(19) United States
(12) Patent Application Publication
(10) Pub. No.: US 2002/0048364 A1
(43) Pub. Date: Apr. 25, 2002

(54) Parallel block encryption method and modes for data confidentiality and integrity protection

(75) Inventors: Virgil Dorin Gligor, Chevy Chase, MD (US); Pompiliu Donescu, Gaithersburg, MD (US)

Correspondence Address: William T. Ellis, FOLEY & LARDNER, Washington Harbour, 3000 K Street, N.W., Suite 500, Washington, DC, 20007-5109, US

(73) Assignee: VDG, Inc.

(21) Appl. No.: 09/931,151

(22) Filed: Aug. 17, 2001

Related U.S. Application Data
(60) Provisional application No. 60/227,519, filed on Aug. 24, 2000.

(51) Int. Cl. H04K 1/04

(52) U.S. Cl. 380/37; 380/286

(57) ABSTRACT

A parallel block encryption method and modes (modes or operation) that provide both data confidentiality and integrity with a single cryptographic primitive and a single processing pass over the input plaintext string by using a non-cryptographic Manipulation Detection Code function for secure data communication over insecure channels and for secure data storage in insecure media. The block encryption method and modes of this invention allow, in yet a further aspect, parallel or pipelined operation of the block enciphering and deciphering functions in and architecture-independent manner. The present invention allows, in a further aspect, error recovery. In a yet further aspect, the present invention allows software and hardware implementations, and use in high-performance and low-power applications, and low-power, low-cost hardware devices. In a yet further aspect, the block encryption method and modes of this invention are suitable for real-time applications.

### CROSS-REFERENCE TO RELATED APPLICATION(S)

This application claims the benefit of priority under 35 U.S.C Section 119(e) of provisional application Ser. No. 60/227,519 entitled “Fast Parallel XCBC Encryption Modes with Message Integrity” filed on Aug. 24, 2000, the disclosure of which is incorporated herein in its entirety.

### FIELD OF THE INVENTION

The present invention relates to the technical field of secure data communication over insecure channels and secure data storage on insecure media using data encryption techniques. Specifically, the invention relates to encryption methods, program products and systems that achieve both data confidentiality and integrity in a single pass over the data with a single cryptographic primitive, and execute the block-enciphering and deciphering operations necessary for data encryption and decryption in an architecture-independent parallel or pipelined manner.

### BACKGROUND OF THE INVENTION

A long-standing goal in the design of block encryption modes, or schemes, has been the ability to provide both data confidentiality and integrity protection with simple Manipulation Detection Code (MDC) functions, such as the bit-wise exclusive-or, cyclic redundancy code (CRC), or even constant functions (viz., C. M. Campbell: “Design and Specification of Cryptographic Capabilities,” in Computer Security and the Data Encryption Standard, (D. K. Brandstad (ed.)) National Bureau of Standards Special Publications 500-27, U.S. Department of Commerce, February 1978, pp. 54-66; V. D. Gligor and B. G. Lindsay: “Object Migration and Authentication,” IEEE Transactions on Software Engineering, SE-5 Vol. 6, November 1979; and R. R. Juneman, S. M. Mathias, and C. H. Meyer: “Message Authentication with Manipulation Detection Codes,” Proc. of the IEEE Symp. on Security and Privacy, Oakland, Calif., April 1983, pp. 33-54). A desirable property of such modes is that they use only a single pass over the input data with a single cryptographic primitive (i.e., a block cipher) thereby saving processing time and power (viz., V. D. Gligor and P. Donescu's provisional patent application Ser. No. 60/179,147 entitled “XCBC Encryption Schemes” filed on Jan. 31, 2000 and subsequent patent application entitled “Block Encryption Method and Schemes for Data Confidentiality and Integrity Protection.”). Another desirable property is that they execute the block-enciphering and deciphering operations necessary for data encryption and decryption in an architecture-independent parallel or pipelined manner.

Executing block-enciphering and deciphering operations of a mode in an architecture-independent parallel or pipelined manner avoids partitioning the plaintext data into separate segments that can be processed concurrently. The disadvantage of separate encryption, and later decryption, of such segments is that the confidentiality and integrity protection mechanisms must be employed for each segment separately, and this leads to added overhead to processing of the entire plaintext data set. In contrast, the execution of block-enciphering and deciphering operations of a mode in an architecture-independent parallel or pipelined manner implies that the overhead of the confidentiality and integrity protection mechanisms is incurred only once for the entire plaintext data set regardless of how many processing units are used in parallel. Furthermore, such execution of block-enciphering and deciphering operations has two added advantages, namely (1) the number of processing units need not be known, or negotiated, prior to data encryption or decryption, thereby simplifying the use of the mode in practice, and (2) there is no overhead difference among the parallel, pipelined and sequential execution architecture for data encryption or decryption operations, thereby enlarging the range of the encryption mode applicability in practice.

A further significant advantage of executing block-enciphering and deciphering operations of a mode in an architecture-independent parallel or pipelined manner is that of efficient incremental and out-of-order processing of such operations; i.e., incremental and out-of-order processing on a per-block basis, as opposed to that on a per-segment basis, has the advantage of lower processing overhead. Incremental processing of block-enciphering and deciphering operations of a mode means that if a small section of a large encrypted message or data set, for instance a single block, is updated, the entire message or data set need not be decrypted, updated, and re-encrypted. Instead, only the blocks affected by the update and that containing the MDC would be decrypted, updated, and re-encrypted. As a result, a substantial performance loss is avoided. Out-of-order processing of block-enciphering and deciphering operations of a mode means that if a block of a message data set arrives at the encryption or decryption processing unit before the blocks preceding it in the message or data set, the processing unit need not wait until all preceding blocks arrive and are processed before processing the block that arrived first. As a consequence, encryption and decryption processing slow-downs are avoided.

Most attempts to provide both data confidentiality and integrity using only a single processing pass over the input data with a single cryptographic primitive focused on different variations of the Cipher Block Chaining (CBC) mode of encryption (viz., NBS FIPS Pub 81, titled “DES Modes of Operation”, National Bureau of Standards, U.S. Department of Commerce, December 1980), which is the most common block-encryption mode in use. However, the CBC mode cannot support parallel or pipelined operation of block-enciphering and deciphering operation in an architecture-independent manner due to the fact that CBC processes each plaintext block sequentially; i.e., the enciphering of each block of a sequence of blocks requires the result of the enciphering of the previous block in the sequence, except the enciphering of the first block in which case the previous block is an initialization vector. Hence parallel or pipelined processing of block enciphering and deciphering operations requires the partitioning of the plaintext data into separate segments that can be processed concurrently.

The stateful XOR (XORC) mode (viz., M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403), which is also known as the “counter-mode,” is a well-known mode of encryption whose block-enciphering and deciphering operations can be performed in an architecture-independent parallel or pipelined manner. However, this mode provides only data confidentiality protection but does not provide integrity protection in a single pass using non-cryptographic MDC. The encryption and decryption equations of the stateful XOR (XORC) mode use a counter, ctr, which is initialized to constant value c. Encryption of plaintext string x=x₁ . . . xₙ to obtain ciphertext string z=z₁ . . . zₙ with the XORC mode is defined by the following equation:

z₁=F_{K} (ctr+i)\mathring{+}x₁, i=1, . . . , n,

where the new counter value ctr+n is obtained after each message x encryption, n is the number of blocks of message x, and F_{K} is the block cipher F using key K. In this mode, decryption of ciphertext string z=z₁ . . . zₙ to obtain plaintext string x=x₁ . . . xₙ, is defined by the following equation:

xᵢ=F_{K} (ctr+i)\mathring{+}zᵢ, i=1, . . . , n.

It is well-known in the art that the counter (XORC) mode is secure with respect to confidentiality (secrecy) when chosen-plaintext attacks are launched by an adversary using a well-defined set of resources. For example, M. Bellare, A. Desai, E. Jokipii, and P. Rogaway, in “A Concrete Security Treatment of Symmetric Encryption,” Proceedings of the 38th Symposium on Foundations of Computer Science, IEEE, 1997, pp. 394-403, demonstrate that the CBC and XOR modes are secure in the left-or-right (or real-or-random) sense, which in turn implies that they are confidentiality-secure against chosen-plaintext attacks (viz., S. Goldwasser and M. Bellare: “Lecture Notes on Cryptography”, 1999, available at http://wwwcse.ucsd.edu/users/mihir/papers/gb.pdf). In such attacks, an adversary can obtain ciphertexts for a set of plaintexts of his/her own choice. Security with respect to confidentiality (secrecy) means that, after such an attack, the adversary cannot determine the plaintext of a never-seen-before ciphertext message (i.e., a ciphertext message not obtained during the attack) with more than negligible probability. The notion of negligible probability in such attacks is also known to those skilled in the art (e.g., as defined by M. Naor and O. Reingold: “From Unpredictability to Indistinguishability: A Simple Construction of Pseudo-Random Functions from MACs,” in Advances in Cryptology—CRYPTO '98 (LNCS 1462), pp. 267-282, 1998). All modes that are secure in this sense are called “confidentiality-secure against chosen-plaintext attacks,” or simply, “confidentiality-secure,” henceforth.

It is also well known to those skilled in the art that the counter (XORC) mode does not, by itself, preserve data or message integrity (authenticity), and that non-cryptographic MDC functions cannot be used with counter (XORC) mode to preserve data or message integrity (authenticity). For example, a change of a ciphertext bit position leads to a change in the same bit position of the plaintext and hence simple, efficient MDC functions, such as the bit-wise exclusive-or, cannot be used for integrity protection. Most Message Authentication Code (MAC) modes that can be used to protect the integrity of data or messages encrypted with counter (XORC) mode, such as HMAC (viz., M. Bellare, R. Canetti, and H. Krawczyk, “Keying Hash Functions for Message Authentication,” Advances in Cryptology—CRYPTO '96, Springer-Verlag, LNCS 1109, pp. 1-15, 1996), and UMAC (viz., J. Black, S. Halevi, H. Krawczyk, T. Krovetz, and P. Rogaway, “UMAC: Fast Message Authentication via Optimized Universal Hash Functions,” Advances in Cryptology—CRYPTO '99, Springer-Verlag, LNCS 1666, 216-233, 1999), cannot operate in an architecture-independent parallel or pipelined manner, thereby decreasing the performance of the added MAC processing pass. Even when MAC modes that operate in an architecture-independent parallel or pipelined manner thereby matching the properties of the counter (XORC) mode, such as the XOR-MAC (viz., M. Bellare, R. Guerin, and P. Rogaway, “XOR-MACs: New Methods for Message Authentication Using Finite Pseudo-Random Functions,” Advances in Cryptology—CRYPTO '95, Springer-Verlag, LNCS 963, pp. 15-28; and M. Bellare, R. Guerin, and P. Rogaway, “Method and Apparatus for Data Authentication in a Communication environment,” U.S. Pat. No. 5,757,913, dated May 26, 1998.) and the XECB MAC modes invented by Gligor and Donescu (viz., V. D. Gligor and P. Donescu's provisional patent application No. 60/193,447 entitled “XCBC Encryption Modes and XECB Authentication Modes” filed on Mar. 31, 2000 and subsequent patent application entitled “Authentication Method and Schemes for Data Integrity Protection”) are used, the additional MAC processing pass would require substantial added implementation complexity, cost, and power consumption. Thus, such modes would be less suitable for use in low-power applications, and low-power, low-cost hardware devices.

A well-understood consequence of combining the counter (XORC) mode and a MAC mode for maintaining the integrity (authenticity) of encrypted data or messages is the lack of error recovery for the resulting mode of operation (viz., A. J. Menezes, P. C. van Oorschot, and S. A. Vanstone in their book “Handbook of Applied Cryptography”, CRC Press, Boca Raton, 1997, Chapter 7.) That is, any bit error in the ciphertext of an encrypted message or data set whose integrity is protected causes the entire plaintext obtained from ciphertext decryption to be discarded by the mode operation with high probability. Although this is a desirable outcome in all environments where protection against ciphertext forgeries is required, it is sometimes important to enable recovery of the plaintext blocks that are unaffected by errors in the ciphertext block being decrypted. Recovery of plaintext blocks unaffected by ciphertext errors is particularly important in environments of use where retransmission of large-message ciphertext (e.g., video, sound, real-time data streams) following detection of ciphertext errors in a small number of blocks cannot be tolerated by the application whereas some loss of plaintext blocks can be tolerated.

V. D. Gligor and P. Donescu invented a block encryption method and modes of operation that provide both data confidentiality and integrity with a single cryptographic primitive and a single processing pass over the input plaintext string by using a non-cryptographic MDC function (e.g., bit-wise exclusive-or) for secure data communication over insecure channels and for secure data storage in insecure media (viz V. D. Gligor and P. Donescu's provisional patent application Ser. No. 60/179,147 entitled “XCBC Encryption Schemes” filed on Jan. 31, 2000 and subsequent patent application entitled “Block Encryption Method and Schemes for Data Confidentiality and Integrity Protection,” and V. D. Gligor and P. Donescu's provisional patent application Ser. No. 60/193,447 entitled “XCBC Encryption Modes and XECB Authentication Modes” filed on Mar. 31, 2000). The encryption and decryption equations of these modes illustrate in a brief manner how these modes use F_{K}, a block cipher F with key K, and its inverse F⁻¹_{K}, to process the plaintext and ciphertext blocks of a message or data. For example, in one of these modes, encryption of plaintext string x=x₁ . . . xₙ to obtain ciphertext string y=y₁ . . . yₙ is defined by the following equations:

yᵢ=F_{K}(xᵢ\mathring{+}zᵢ₋₁) op Eᵢ, z₀=F_{K}(r₀+1), xₙ₊₁=z₀\mathring{+}x₁\mathring{+} . . . \mathring{+}xₙ, y₀=F_{K}(r₀), i=1, . . . , n+1,

where F_{K} is the block cipher F using secret key K, r₀ is a secret random number uniformly distributed of the same size as that of a block of the block cipher (i.e., of λ bits in length), and Eᵢ is an λ-bit element of a sequence of unpredictable elements (e.g., Eᵢ=i×r₀), and op is a operation that has the inverse op⁻¹ (e.g., op can be modulo 2^{λ} addition, modulo 2^{λ} subtraction, bit-wise exclusive-or). In this mode, decryption of ciphertext string y=y₀y₁ . . . yₙ₊₁ to obtain plaintext string x=x₁ . . . xₙ, is defined by the following equations:

xₗ=F⁻¹_{K} (yₗ op⁻¹ Eᵢ)\mathring{+}zᵢ₋₁, i=1, . . . , n+1,

subject to the integrity check xₙ₊₁=z₀\mathring{+}x₁\mathring{+} . . . \mathring{+}xₙ.

An important added security feature of this mode, which is not shared by other modes, is that the integrity check includes the unpredictable vector z₀. This removes the ability of an adversary to use the integrity check for the purpose of verifying the validity of plaintext x₁, . . . , xₙ xₙ₊₁ obtained using guessed keys, as would be the case in typical key-search attacks.

Gligor and Donescu's block encryption method and modes of operations allow encryption and decryption in parallel or pipelined manners by the segmentation of the plaintext data and of corresponding ciphertext. These modes can also support error recovery at the segment level, since the integrity of each message or data-set segment is separately verified. Thus the recovery of the plaintext segments that are unaffected by errors in the ciphertext being decrypted can be performed by identifying the segments whose integrity checks have passed. Although these modes are suitable for high-performance and low-power applications and for real-time applications, and can be used in low-power, low-cost hardware devices, they cannot support architecture-independent parallel and pipelined operation efficiently at the level of individual block processing.

Later, C. S. Jutla also designed a block encryption modes of operation that provide both data confidentiality and integrity with a single cryptographic primitive and a single processing pass over the input plaintext string by using a non-cryptographic MDC function (i.e., bit-wise exclusive-or, viz., C. S. Jutla's “Encryption Modes with Almost Free Message Integrity” IBM Thomas Watson Reserch Center, Yorktown Heights, N.Y. 10598, available at http://eprint.iacr.org/2000/039, August 2000 version). The encryption and decryption equations of these modes illustrate in a brief manner how these modes use F_{K}, a block cipher F with key K, and its inverse F⁻¹ₖ, to process the plaintext and ciphertext blocks of a message or data. For example, in the fastest mode proposed by C. S. Jutla, encryption of plaintext string x=x₁ . . . xₙ to obtain ciphertext string y=y₁ . . . yₙ is defined by the following equations:

yᵢ=F_{K}(xₗ\mathring{+}Sᵢ)\mathring{+}Sᵢ, xₙ₊₁=x₁\mathring{+} . . . \mathring{+}xₙ, y₀=F_{K}(r₀), i=1, . . . , n+1,

where F_{K} is the block cipher F using secret key K, r₀ is a secret random number uniformly distributed of the same size as that of a block of the block cipher (i.e., of λ bits in length) generated anew for each message; Sᵢ is an λ-bit element of a per-message sequence of random, pairwise-independent elements defined as Sᵢ=(r₁+i×r₂)mod p, where p is a large prime slightly smaller than 2^{λ}, r₁=F_{K′}(r₀+1), r₂=F_{K′}(r₀+2); and K′ is a second key. Two elements Sᵢ and Sⱼ, i≠j of a sequence of random numbers are pair-wise independent if, for any constants a and b, Probability (Sᵢ=a and Sⱼ=b)=Probability (Sᵢ=a)×Probability (Sᵢ=b). In this mode, decryption of ciphertext string y=y₀y₁ . . . yₙ₊₁ to obtain plaintext string x=X₁ . . . xₙ, is defined by the following equations:

xᵢ=F⁻¹_{K} (yₗ\mathring{+}Sᵢ)\mathring{+}Sᵢ, i=1, . . . , n+1,

subject to the integrity check xₙ₊₁=x₁\mathring{+}. . . \mathring{+}x_{n.}

The above equations indicate that all inputs to the block-enciphering and deciphering operations (i.e., the inputs of F_{K} and F⁻¹_{K}) are independent of the outputs of those operations and hence can be executed in an architecture-independent parallel or pipelined manner. However, Jutla's modes have several performance disadvantages. First, the generation of random, pair-wise independent sequences of elements is less efficient than that of sequences whose elements are only unpredictable, but not pair-wise independent. For example, the computation of the elements of sequence Sᵢ is less efficient than that of sequence Eᵢ used in Gligor and Donescu's modes. This is the case because computation of sequence Sₗ requires two extra block-enciphering operation (i.e., two operations for r₁ and r₂) per message and modular p additions where p is a prime, which is less efficient than modulo 2^{λ} addition operations. Second, Jutla's modes require that a different sequence Sₗ be generated for each message and does not allow a single, per-key sequence. This means that these modes can never attain the minimum number of block-enciphering/deciphering operations (i.e., n+1 operations for n-block data set) and cannot come close to the minimum latency (i.e., the elapsed time between the beginning and end of message encryption) for parallel operation (i.e., close to the latency of a single block enciphering/deciphering operation) in the processing of a message. For example, Jutla's fastest mode requires n+4 block-cipher invocations, instead of the minimum n+1, for an n-block data set, and a latency of at least three sequential block-cipher invocations regardless of how many parallel processing units are available (i.e., the per-message random number generation, which accounts for at least one block cipher invocation, is followed by the generation of Sᵢ, which accounts for a second block cipher invocation, which is then followed by the parallel invocation on n+1 block cipher operations, which accounts for the latency of a third block cipher invocation). These performance disadvantages are particularly relevant for processing relatively short data sets (e.g., under 256 bytes). Finally, none of Jutla's modes provide any means for message or data set segmentation and have no applicability in environments where recovery from ciphertext errors is required.

Recently, Katz and Yung proposed a new mode of encryption that uses a single cryptographic primitive and non-cryptographic MDC function to protect confidentiality and integrity called The Related Plaintext Chaining (RPC) (viz., J. Katz and M. Yung, “Unforgeability and Chosen-Ciphertext-Secure Modes of Operation,” Proc. of the Fast Software Encryption 2000, B. Schneier (ed.), Springer-Verlag, LNCS). The single processing pass used by this mode is over a modified plaintext that expands the plaintext data by concatenating each plaintext block's identifier with the actual plaintext data of that block to form the input block submitted to block enciphering. (Each block's identifier represents the addition of either a per-message counter or a per-message random number, depending on whether a stateful or stateless mode is desired, and the sequence number of that block in the input data.) Two separate ciphertext blocks are created that represent the enciphering of a message start and end markers. RPC supports architecture-independent parallel and pipelined execution of block enciphering and deciphering operations. However, these operations are over an expanded input plaintext thereby requiring extra block-enciphering and deciphering operations; i.e., up to twice as many as necessary for long messages. Thus the performance and power-consumption characteristics of this mode are inferior to that of single pass modes that do not expand the plaintext input, such as those of Gligor and Donescu and Jutla's that are referred to above. Further, like Jutla's modes, RPC and counter (XORC) mode does not provide any means for message or data set segmentation and have no applicability in environments where recovery from ciphertext errors is required.

### SUMMARY OF THE INVENTION

The inventors have recognized, and it is an aspect of this invention, that it is highly advantageous to provide parallel encryption modes that (1) provide both data confidentiality and integrity and require only one processing pass over the data or message with only one cryptographic primitive (i.e., the block cipher), and (2) perform the block enciphering and deciphering operations in an architecture-independent parallel or pipelined manner without requiring any plaintext expansion, and in a preferred embodiment (3) provide error recovery.

The inventors have further recognized, and it is an aspect of this invention, that it is advantageous to provide (1) stateless, (2) stateful-sender, and (3) stateful encryption modes, each mode being preferable over the others in different application environments. Many of the prior-art encryption modes provided only stateless modes, which require a high-performance random number generator that produces a new random number for the encryption of each message. Such random number generators may be unavailable or may be hard to protect in terms of confidentiality, integrity and availability; e.g., the new random number used in each message encryption by the sender must be securely transmitted to the receiver, which usually costs at least an additional block-cipher invocation. Other prior-art encryption modes are stateful-sender modes (e.g., a counter-based mode) that eliminate the need for using random number generators, but do not eliminate the extra block-cipher invocation and the need to protect the extra sender-state variables; i.e., the source of randomness is replaced by the enciphering of a message counter, but the counter must be maintained and its integrity must be protected by the sender across encryption of multiple messages, which was unnecessary in stateless modes. It has been further recognized by the present inventors, and is an aspect of this invention that maintaining secret shared-state variables for both the sender and receiver, as opposed to just sender-state, helps eliminate the extra block-cipher invocations, thereby increasing encryption performance, particularly for short messages. However, enlarging the shared state beyond that of a shared secret key may increase the exposure of the mode to physical attacks beyond that possible in stateless and stateful-sender modes. Hence, there remains a need for all three implementation options (i.e., stateless, stateful-sender, and stateful) of an encryption mode.

Briefly, the present invention comprises, in a first embodiment, a parallel encryption method for providing both data confidentiality and integrity for a message, comprising the steps of: receiving an input plaintext string comprising a message; generating a plurality of equal-sized blocks of λ bits in length from the input plaintext string; creating an MDC block of λ bits in length that includes the result of applying a non-cryptographic Manipulation Detection Code (MDC) function to the plurality of the equal-size blocks; presenting the equal-size blocks and the MDC block to a selected parallel encryption mode that makes one and only one processing pass with a single cryptographic primitive over each of the equal-size blocks and the MDC block to create a plurality of hidden ciphertext blocks each of λ bits in length; and performing a hidden ciphertext randomization function over the plurality of hidden ciphertext blocks to create a plurality of output ciphertext blocks each of λ bits in length.

In a further aspect of the present invention, the selected parallel encryption mode is confidentiality-secure against chosen-plaintext attacks, wherein each of the equal-size blocks and the MDC block is processed by a block cipher using a secret key (K) to obtain the plurality of hidden ciphertext blocks; and wherein the performing a hidden ciphertext randomization function step comprises combining each of the hidden ciphertext blocks with a corresponding element of a sequence of unpredictable elements for the hidden ciphertext to create a set of output blocks of the ciphertext, wherein a hidden ciphertext block identified by an index i is combined with the element of the sequence identified by index i by an operation for the hidden ciphertext that has an inverse.

In a further aspect of the present invention, the selected parallel encryption mode that is confidentiality-secure against chosen-plaintext attacks comprises the steps of: performing a plaintext randomization function over the plurality of equal-sized blocks of the plaintext and the MDC block to create a plurality of hidden plaintext blocks each of λ bits in length; and processing each of the hidden plaintext blocks by a block cipher using the secret key (K) to obtain the plurality of hidden ciphertext blocks.

In a further aspect of the present invention, the performing a plaintext randomization function step comprises combining each of the equal-size blocks and the MDC block with a corresponding element of a sequence of unpredictable elements for the hidden plaintext to create a set of hidden plaintext blocks, wherein an equal-size block or the MDC block identified by an index i is combined with the element of the sequence identified by index i by an operation for the hidden plaintext that has an inverse.

In a further aspect of the present invention, the result of the combination of any two different unpredictable elements of the sequence of unpredictable elements for the hidden ciphertext by the inverse operation of the operation for the hidden ciphertext is unpredictable; and wherein the unpredictable elements selected as the two unpredictable elements for the hidden ciphertext are any two different elements of the same sequence of unpredictable elements for the hidden ciphertext used for the encryption of the plaintext string; and wherein the unpredictable elements selected as the two unpredictable elements for the hidden ciphertext are any two different elements of a plurality of sequences of unpredictable elements for the hidden ciphertext used for encryption of a plurality of plaintext strings with the same secret key K.

In a further aspect of the present invention, the result of the combination of any two different unpredictable elements of the sequence of unpredictable elements for the hidden plaintext by the inverse operation of the operation for the hidden plaintext is unpredictable; and wherein the unpredictable elements selected as the two unpredictable elements for the hidden plaintext are any two different elements of the same sequence of unpredictable elements for the hidden plaintext used for the encryption of the plaintext string; and wherein the unpredictable elements selected as the two unpredictable elements for the hidden plaintext are any two different elements of a plurality of sequences of unpredictable elements for the hidden plaintext used for encryption of a plurality of plaintext strings with the same secret key K.

In a further aspect of the present invention, any two different unpredictable elements of the sequence of unpredictable elements for the hidden ciphertext are not pair-wise independent; wherein the unpredictable elements selected as the two unpredictable elements for the hidden ciphertext are any two different elements of the same sequence of unpredictable elements for the hidden ciphertext used for the encryption of the plaintext string; and wherein the unpredictable elements selected as the two unpredictable elements for the hidden ciphertext are any two different elements of a plurality of sequences of unpredictable elements for the hidden ciphertext used for encryption of a plurality of plaintext strings with the same secret key K; and wherein any two different unpredictable elements of the sequence of unpredictable elements for the hidden plaintext are not pair-wise independent; wherein the unpredictable elements selected as the two unpredictable elements for the hidden plaintext are any two different elements of the same sequence of unpredictable elements for the hidden plaintext used for the encryption of the plaintext string; and wherein the unpredictable elements selected as the two unpredictable elements for the hidden plaintext are any two different elements of a plurality of sequences of unpredictable elements for the hidden plaintext used for encryption of a plurality of plaintext strings with the same secret key K.

In a further aspect of the present invention, the creating an MDC block step comprises applying the non-cryptographic MDC function to the equal-sized blocks of the plaintext.

In a further aspect of the present invention, the non-cryptographic MDC function is the bit-wise exclusive-or function.

In a further aspect of the present invention, the non-cryptographic MDC function is the addition modulo 2^{λ}-1 function.

In a further aspect of the present invention, the non-cryptographic MDC function is the subtraction modulo 2^{λ}-1 function.

In a further aspect of the present invention, there is provided the step of combining the result from applying the non-cryptographic Manipulation Detection Code function to the plurality of equal-sized blocks of the plaintext with a secret, λ-bit random vector generated on a per-message basis to obtain the MDC block.

In a further aspect of the present invention, the combining step comprises performing the combination using a bit-wise exclusive-or function.

In a further aspect of the present invention, the combining step comprises performing the combination using addition modulo 2^{λ}-1.

In a further aspect of the present invention, the combining step comprises performing the combination using subtraction modulo 2^{λ}-1.

In a further aspect of the present invention, there is provided the step of generating the secret random vector from a secret random number generated on a per-message basis.

In a further aspect of the present invention, there is provided the step of appending the created MDC block after a last block of the set of equal-sized blocks of the plaintext.

In a further aspect of the present invention, the hidden ciphertext blocks from the processing step comprise n+1 hidden ciphertext blocks each of λ-bit length, where n is the total number of blocks in the set of equal-sized blocks of the plaintext.

In a further aspect of the present invention, there is provided the step of generating each of a plurality of the unpredictable elements of the sequence of unpredictable elements for the hidden ciphertext by combining a different element identifier for each of the unpredictable elements and a secret random number.

In a further aspect of the present invention, there is provided the step of generating each of a plurality of the unpredictable elements of the sequence of unpredictable elements for the hidden plaintext by combining a different element identifier for each of the unpredictable elements and a secret random number.

In a further aspect of the present invention, there are provided the steps of: generating each of a plurality of the unpredictable elements of the sequence of unpredictable elements for the hidden ciphertext by combining a different element identifier for each of the unpredictable elements and a secret random number; and generating each of a plurality of the unpredictable elements of the sequence of unpredictable elements for the hidden plaintext by combining a different element identifier for each of the unpredictable elements and the secret random number.

In a further aspect of the present invention, the step of generating each element in the sequence of unpredictable elements for the hidden ciphertext comprises a modular 2^{λ} multiplication of a different unique element identifier (i) for each element in the sequence of unpredictable elements and the secret random number; and wherein generating each element in the sequence of unpredictable elements for the hidden plaintext comprises a modular 2^{λ} multiplication of a different unique element identifier (i) for each element in the sequence of unpredictable elements and the secret random number for all the equal-size blocks of the plaintext and by modular 2^{λ} multiplication of (n+2) and the secret random number for the MDC block.

In a further aspect of the present invention, there are provided the steps of: enciphering the secret random number using the block cipher using the secret key (K); and including this enciphered secret random number (y₀) as one of the output ciphertext blocks.

In a further aspect of the present invention, the secret random number is provided by a random number generator.

In a further aspect of the present invention, there is provided the steps of: generating the secret random number by enciphering a count of a counter initialized to a constant, the enciphering being performed with the block cipher using the secret key (K); and incrementing the counter by one on every message encryption.

In a further aspect of the present invention, the counter is initialized to a constant whose value is the λ-bit representation of negative one.

In a further aspect of the present invention, there is provided the step of initializing the counter to a secret value of λ bits in length.

In a further aspect of the present invention, there is provided the step of outputting the counter value as an output block of the encryption mode.

In a further aspect of the present invention, there are provided the steps of: deriving a block-index-independent unpredictable element; generating each of a plurality of the unpredictable elements of the sequence of unpredictable elements for the hidden ciphertext by combining the block-index-independent unpredictable element with each of a plurality of block-index-dependent unpredictable elements for the hidden ciphertext; and generating each of a plurality of the unpredictable elements of the sequence of unpredictable elements for the hidden plaintext by combining the block-index-independent unpredictable element with each of a plurality of block-index-dependent unpredictable elements for the hidden ciphertext.

In a further aspect of the present invention, there are provided the steps of: wherein the block-index-independent unpredictable element is obtained from a count of an λ-bit counter initialized to a non-zero constant, and a per-key secret, first random initial number shared between sender and receiver; and wherein each of the plurality of block-index-dependent unpredictable elements for the hidden ciphertext is obtained from an λ-bit element index and a secret, second random initial number shared between sender and receiver; wherein each of the plurality of block-index-dependent unpredictable elements for the hidden plaintext is obtained from an λ-bit element index and a per-key secret, second random initial number shared between sender and receiver; wherein the secret, first and second random initial numbers are independent; and wherein the λ-bit counter is incremented by one on every message encryption.

In a further aspect of the present invention, the combining to obtain the unpredictable elements for the hidden ciphertext comprises an addition modulo 2^{λ}.

In a further aspect of the present invention, the combining to obtain the unpredictable elements for the hidden plaintext comprises an addition modulo 2^{λ}.

In a further aspect of the present invention, the combining to obtain the unpredictable elements for the hidden ciphertext comprises a subtraction modulo 2^{λ}.

In a further aspect of the present invention, the combining to obtain the unpredictable elements for the hidden plaintext comprises a subtraction modulo 2^{λ}.

In a further aspect of the present invention, the combining to obtain the unpredictable elements for the hidden ciphertext comprises a bit-wise exclusive-or operation.

In a further aspect of the present invention, the combining to obtain the unpredictable elements for the hidden plaintext comprises a bit-wise exclusive-or operation.

In a further aspect of the present invention, there are provided the steps of: wherein the block-index-independent unpredictable element is obtained by multiplication modulo 2^{λ} of the secret, first random initial number with a different value of the counter; and wherein each of the plurality of block-index-dependent unpredictable elements for the hidden ciphertext is obtained by multiplication modulo 2^{λ} of the secret, second random initial number with the index i of the hidden ciphertext block; and wherein each of the plurality of block-index-dependent unpredictable elements for the hidden plaintext is obtained by multiplication modulo 2^{λ} of the secret, second random initial number with the index i of the plaintext block; and wherein the unpredictable element for the hidden plaintext corresponding to the MDC block is the block-index-independent unpredictable element itself.

In a further aspect of the present invention, the operation for the hidden ciphertext that has an inverse is the addition modulo 2^{λ}.

In a further aspect of the present invention, the operation for the hidden ciphertext that has an inverse is a bit-vise exclusive-or operation.

In a further aspect of the present invention, the operation for the hidden ciphertext that has an inverse is the subtraction modulo 2^{λ} operation.

In a further aspect of the present invention, the operation for the hidden plaintext that has an inverse is the addition modulo 2^{λ}.

In a further aspect of the present invention, the operation for the hidden plaintext that has an inverse is a bit-wise exclusive-or operation.

In a further aspect of the present invention, the operation for the hidden plaintext that has an inverse is the subtraction modulo 2^{λ} operation.

In a further aspect of the present invention, the step of generating a plurality of equal-sized blocks of λ bits in length from the input plaintext string further comprises the steps of: padding the input plaintext string as necessary such that its length is a multiple of λ bits; and partitioning the padded input plaintext string into a plurality of equal-size blocks of λ bits in length.

In a further aspect of the present invention, the padding of the input plaintext string is a standard padding method.

In a further aspect of the present invention, the padding of the input plaintext string step comprises the steps of: if the last block of the plaintext has λ bits in length derive a last element of the sequence of unpredictable elements for the hidden plaintext to be combined with the MDC block to form a hidden plaintext block from the bit-wise complement of a random number; else, append to the last block of the plaintext the bit 1 and the necessary bits of 0 to generate a last equal-size block, and derive a last element of the sequence of unpredictable elements for the hidden plaintext to be combined with the MDC block to form a hidden plaintext block from the random number; and generating each but the last of a plurality of the unpredictable elements of the sequence of unpredictable elements for the hidden plaintext by combining a different element identifier for each of the unpredictable elements and the secret random number.

In a further aspect of the present invention, the padding of the input plaintext string step comprises the steps of: if the last block of the plaintext has λ bits in length derive a last element of the sequence of unpredictable elements for the hidden plaintext to be combined with the MDC block to form a hidden plaintext block from a different block-index-independent unpredictable element obtained from the bit-wise complement of a first random number shared between a sender and a receiver; else, append to the last block of the plaintext the bit 1 and the necessary bits of 0 to generate a last equal-size block, and derive the last element of the sequence of unpredictable elements for the hidden plaintext to be combined with the MDC block to form a hidden plaintext block from a different block-index-independent unpredictable element obtained from the first random number shared between a sender and a receiver; and generating each but the last of a plurality of the unpredictable elements of the sequence of unpredictable elements for the hidden plaintext by combining a different block-index-independent unpredictable element obtained from the first random number shared between a sender and a receiver and each of a plurality of block-index-dependent unpredictable elements for the hidden plaintext.

In a further embodiment of the present invention, there is provided a parallel decryption method that is the inverse of the parallel encryption method which provides both data confidentiality and integrity, comprising the steps of: presenting a string including ciphertext string for decryption; partitioning the ciphertext string into a plurality of ciphertext blocks comprising λ bits each; selecting n+1 ciphertext blocks from the plurality of ciphertext blocks representing n data blocks and one MDC block and performing a reverse hidden ciphertext randomization function on each of the selected n+1 ciphertext blocks to obtain a plurality of hidden ciphertext blocks each of λ bits in length; presenting the hidden ciphertext blocks to a selected parallel decryption mode that makes one and only one processing pass with a single cryptographic primitive that is the inverse of an encryption single cryptographic primitive over the plurality of hidden ciphertext blocks to obtain a plurality of plaintext blocks and one decrypted MDC block each of λ bits in length; verifying integrity of the plaintext blocks using a non-cryptographic Manipulation Detection Function (MDC) function; outputting the plurality of plaintext blocks as an accurate plaintext string if the integrity verification passes; and outputting a failure indicator if the integrity verification fails.

In a further aspect of the present invention, the performing the reverse hidden-ciphertext randomization function comprises the steps of: generating a sequence of unpredictable elements for the hidden ciphertext each of λ-bit length in the same manner as used at an encryption method; selecting n+1 ciphertext blocks from the plurality of ciphertext blocks representing n data blocks and one MDC block in the same order as that used at an encryption method, and combining the selected ciphertext blocks with the sequence of unpredictable elements for the hidden ciphertext to obtain a plurality of hidden ciphertext blocks (zᵢ), such that each of the n+1 ciphertext blocks identified by index i is combined with the element of the sequence of unpredictable elements for the hidden ciphertext identified by index i, by the inverse of the operation for the hidden ciphertext used at the encryption method; and wherein the verifying integrity step comprises creating an MDC decryption block by applying the non-cryptographic Manipulation Detection Code function to the n decrypted plaintext data blocks; and comparing the created MDC decryption block with the decrypted MDC block.

In a further aspect of the present invention, the creating an MDC decryption block further comprises combining the result with a secret, λ-bit random vector, the combining operation being the same as the combining operation at the encryption method, and the secret random vector being derived from the secret random number in the same manner as at the encryption method.

In a further aspect of the present invention, the selected parallel decryption mode comprises the steps of: processing each of the hidden ciphertext blocks with the inverse of the block cipher used at an encryption method using a secret key (K) to obtain a plurality of hidden plaintext blocks; and performing a reverse plaintext randomization function over the plurality of hidden plaintext blocks to create a plurality of n decrypted plaintext data blocks and one decrypted MDC block each of λ bits in length.

In a further aspect of the present invention, performing the reverse plaintext randomization function comprises the steps of: generating a sequence of unpredictable elements for the hidden plaintext each of λ-bit length in the same manner as used at an encryption method; and combining the selected hidden plaintext blocks with the sequence of unpredictable elements for the hidden plaintext to obtain a plurality of n plaintext blocks and one decrypted MDC block, such that each of the n+1 hidden plaintext blocks identified by index i is combined with the element of the sequence of unpredictable elements for the hidden plaintext identified by index i, by the inverse of the operation for the hidden plaintext used at the encryption method.

In a further aspect of the present invention, there are provided the steps of: deriving a secret random number from the ciphertext string presented for decryption; and generating each of a plurality of the unpredictable elements of the sequence of unpredictable elements for the hidden ciphertext in the same manner as at the encryption method.

In a further aspect of the present invention, there are provided the steps of: deriving a secret random number from the ciphertext string presented for decryption; and generating each of a plurality of the unpredictable elements of the sequence of unpredictable elements for the hidden plaintext in the same manner as at the encryption method.

In a further aspect of the present invention, there are provided the steps of: deriving a secret random number from the ciphertext string presented for decryption; generating each of a plurality of the unpredictable elements of the sequence of unpredictable elements for the hidden ciphertext in the same manner as at the encryption method; and generating each of a plurality of the unpredictable elements of the sequence of unpredictable elements for the hidden plaintext in the same manner as at the encryption method.

In a further aspect of the present invention, there are provided the steps of: selecting the ciphertext block of a secret random number (y₀) from the string presented for decryption; and deciphering the selected ciphertext block to obtain the secret random number.

In a further aspect of the present invention, the deciphering step comprises performing the deciphering with the inverse of the block cipher using the secret key (K).

In a further aspect of the present invention, there are provided the steps of: for the encryption method generating a secret random number by enciphering a count of a counter initialized to a constant, the enciphering being performed with the block cipher using the secret key; and incrementing the counter by one on every message encryption; and further comprises for decrypting the ciphertext blocks of the partitioned ciphertext string the steps of: selecting a counter block representing the count of the counter from the string presented at decryption; and enciphering the selected counter block to obtain the secret random number.

In a further aspect of the present invention, the enciphering step comprises performing the enciphering with the block cipher using the secret key.

In a further aspect of the present invention, there are provided the steps of: generating each of a plurality of the unpredictable elements of the sequence of unpredictable elements for the hidden ciphertext by combining a different block-index-independent unpredictable element with each of a plurality of block-index-dependent unpredictable elements for the hidden ciphertext in the same manner as at the encryption method; and generating each of a plurality of the unpredictable elements of the sequence of unpredictable elements for the hidden plaintext by combining a different block-index-independent unpredictable element with each of a plurality of block-index-dependent unpredictable elements for the hidden plaintext in the same manner as at the encryption method.

In a further aspect of the present invention, the string presented for decryption is obtained by applying the encryption method that provides both data confidentiality and integrity to an input plaintext string, and further comprises outputting the input plaintext string.

In yet a further embodiment of the present invention, there are provided a method for segmented encryption processing of a message comprising the steps of: partitioning the input plaintext string into a plurality of input plaintext segments; concurrently presenting each different one of the plurality of input plaintext segments to a different one of a plurality of parallel encryption methods, each of the different methods using a different λ-bit secret random number per segment to obtain a ciphertext segment, wherein each encryption method provides both data confidentiality and integrity with a single processing pass over the input plaintext segment and a single cryptographic primitive, and uses a non-cryptographic Manipulation Detection Code function, wherein the single cryptographic primitive is an λ-bit block cipher using a secret key; assembling the plurality of ciphertext segments into a ciphertext string; and outputting the ciphertext string.

In a further aspect of the present invention, the assembling step comprises including in the ciphertext string the number of ciphertext segments, a ciphertext segment index, a length of each ciphertext segment and a sequence of ciphertext segments.

In a further aspect of the present invention, there is provided the step of: generating the different λ-bit secret random number per segment from a secret random number of λ bits in length.

In a further aspect of the present invention, there is provided the step of: generating the different secret random number per segment from the secret random number of λ bits by adding modulo 2^{λ} a plaintext segment sequence index for that segment to the secret random number.

In a further aspect of the present invention, there are provided the steps of: generating the secret random number of λ bits in length by a random number generator; enciphering the secret random number with the block cipher using a first key (K); and including the enciphered secret random number as an output block of the output ciphertext string.

In a further aspect of the present invention, there are provided the steps of: generating each of the secret random number per segment by enciphering the result of adding the segment number to a counter initialized to a constant, the enciphering being done with the block cipher using the first key (K); and outputting the counter value as an output block of the output ciphertext string; and incrementing after every different message encryption the counter by a number equal to a number of plaintext segments in the message.

In a further aspect of the present invention, there are provided the steps of: generating each of the secret random number per segment from a per-key secret, first random initial number shared between sender and receiver and the result of adding modulo 2^{λ} the segment number to a counter initialized to a constant, and outputting the counter value as an output block of the output ciphertext string; and incrementing after every different message encryption the counter by a number equal to a number of plaintext segments in the message.

In a further aspect of the present invention, the generating each of the secret random number per segment comprises multiplying modulo 2^{λ} the per-key secret, first random initial number shared between sender and receiver with the result of adding the segment number to the counter.

In a yet further embodiment of the present invention, there is provided a method for segmented decryption processing of a message comprising the steps of: presenting a string including the ciphertext string of a message for decryption; partitioning the ciphertext string into a plurality of ciphertext segments; concurrently presenting the plurality of ciphertext segments to a plurality of decryption modes; obtaining a different secret random number per ciphertext segment in the same manner as at the segmented encryption method; decrypting each ciphertext segment using the different secret random number per ciphertext segment to obtain a plaintext segment, using a parallel decryption method that is the inverse of the parallel encryption method that provides both data confidentiality and integrity with a single processing pass over the input plaintext segment and a single cryptographic primitive, wherein the single cryptographic primitive is an λ-bit block cipher using a secret key, and using a non-cryptographic Manipulation Detection Code function for verifying integrity of the plaintext blocks of each plaintext segment; and verifying the integrity of each plaintext segment and for each plaintext segment, outputting either the plaintext segment if the integrity verification passes, or an error indicator.

In a further aspect of the present invention, each of the different secret random numbers per ciphertext segment are obtained from a secret random number in the same manner at as used at a segmented encryption method.

In a further aspect of the present invention, there are provided the steps of: selecting a ciphertext block of the secret random number from the string presented for decryption; and deciphering the selected ciphertext block to obtain the secret random number.

In a further aspect of the present invention, the method includes performing the deciphering step with the inverse of a block cipher using the secret key, the block cipher and the secret key being the same as to those used at a segmented encryption method.

In a further aspect of the present invention, there are provided the steps of: for the segmented encryption method generating the secret random number per ciphertext segment by enciphering the result of adding modulo 2^{λ} the segment number with a counter initialized to a constant, the enciphering being done with the block cipher using the first key (K); and incrementing after every different message encryption the counter by a number equal to a number of plaintext segments in the message; and further comprising for segmented decryption of the ciphertext segments of the partitioned ciphertext string the steps of: selecting a counter block holding the count of the counter from the string presented for decryption; enciphering the result of adding modulo 2^{λ} the segment number with the selected counter block to obtain the secret random number per ciphertext segment.

In a further aspect of the present invention, the enciphering of the result of adding modulo 2^{λ} the segment number with a counter initialized to a constant step comprises enciphering with the block cipher using the same key as that used for segmented encryption.

In a further aspect of the present invention, there are provided the steps of: for the segmented encryption method generating each of the secret random number per segment from a per-key secret, first random initial number shared between sender and receiver and the result of adding modulo 2^{λ} the segment number to a counter initialized to a constant; and outputting the counter value as an output block of the output ciphertext string; and incrementing after every different message encryption the counter by a number equal to a number of plaintext segments in the message; and further comprising for segmented decryption of the ciphertext segments of the partitioned ciphertext string the steps of: selecting a counter block holding the count of the counter from the string presented for decryption; and generating each of the secret random number per ciphertext segment from the per-key secret, first random initial number shared between sender and receiver and the result of adding modulo 2^{λ} the segment number to the counter.

In a yet further embodiment of the present invention, there is provided a parallel encryption method for providing both data confidentiality and integrity for a message, that updates a ciphertext string incrementally, comprising the steps of: receiving an input plaintext string comprising a message; generating a plurality of equal-sized blocks of λ bits in length from the input plaintext string; creating an MDC block of λ bits in length that includes the result of applying a non-cryptographic Manipulation Detection Code (MDC) function to the plurality of the equal-size blocks; performing a plaintext randomization function over the plurality of equal-sized blocks of the plaintext and the MDC block to create a plurality of hidden plaintext blocks each of λ bits in length; processing each of the hidden plaintext blocks by a block cipher using a secret key (K) to obtain a plurality of hidden ciphertext blocks; performing a hidden ciphertext randomization function over the plurality of hidden ciphertext blocks to create a plurality of output ciphertext blocks each of λ bits in length; and further comprising the steps of: receiving an input plaintext string; generating a plurality of equal-sized blocks of λ bits in length from the input plaintext string; receiving an input ciphertext string including a plurality of n+1 equal-size blocks of the ciphertext of λ bits in length, wherein the n+1 block of the ciphertext corresponds to an MDC block for the plaintext string; receiving a new λ-bit plaintext block to replace an λ-bit plaintext block at index i; creating a new MDC block of λ bits in length that includes the result of applying a non-cryptographic Manipulation Detection Code (MDC) function to the plurality of the equal-size blocks and the new λ-bit plaintext block; performing the same plaintext randomization function as that used at a parallel encryption method over the new λ-bit plaintext block and the new MDC block to create two new hidden plaintext blocks each of λ bits in length using index i for the new λ-bit plaintext block and index n+1 for the new MDC block; processing each of the two new hidden plaintext blocks by a block cipher using the secret key (K) to obtain two new hidden ciphertext blocks; performing the same hidden ciphertext randomization function as that used at a parallel encryption method over the two new hidden ciphertext blocks to create two new output ciphertext blocks each of λ bits in length using index i for the new λ-bit plaintext block and index n+1 for the new MDC block; replacing in the input ciphertext string, the input ciphertext block at index i with the output ciphertext block for the new λ-bit plaintext block and replace the input ciphertext block at index n+1 with the output ciphertext block for the new MDC block, to create a new ciphertext string; and outputting the new ciphertext string.

In a further aspect of the present invention, the generating a plurality of equal-sized blocks of λ bits in length from the input plaintext string further comprises the steps of: padding the input plaintext string as necessary such that its length is a multiple of λ bits; and partitioning the padded input plaintext string into a plurality of equal-size blocks of λ bits in length.

In a further aspect of the present invention, there are provided the steps of: receiving a plurality of new λ-bit plaintext blocks to replace a plurality of λ-bit plaintext blocks at the plaintext string at index i; and providing a parallel encryption method that outputs a ciphertext string incrementally for each of the plurality of new λ-bit plaintext blocks.

In a yet further embodiment of the present invention, there is provided a parallel encryption method for providing both data confidentiality and integrity for a message, comprising the steps of: receiving an input plaintext string comprising a message; generating a plurality of equal-sized blocks of λ bits in length from the input plaintext string; partitioning the padded input plaintext string into a plurality of equal-size blocks of λ bits in length; creating an MDC block of λ bits in length that includes the result of applying a non-cryptographic Manipulation Detection Code (MDC) function to the plurality of the equal-size blocks; performing a plaintext randomization function over the plurality of equal-sized blocks of the plaintext and the MDC block using a different plaintext index for each equal-sized block and the MDC block to create a plurality of hidden plaintext blocks each of λ bits in length; processing each of the hidden plaintext blocks by a block cipher using a secret key (K) to obtain a plurality of hidden ciphertext blocks; performing a hidden ciphertext randomization function over the plurality of hidden ciphertext blocks using a different ciphertext index for each hidden ciphertext block to create a plurality of output ciphertext blocks each of λ bits in length; and further providing an out-of-order decryption method for the parallel encryption method, which provides both data confidentiality and integrity, comprising the steps of: receiving a string including a plurality of n+1 λ-bit ciphertext blocks for decryption; selecting n+1 ciphertext blocks from the plurality of ciphertext blocks representing n data blocks and one MDC block and performing a reverse hidden ciphertext randomization function on each of the selected n+1 ciphertext blocks using the ciphertext index to obtain a plurality of hidden ciphertext blocks each of λ bits in length; processing each of the hidden ciphertext blocks with the inverse of the block cipher used at an encryption method using the secret key (K) to obtain a plurality of hidden plaintext blocks; and performing an inverse plaintext randomization function over the plurality of hidden plaintext blocks using the plaintext index to create a plurality of n decrypted plaintext data blocks and one decrypted MDC block each of λ-bit length; creating an MDC decryption block by applying the non-cryptographic Manipulation Detection Code function to the n decrypted plaintext data blocks in the same manner as at a parallel encryption method; verifying integrity of the plaintext blocks by comparing the created MDC decryption block with the decrypted MDC block; outputting the plurality of plaintext blocks as an accurate plaintext string if the integrity verification passes; and outputting a failure indicator if the integrity verification fails.

In a further aspect of the present invention, the generating a plurality of equal-sized blocks of λ bits in length from the input plaintext string further comprises the steps of: padding the input plaintext string as necessary such that its length is a multiple of λ bits; and partitioning the padded input plaintext string into a plurality of equal-size blocks of λ bits in length.

In a yet further embodiment of the present invention, there is provided a program product for parallel encryption for providing both data confidentiality and integrity for a message, including machine-readable program code for causing a machine to perform the following method steps: receiving an input plaintext string comprising a message; generating a plurality of equal-sized blocks of λ bits in length from the input plaintext string; creating an MDC block of λ bits in length that includes the result of applying a non-cryptographic Manipulation Detection Code (MDC) function to the plurality of the equal-size blocks; presenting the equal-size blocks and the MDC block to a selected parallel encryption mode that makes one and only one processing pass with a single cryptographic primitive over each of the equal-size blocks and the MDC block to create a plurality of hidden ciphertext blocks each of λ bits in length; and performing a hidden ciphertext randomization function over the plurality of hidden ciphertext blocks to create a plurality of output ciphertext blocks each of λ bits in length.

In a further aspect of the present invention, the program code includes code to cause: the step of presenting the equal-size blocks and the MDC block to a selected parallel encryption mode processing each of the equal-size blocks and the MDC block by a parallel encryption mode to be confidentiality-secure against chosen-plaintext attacks, wherein each of the equal-size blocks and the MDC block is processed by a block cipher using a secret key (K) to obtain the plurality of hidden ciphertext blocks; and to cause the step of performing a hidden ciphertext randomization function step comprises code for combining each of the hidden ciphertext blocks with a corresponding element of a sequence of unpredictable elements for the hidden ciphertext to create a set of output blocks of the ciphertext, wherein a hidden ciphertext block identified by an index i is combined with the element of the sequence identified by index i by an operation for the hidden ciphertext that has an inverse.

In a further aspect of the present invention, the program code for causing the performance of the step of processing each of the equal-size blocks and the MDC block by a parallel encryption mode that is confidentiality-secure against chosen-plaintext attacks comprises code for: performing a plaintext randomization function over the plurality of equal-sized blocks of the plaintext and the MDC block to create a plurality of hidden plaintext blocks each of λ bits in length; and processing each of the hidden plaintext blocks by a block cipher using the secret key (K) to obtain the plurality of hidden ciphertext blocks.

In a further aspect of the present invention, the program code for performing a plaintext randomization function step comprises code for combining each of the equal-size blocks and the MDC block with a corresponding element of a sequence of unpredictable elements for the hidden plaintext to create a set of hidden plaintext blocks, wherein an equal-size block or the MDC block identified by an index i is combined with the element of the sequence identified by index i by an operation for the hidden plaintext that has an inverse.

In a further aspect of the present invention, the result of the combination of any two different unpredictable elements of the sequence of unpredictable elements for the hidden ciphertext by the inverse operation of the operation for the hidden ciphertext is unpredictable; and wherein the unpredictable elements selected as the two unpredictable elements for the hidden ciphertext are any two different elements of the same sequence of unpredictable elements for the hidden ciphertext used for the encryption of the plaintext string; and wherein the unpredictable elements selected as the two unpredictable elements for the hidden ciphertext are any two different elements of a plurality of sequences of unpredictable elements for the hidden ciphertext used for encryption of a plurality of plaintext strings with the same secret key K.

In a further aspect of the present invention, the result of the combination of any two different unpredictable elements of the sequence of unpredictable elements for the hidden plaintext by the inverse operation of the operation for the hidden plaintext is unpredictable; and wherein the unpredictable elements selected as the two unpredictable elements for the hidden plaintext are any two different elements of the same sequence of unpredictable elements for the hidden plaintext used for the encryption of the plaintext string; and wherein the unpredictable elements selected as the two unpredictable elements for the hidden plaintext are any two different elements of a plurality of sequences of unpredictable elements for the hidden plaintext used for encryption of a plurality of plaintext strings with the same secret key K.

In a further embodiment of the present invention, a program product is provided for parallel decryption that is the inverse of a program product for parallel encryption which provides both data confidentiality and integrity, comprising machine-readable program code for causing a machine to perform the following method steps: presenting a string including ciphertext string for decryption; partitioning the ciphertext string into a plurality of ciphertext blocks comprising λ bits each; selecting n+1 ciphertext blocks from the plurality of ciphertext blocks representing n data blocks and one MDC block and performing a reverse hidden ciphertext randomization function on each of the selected n+1 ciphertext blocks to obtain a plurality of hidden ciphertext blocks each of λ bits in length; presenting the hidden ciphertext blocks to a selected parallel decryption mode that makes one and only one processing pass with a single cryptographic primitive that is the inverse of an encryption single cryptographic primitive over the plurality of hidden ciphertext blocks to obtain a plurality of plaintext blocks and one decrypted MDC block each of λ bits in length; verifying integrity of the plaintext blocks using a non-cryptographic Manipulation Detection Function (MDC) function; outputting the plurality of plaintext blocks as an accurate plaintext string if the integrity verification passes; and outputting a failure indicator if the integrity verification fails.

In a further aspect of the present invention, the program code for causing the performance of the step of selecting n+1 ciphertext blocks from the plurality of ciphertext blocks representing n data blocks and one MDC block and performing the reverse hidden-ciphertext randomization function comprises code for: generating a sequence of unpredictable elements for the hidden ciphertext each of λ-bit length in the same manner as used at an encryption program product; selecting n+1 ciphertext blocks from the plurality of ciphertext blocks representing n data blocks and one MDC block in the same order as that used at an encryption program product, and combining the selected ciphertext blocks with the sequence of unpredictable elements for the hidden ciphertext to obtain a plurality of hidden ciphertext blocks (zₗ), such that each of the n+1 ciphertext blocks identified by index i is combined with the element of the sequence of unpredictable elements for the hidden ciphertext identified by index i, by the inverse of the operation for the hidden ciphertext used at the encryption program product; and wherein the program code for causing the performance of the step of verifying integrity comprises code for creating an MDC decryption block by applying the non-cryptographic Manipulation Detection Code function to the n decrypted plaintext data blocks; and code for comparing the created MDC decryption block with the decrypted MDC block.

In a further aspect of the present invention, the program code for causing the performance of the step of presenting the hidden ciphertext blocks to a selected parallel decryption mode comprises code for: processing each of the hidden ciphertext blocks with the inverse of the block cipher used at an encryption program product using a secret key (K) to obtain a plurality of hidden plaintext blocks; and performing a reverse plaintext randomization function over the plurality of hidden plaintext blocks to create a plurality of n decrypted plaintext data blocks and one decrypted MDC block each of λ bits in length.

In a further aspect of the present invention, the program code for causing the performance of the reverse plaintext randomization function comprises code for: generating a sequence of unpredictable elements for the hidden plaintext each of λ-bit length in the same manner as used at an encryption program product; and combining the selected hidden plaintext blocks with the sequence of unpredictable elements for the hidden plaintext to obtain a plurality of n plaintext blocks and one decrypted MDC block, such that each of the n+1 hidden plaintext blocks identified by index i is combined with the element of the sequence of unpredictable elements for the hidden plaintext identified by index i, by the inverse of the operation for the hidden plaintext used at the encryption program product.

In a further embodiment of the present invention, a program product is provided for segmented encryption processing of a message comprising machine-readable program code for causing the performance of the following method steps: partitioning the input plaintext string into a plurality of input plaintext segments; concurrently presenting each different one of the plurality of input plaintext segments to a different one of a plurality of program products for parallel encryption, each of the different program products using a different λ-bit secret random number per segment to obtain a ciphertext segment, wherein each encryption program product provides both data confidentiality and integrity with a single processing pass over the input plaintext segment and a single cryptographic primitive, and uses a non-cryptographic Manipulation Detection Code function, wherein the single cryptographic primitive is an λ-bit block cipher using a secret key; assembling the plurality of ciphertext segments into a ciphertext string; and outputting the ciphertext string.

In a further aspect of the present invention, the program code for causing the performance of the step of assembling comprises code for including in the ciphertext string the number of ciphertext segments, a ciphertext segment index, a length of each ciphertext segment and a sequence of ciphertext segments.

In a further embodiment of the present invention, a program product is provided for segmented decryption processing of a message comprising machine-readable program code for causing a machine to perform the following method steps: presenting a string including the ciphertext string of a message for decryption; partitioning the ciphertext string into a plurality of ciphertext segments; concurrently presenting the plurality of ciphertext segments to a plurality of decryption modes; obtaining a different secret random number per ciphertext segment in the same manner as at the program product for segmented encryption; for decrypting each ciphertext segment using the different secret random number per ciphertext segment to obtain a plaintext segment, using a program product for parallel decryption that is the inverse of a program product for parallel encryption that provides both data confidentiality and integrity with a single processing pass over the input plaintext segment and a single cryptographic primitive, wherein the single cryptographic primitive is an λ-bit block cipher using a secret key, and using a non-cryptographic Manipulation Detection Code function for verifying integrity of the plaintext blocks of each plaintext segment; and verifying the integrity of each plaintext segment and for each plaintext segment, outputting either the plaintext segment if the integrity verification passes, or an error indicator.

In a yet further embodiment of the present invention, a system is disclosed for parallel encryption for providing both data confidentiality and integrity for a message, comprising: a first component for receiving an input plaintext string comprising a message; a second component for generating a plurality of equal-sized blocks of λ bits in length from the input plaintext string; a third component for creating an MDC block of λ bits in length that includes the result of applying a non-cryptographic Manipulation Detection Code (MDC) function to the plurality of the equal-size blocks; a fourth component for presenting the equal-size blocks and the MDC block to a selected parallel encryption mode that makes one and only one processing pass with a single cryptographic primitive over each of the equal-size blocks and the MDC block to create a plurality of hidden ciphertext blocks each of λ bits in length; and a fifth component for performing a hidden ciphertext randomization function over the plurality of hidden ciphertext blocks to create a plurality of output ciphertext blocks each of λ bits in length.

In a further aspect of the present invention, the fourth component for presenting the equal-size blocks and the MDC block to a selected parallel encryption mode comprises a component for processing each of the equal-size blocks and the MDC block by a parallel encryption mode is confidentiality-secure against chosen-plaintext attacks, wherein each of the equal-size blocks and the MDC block is processed by a block cipher using a secret key (K) to obtain the plurality of hidden ciphertext blocks; and wherein the fifth component for performing a hidden ciphertext randomization function step comprises a component for combining each of the hidden ciphertext blocks with a corresponding element of a sequence of unpredictable elements for the hidden ciphertext to create a set of output blocks of the ciphertext, wherein a hidden ciphertext block identified by an index i is combined with the element of the sequence identified by index i by an operation for the hidden ciphertext that has an inverse.

In a further aspect of the present invention, the component for processing each of the equal-size blocks and the MDC block by a parallel encryption mode that is confidentiality-secure against chosen-plaintext attacks comprises: a component for performing a plaintext randomization function over the plurality of equal-sized blocks of the plaintext and the MDC block to create a plurality of hidden plaintext blocks each of λ bits in length; and a component for processing each of the hidden plaintext blocks by a block cipher using the secret key (K) to obtain the plurality of hidden ciphertext blocks.

In a further aspect of the present invention, the component for performing a plaintext randomization function step comprises a component for combining each of the equal-size blocks and the MDC block with a corresponding element of a sequence of unpredictable elements for the hidden plaintext to create a set of hidden plaintext blocks, wherein an equal-size block or the MDC block identified by an index i is combined with the element of the sequence identified by index i by an operation for the hidden plaintext that has an inverse.

In a further aspect of the present invention, the result of the combination of any two different unpredictable elements of the sequence of unpredictable elements for the hidden ciphertext by the inverse operation of the operation for the hidden ciphertext is unpredictable; and wherein the unpredictable elements selected as the two unpredictable elements for the hidden ciphertext are any two different elements of the same sequence of unpredictable elements for the hidden ciphertext used for the encryption of the plaintext string; and wherein the unpredictable elements selected as the two unpredictable elements for the hidden ciphertext are any two different elements of a plurality of sequences of unpredictable elements for the hidden ciphertext: used for encryption of a plurality of plaintext strings with the same secret key K.

In a further aspect of the present invention, the result of the combination of any two different unpredictable elements of the sequence of unpredictable elements for the hidden plaintext by the inverse operation of the operation for the hidden plaintext is unpredictable; and wherein the unpredictable elements selected as the two unpredictable elements for the hidden plaintext are any two different elements of the same sequence of unpredictable elements for the hidden plaintext used for the encryption of the plaintext string; and wherein the unpredictable elements selected as the two unpredictable elements for the hidden plaintext are any two different elements of a plurality of sequences of unpredictable elements for the hidden plaintext used for encryption of a plurality of plaintext strings with the same secret key K.

In a yet further embodiment of the present invention, a system is disclosed for parallel decryption that is the inverse of a system for parallel encryption which provides both data confidentiality and integrity, comprising: a first component for presenting a string including ciphertext string for decryption; a second component for partitioning the ciphertext string into a plurality of ciphertext blocks comprising λ bits each; a third component for selecting n+1 ciphertext blocks from the plurality of ciphertext blocks representing n data blocks and one MDC block and performing a reverse hidden ciphertext randomization function on each of the selected n+1 ciphertext blocks to obtain a plurality of hidden ciphertext blocks each of λ bits in length; a fourth component for presenting the hidden ciphertext blocks to a selected parallel decryption mode that makes one and only one processing pass with a single cryptographic primitive that is the inverse of an encryption single cryptographic primitive over the plurality of hidden ciphertext blocks to obtain a plurality of plaintext blocks and one decrypted MDC block each of λ bits in length; a fifth component for verifying integrity of the plaintext blocks using a non-cryptographic Manipulation Detection Function (MDC) function; a sixth component for outputting the plurality of plaintext blocks as an accurate plaintext string if the integrity verification passes; and a seventh component for outputting a failure indicator if the integrity verification fails.

In a further aspect of the present invention, the third component for selecting n+1 ciphertext blocks from the plurality of ciphertext blocks representing n data blocks and one MDC block and performing the reverse hidden-ciphertext randomization function comprises: a component for generating a sequence of unpredictable elements for the hidden ciphertext each of λ-bit length in the same manner as used at an encryption system; a component for selecting n+1 ciphertext blocks from the plurality of ciphertext blocks representing n data blocks and one MDC block in the same order as that used at an encryption system, and combining the selected ciphertext blocks with the sequence of unpredictable elements for the hidden ciphertext to obtain a plurality of hidden ciphertext blocks (zₗ), such that each of the n+1 ciphertext blocks identified by index i is combined with the element of the sequence of unpredictable elements for the hidden ciphertext identified by index i, by the inverse of the operation for the hidden ciphertext used at the encryption system; and wherein the fifth code for verifying integrity step comprises a component for creating an MDC decryption block by applying the non-cryptographic Manipulation Detection Code function to the n decrypted plaintext data blocks; and a component for comparing the created MDC decryption block with the decrypted MDC block.

In a further aspect of the present invention, the fourth component for presenting the hidden ciphertext blocks to a selected parallel decryption mode comprises: a component for processing each of the hidden ciphertext blocks with the inverse of the block cipher used at an encryption system using a secret key (K) to obtain a plurality of hidden plaintext blocks; and a component for performing a reverse plaintext randomization function over the plurality of hidden plaintext blocks to create a plurality of n decrypted plaintext data blocks and one decrypted MDC block of λ bits in length.

In a further aspect of the present invention, the component for performing the reverse plaintext randomization function comprises: a component for generating a sequence of unpredictable elements for the hidden plaintext each of λ-bit length in the same manner as used at an encryption system; and a component for combining the selected hidden plaintext blocks with the sequence of unpredictable elements for the hidden plaintext to obtain a plurality of n plaintext blocks and one decrypted MDC block, such that each of the n+1 hidden plaintext blocks identified by index i is combined with the element of the sequence of unpredictable elements for the hidden plaintext identified by index i, by the inverse of the operation for the hidden plaintext used at the encryption system.

In a yet further embodiment of the present invention, a system is disclosed for segmented encryption processing of a message comprising: a first component for partitioning the input plaintext string into a plurality of input plaintext segments; a second component for concurrently presenting each different one of the plurality of input plaintext segments to a different one of a plurality of systems for parallel encryption, each of the different systems using a different λ-bit secret random number per segment to obtain a ciphertext segment, wherein each encryption system provides both data confidentiality and integrity with a single processing pass over the input plaintext segment and a single cryptographic primitive, and uses a non-cryptographic Manipulation Detection Code function, wherein the single cryptographic primitive is an λ-bit block cipher using a secret key; a third component for assembling the plurality of ciphertext segments into a ciphertext string; and a fourth component outputting the ciphertext string.

In a further aspect of the present invention, the third component for assembling step comprises a component for including in the ciphertext string the number of ciphertext segments, a ciphertext segment index, a length of each ciphertext segment and a sequence of ciphertext segments.

In a yet further embodiment of the present invention, a system is disclosed for segmented decryption processing of a message comprising: a first component for presenting a string including the ciphertext string of a message for decryption; a second component for partitioning the ciphertext string into a plurality of ciphertext segments; a third component for concurrently presenting the plurality of ciphertext segments to a plurality of decryption modes; a fourth component for obtaining a different secret random number per ciphertext segment in the same manner as at the system for segmented encryption; a fifth component for decrypting each ciphertext segment using the different secret random number per ciphertext segment to obtain a plaintext segment, using a system for parallel decryption that is the inverse of a system for parallel encryption that provides both data confidentiality and integrity with a single processing pass over the input plaintext segment and a single cryptographic primitive, wherein the single cryptographic primitive is an λ-bit block cipher using a secret key, and using a non-cryptographic Manipulation Detection Code function for verifying integrity of the plaintext blocks of each plaintext segment; and a sixth component for verifying the integrity of each plaintext segment and for each plaintext segment, outputting either the plaintext segment if the integrity verification passes, or an error indicator.

In a yet further embodiment of the present invention, a program product is disclosed for a parallel encryption for providing both data confidentiality and integrity for a message, that updates a ciphertext string incrementally, including machine-readable code for performing the following method steps: receiving an input plaintext string comprising a message; generating a plurality of equal-sized blocks of λ bits in length from the input plaintext string; creating an MDC block of λ bits in length that includes the result of applying a non-cryptographic Manipulation Detection Code (MDC) function to the plurality of the equal-size blocks; performing a plaintext randomization function over the plurality of equal-sized blocks of the plaintext and the MDC block to create a plurality of hidden plaintext blocks each of λ bits in length; processing each of the hidden plaintext blocks by a block cipher using a secret key (K) to obtain a plurality of hidden ciphertext blocks; performing a hidden ciphertext randomization function over the plurality of hidden ciphertext blocks to create a plurality of output ciphertext blocks each of λ bits in length; and further including machine-readable code for performing the following method steps: receiving an input plaintext string; generating a plurality of equal-sized blocks of λ bits in length from the input plaintext string; receiving an input ciphertext string including a plurality of n+1 equal-size blocks of the ciphertext of λ bits in length, wherein the n+1 block of the ciphertext corresponds to an MDC block for the plaintext string; receiving a new λ-bit plaintext block to replace an λ-bit plaintext block at index i; creating a new MDC block of λ bits in length that includes the result of applying a non-cryptographic Manipulation Detection Code (MDC) function to the plurality of the equal-size blocks and the new λ-bit plaintext block; performing the same plaintext randomization function as that used at a parallel encryption method over the new λ-bit plaintext block and the new MDC block to create two new hidden plaintext blocks each of λ bits in length using index i for the new λ-bit plaintext block and index n+1 for the new MDC block; processing each of the two new hidden plaintext blocks by a block cipher using the secret key (K) to obtain two new hidden ciphertext blocks; performing the same hidden ciphertext randomization function as that used at a parallel encryption method over the two new hidden ciphertext blocks to create two new output ciphertext blocks each of λ bits in length using index i for the new λ-bit plaintext block and index n+1 for the new MDC block; replacing in the input ciphertext string, the input ciphertext block at index i with the output ciphertext block for the new λ-bit plaintext block and replace the input ciphertext block at index n+1 with the output ciphertext block for the new MDC block, to create a new ciphertext string; and outputting the new ciphertext string.

In a further aspect of the present invention, the program code for causing the performance of the step of generating a plurality of equal-sized blocks of λ bits in length from the input plaintext string further comprises code for: padding the input plaintext string as necessary such that its length is a multiple of λ bits; and partitioning the padded input plaintext string into a plurality of equal-size blocks of λ bits in length.

In a further aspect of the present invention, the program product claim includes machine-readable code for performing the method steps: receiving a plurality of new λ-bit plaintext blocks to replace a plurality of λ-bit plaintext blocks at the plaintext string at index i; and providing a parallel encryption method that outputs a ciphertext string incrementally for each of the plurality of new λ-bit plaintext blocks.

In a yet further embodiment of the present invention, a program product is disclosed for parallel encryption method for providing both data confidentiality and integrity for a message, including machine-readable program code for causing a machine to perform the method steps: receiving an input plaintext string comprising a message; generating a plurality of equal-sized blocks of λ bits in length from the input plaintext string; partitioning the padded input plaintext string into a plurality of equal-size blocks of λ bits in length; creating an MDC block of λ bits in length that includes the result of applying a non-cryptographic Manipulation Detection Code (MDC) function to the plurality of the equal-size blocks; performing a plaintext randomization function over the plurality of equal-sized blocks of the plaintext and the MDC block using a different plaintext index for each equal-sized block and the MDC block to create a plurality of hidden plaintext blocks each of λ bits in length; processing each of the hidden plaintext blocks by a block cipher using a secret key (K) to obtain a plurality of hidden ciphertext blocks; performing a hidden ciphertext randomization function over the plurality of hidden ciphertext blocks using a different ciphertext index for each hidden ciphertext block to create a plurality of output ciphertext blocks each of λ bits in length; and further including machine-readable program code for performing an out-of-order decryption method for the parallel encryption method, which provides both data confidentiality and integrity, including code for: receiving a string including a plurality of n+1 λ-bit ciphertext blocks for decryption; selecting n+1 ciphertext blocks from the plurality of ciphertext blocks representing n data blocks and one MDC block and performing a reverse hidden ciphertext randomization function on each of the selected n+1 ciphertext blocks using the ciphertext index to obtain a plurality of hidden ciphertext blocks each of λ bits in length; processing each of the hidden ciphertext blocks with the inverse of the block cipher used at an encryption method using the secret key (K) to obtain a plurality of hidden plaintext blocks; and performing an inverse plaintext randomization function over the plurality of hidden plaintext blocks using the plaintext index to create a plurality of n decrypted plaintext data blocks and one decrypted MDC block each of λ-bit length; creating an MDC decryption block by applying the non-cryptographic Manipulation Detection Code function to the n decrypted plaintext data blocks in the same manner as at a parallel encryption method; verifying integrity of the plaintext blocks by comparing the created MDC decryption block with the decrypted MDC block; outputting the plurality of plaintext blocks as an accurate plaintext string if the integrity verification passes; and outputting a failure indicator if the integrity verification fails.

In a further aspect of the present invention, the program code for generating a plurality of equal-sized blocks of λ bits in length from the input plaintext string comprises code for: padding the input plaintext string as necessary such that its length is a multiple of λ bits; and partitioning the padded input plaintext string into a plurality of equal-size blocks of λ bits in length.

In a yet further embodiment of the present invention, a system is disclosed for a parallel encryption for providing both data confidentiality and integrity for a message, that updates a ciphertext string incrementally, comprising: a first component for receiving an input plaintext string comprising a message; a second component for generating a plurality of equal-sized blocks of λ bits in length from the input plaintext string; a third component for creating an MDC block of λ bits in length that includes the result of applying a non-cryptographic Manipulation Detection Code (MDC) function to the plurality of the equal-size blocks; a fourth component for performing a plaintext randomization function over the plurality of equal-sized blocks of the plaintext and the MDC block to create a plurality of hidden plaintext blocks each of λ bits in length; a fifth component for processing each of the hidden plaintext blocks by a block cipher using a secret key (K) to obtain a plurality of hidden ciphertext blocks; a sixth component for performing a hidden ciphertext randomization function over the plurality of hidden ciphertext blocks to create a plurality of output ciphertext blocks each of λ bits in length; and further comprising: a seventh component for receiving an input plaintext string; an eight component for generating a plurality of equal-sized blocks of λ bits in length from the input plaintext string; a ninth component for receiving an input ciphertext string including a plurality of n+1 equal-size blocks of the ciphertext of λ bits in length, wherein the n+1 block of the ciphertext corresponds to an MDC block for the plaintext string; a tenth component for receiving a new λ-bit plaintext block to replace an λ-bit plaintext block at index i; an eleventh component for creating a new MDC block of λ bits in length that includes the result of applying a non-cryptographic Manipulation Detection Code (MDC) function to the plurality of the equal-size blocks and the new λ-bit plaintext block; a twelfth component for performing the same plaintext randomization function as that used at a parallel encryption method over the new λ-bit plaintext block and the new MDC block to create two new hidden plaintext blocks each of λ bits in length using index i for the new λ-bit plaintext block and index n+1 for the new MDC block; a thirteenth component for processing each of the two new hidden plaintext blocks by a block cipher using the secret key (K) to obtain two new hidden ciphertext blocks; a fourteenth component for performing the same hidden ciphertext randomization function as that used at a parallel encryption method over the two new hidden ciphertext blocks to create two new output ciphertext blocks each of λ bits in length using index i for the new λ-bit plaintext block and index n+1 for the new MDC block; a fifteenth component for replacing in the input ciphertext string, the input ciphertext block at index i with the output ciphertext block for the new λ-bit plaintext block and replace the input ciphertext block at index n+1 with the output ciphertext block for the new MDC block, to create a new ciphertext string; and a sixteenth component for outputting the new ciphertext string.

In a further aspect of the present invention, the second component for generating a plurality of equal-sized blocks of λ bits in length from the input plaintext string further comprises: a component for padding the input plaintext string as necessary such that its length is a multiple of λ bits; and a component for partitioning the padded input plaintext string into a plurality of equal-size blocks of λ bits in length.

In a further aspect of the present invention, the system further comprises: a component for receiving a plurality of new λ-bit plaintext blocks to replace a plurality of λ-bit plaintext blocks at the plaintext string at index i; and a component for providing a parallel encryption method that outputs a ciphertext string incrementally for each of the plurality of new λ-bit plaintext blocks.

In a yet further embodiment of the present invention, a system is disclosed for parallel encryption method for providing both data confidentiality and integrity for a message, comprising: a first component for receiving an input plaintext string comprising a message; a second component for generating a plurality of equal-sized blocks of λ bits in length from the input plaintext string; a third component for partitioning the padded input plaintext string into a plurality of equal-size blocks of λ bits in length; a fourth component for creating an MDC block of λ bits in length that includes the result of applying a non-cryptographic Manipulation Detection Code (MDC) function to the plurality of the equal-size blocks; a fifth component for performing a plaintext randomization function over the plurality of equal-sized blocks of the plaintext and the MDC block using a different plaintext index for each equal-sized block and the MDC block to create a plurality of hidden plaintext blocks each of λ bits in length; a sixth component for processing each of the hidden plaintext blocks by a block cipher using a secret key (K) to obtain a plurality of hidden ciphertext blocks; a seventh component for performing a hidden ciphertext randomization function over the plurality of hidden ciphertext blocks using a different ciphertext index for each hidden ciphertext block to create a plurality of output ciphertext blocks each of λ bits in length; and further comprising for performing an out-of-order decryption method for the parallel encryption method, which provides both data confidentiality and integrity: an eighth component for receiving a string including a plurality of n+1 λ-bit ciphertext blocks for decryption; a ninth component for selecting n+1 ciphertext blocks from the plurality of ciphertext blocks representing n data blocks and one MDC block and performing a reverse hidden ciphertext randomization function on each of the selected n+1 ciphertext blocks using the ciphertext index to obtain a plurality of hidden ciphertext blocks each of λ bits in length; a tenth component for processing each of the hidden ciphertext blocks with the inverse of the block cipher used at an encryption method using the secret key (K) to obtain a plurality of hidden plaintext blocks; and an eleventh component for performing an inverse plaintext randomization function over the plurality of hidden plaintext blocks using the plaintext index to create a plurality of n decrypted plaintext data blocks and one decrypted MDC block each of λ-bit length; a twelfth component for creating an MDC decryption block by applying the non-cryptographic Manipulation Detection Code function to the n decrypted plaintext data blocks in the same manner as at a parallel encryption method; a thirteenth component for verifying integrity of the plaintext blocks by comparing the created MDC decryption block with the decrypted MDC block; a fourteenth component for outputting the plurality of plaintext blocks as an accurate plaintext string if the integrity verification passes; and a fifteenth component for outputting a failure indicator if the integrity verification fails.

In a further aspect of the present invention, the second component for generating a plurality of equal-sized blocks of λ bits in length from the input plaintext string comprises: a component for padding the input plaintext string as necessary such that its length is a multiple of λ bits; and a component for partitioning the padded input plaintext string into a plurality of equal-size blocks of λ bits in length.

### BRIEF DESCRIPTION OF THE DRAWINGS

For a more complete understanding of the present invention and the advantages thereof, reference should be made to the following Detailed Description taken in connection with the accompanying drawings, in which:

FIG. 1 illustrates a schematic diagram of the method of the present invention for the parallel encryption of input plaintext string x=x₁ x₂ x₃ x₄, using secret key K to obtain output ciphertext string y=y₀ y₁ y₂ y₃ y₄ y₅.

FIG. 2 illustrates a schematic diagram of the method of the present invention for the parallel decryption of the input ciphertext string y=y₀ y₁ y₂ y₃ y₄ y₅, using secret key K to obtain the output plaintext string x=x₁ x₂ x₃ x₄ or the error indicator.

FIG. 3 illustrates a schematic diagram for the preferred embodiment of this invention of the stateless parallel encryption mode in which input plaintext string x=x₁ x₂ x₃ x₄ is encrypted using secret key K to obtain output ciphertext y=y₀ y₁ y₂ y₃ y₄ y₅.

FIG. 4 illustrates a schematic diagram for the preferred embodiment of this invention of the stateless parallel decryption mode in which input ciphertext string y=y₀ y₁ y₂ y₃ y₄ y₅ is decrypted using secret key K to obtain output plaintext string x=x₁ x₂ x₃ x₄ or the error indicator.

FIG. 5 illustrates a schematic diagram for the preferred embodiment of this invention of the stateful-sender parallel encryption mode in which input plaintext string x=x₁ x₂ x₃ x₄ is encrypted using secret key K to obtain output ciphertext y=y₁ y₂ y₃ y₄ y₅.

FIG. 6 illustrates a schematic diagram for the preferred embodiment of this invention of the stateful-sender parallel decryption mode in which input ciphertext string y=y₁ y₂ y₃ y₄ y₅ is decrypted using secret key K to obtain output plaintext string x=x₁ x₂ x₃ x₄ or the error indicator.

FIG. 7 illustrates a schematic diagram for the preferred embodiment of this invention of the stateful parallel encryption mode in which input plaintext string x=x₁ x₂ x₃ x₄ is encrypted using secret key K to obtain output ciphertext y=y₁ y₂ y₃ y₄ y₅.

FIG. 8 illustrates a schematic diagram for the preferred embodiment of this invention of the stateful parallel decryption mode in which input ciphertext string y=y₁ y₂ y₃ y₄ y₅ is decrypted using secret key K to obtain output plaintext string x=x₁ x₂ x₃ x₄ or the error indicator.

FIG. 9 illustrates a schematic diagram for the preferred embodiment of the three-segment stateful-sender parallel encryption mode in which input plaintext string x=x₁ x₂ x₃ x₄ x₅ x₆ x₇ x₈ x₉ x₁₀ x₁₁ x₁₂ is encrypted using secret key K to obtain output ciphertext string y=y₁ y₂ y₃ y₄ y′₅ y₅ y₆ y₇ y₈ y′₉ y₉ y₁₀ y₁₁ y₁₂ y′₁₃.

FIG. 10 illustrates a schematic diagram for the preferred embodiment of the three-segment stateful-sender parallel decryption mode in which input ciphertext string y=y₁ y₂ y₃ y₄ y′₅ y₅ y₆ y₇ y₈ y′₉ y₉ y₁₀ y₁₁ y₁₂ y′₁₃ is decrypted using secret key K to obtain a plurality of output plaintext segment x₁ x₂ x₃ x₄ or a first error indicator, output plaintext segment x₅ x₆ x₇ x₈ or a second error indicator, and output plaintext segment x₉ x₁₀ x₁₁ x₁₂ or a third error indicator.

FIG. 11 illustrates a schematic diagram for the preferred embodiment of the three-segment stateful parallel encryption mode in which input plaintext string x=x₁ x₂ x₃ x₄ x₅ x₆ x₇ x₈ x₉ x₁₀ x₁₁ x₁₂ is encrypted using secret key K to obtain output ciphertext string y=y₁ y₂ y₃ y₄ y′₅ y₅ y₆ y₇ y₈ y′₉ y₉ y₁₀ y₁₁ y₁₂ y′₁₃.

FIG. 12 illustrates a schematic diagram for the preferred embodiment of the three-segment stateful parallel decryption mode in which input ciphertext string y=y₁ y₂ y₃ y₄ y′₅ y₅ y₆ y₇ y₈ y′₉ y₉ y₁₀ y₁₁ y₁₂ y′₁₃ is decrypted using secret key K to obtain a plurality of output plaintext segment x₁ x₂ x₃ x₄ or a first error indicator, output plaintext segment x₅ x₆ x₇ x₈ or a second error indicator, and output plaintext segment x₉ x₁₀ x₁₁ x₁₂ or a third error indicator.

### DETAILED DESCRIPTION OF THE PREFERRED EMBODIMENTS

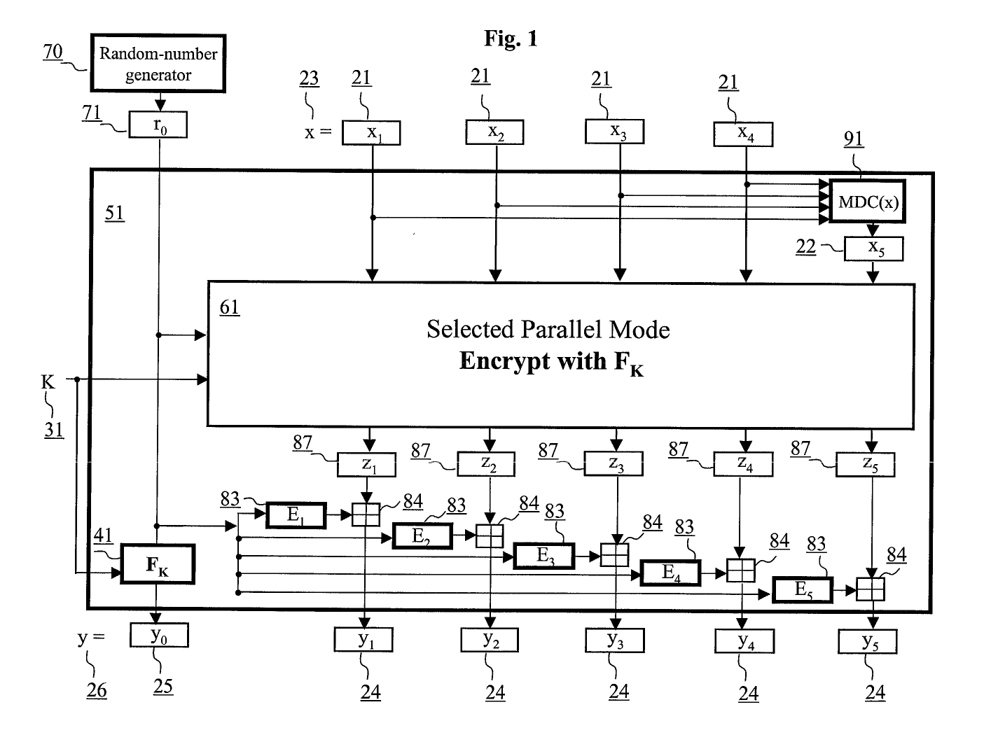

Referring to FIG. 1, a plaintext string x 23 representing the input data is presented to the parallel encryption mode system providing data confidentiality and integrity 51 resulting in an output ciphertext string y 26. It is assumed that the sender and the receiver share a secret key K (31) and that a random-number generator 70 is available. From the input plaintext string x 23, a plurality of equal-sized blocks 21 of λ bits in length is generated. In one embodiment, the input plaintext string x 23 is padded so that it is a multiple of λ bits. It is assumed that the plaintext string x 23 is composed of n λ-bit plaintext blocks 21. FIG. 1 shows an example plaintext string 23 composed of n=4 blocks, x=x₁ x₂ x₃ x₄.

F is an λ-bit block cipher with key length k, F_{K} 41 is the λ-bit block cipher F using secret key K 31. F_{K}(b) is an λ-bit block representing the enciphering of the λ -bit block b by F_{K}.

The random-number generator 70 outputs a secret random number r₀ 71 of λ bits in length that is further enciphered by F_{K} 41, the block cipher F using the first key K 31, to obtain the block y₀ 25. In an alternate embodiment, the secret random number r₀ 71 is shared between the sender and the receiver, and hence it need not be generated by a random-number generator 70. In the alternate embodiment the sender and the receiver generate the same shared secret random number r₀ 71 from an already shared secret key K 31 using key separation techniques well-known in the art.

The input plaintext blocks 21 are combined using a non-cryptographic Manipulation Detection Code (MDC) function 91 yielding an λ-bit MDC block. Examples of the result MDC(x) are provided below. By way of example, the non-cryptographic MDC function is a high-performance MDC function. In the preferred embodiment of this invention, this function is a bit-wise exclusive-or function. In the example of FIG. 1, in which the input plaintext string 23 is x=x₁ x₂ x₃ x₄, MDC(x)=x₁\mathring{+}x₂\mathring{+}x₃\mathring{+}x₄, where \mathring{+}denotes the bit-wise exclusive-or operation. In an alternate embodiment of this invention, the non-cryptographic MDC function uses addition modulo 2^{λ}-1; i.e., for the example of FIG. 1 in which the input plaintext string is x=x₁ x₂ x₃ x₄, MDC(x)=x₁+x₂+x₃+x₄ (modulo 2^{λ}1). In yet another alternate embodiment of this invention, the non-cryptographic MDC function is any other parity checking code such as a cyclic redundancy code function. In the preferred embodiment of this invention, the result of the application of the MDC function, MDC(x), represents the λ-bit MDC block 22. In an alternate embodiment, the result of the application of the MDC function, MDC(x), is further combined with a secret random vector z₀ that is obtained by enciphering with F_{K}, the block cipher F using the first key K, of a variant, r₀+c, of the random number r₀ 71, where c is a non-zero constant, the combination resulting in the block value MDC(x)\mathring{+}z₀, which represents the computed λ-bit MDC block 22. In this alternate embodiment of this invention, the combination operation between MDC(x) and the secret random vector z₀ is the bit-wise exclusive-or operation denoted by \mathring{+}; i.e. the resulting value 22 is MDC(x)\mathring{+}z₀. In another alternate embodiment of this invention, the combination operation between MDC(x) and the secret random vector z₀ is the addition modulo 2^{λ}-1; i.e., the resulting value 22 is MDC(x)+z₀ (modulo 2^{λ}-1).

The plurality of input plaintext blocks 21 and the MDC block 22 are submitted to a selected parallel encryption mode 61 that uses a block cipher F_{K} with key K 31. In an aspect of this invention, the selected parallel encryption mode 61 is confidentiality-secure. In a further aspect of this invention, the selected confidentiality-secure parallel encryption mode 61 has the property that the input plaintext blocks 21 and the block value MDC(x) 22 are part of the input to F_{K}, the block cipher F using the first key K 31, used by the selected confidentiality-secure encryption mode 61.

The application of the selected parallel encryption mode 61 results in a plurality of hidden ciphertext blocks 87 of λ-bit length; the number of hidden ciphertext blocks 87 is greater by one than the number of the input plaintext blocks 21; i.e., it is n+1. For the example of FIG. 1, wherein n=4, the plurality of hidden ciphertext blocks 87 comprises n+1=5 blocks z₁, z₂, z₃, z₄, z₅. These hidden ciphertext blocks 87 are submitted to a hidden ciphertext randomization step comprising, in one embodiment, applying a combination operation for the hidden ciphertext 84 to each hidden ciphertext block zₗ 87 and each λ-bit element Eₗ 83 of a sequence of n+1 elements for the hidden ciphertext.

Each of the elements Eₗ 83 is unpredictable because it is obtained by combining the secret random number r₀ 71 and the element identifier i such that for any given λ-bit constant a, the probability of the event Eₗ=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). The fact that these elements Eᵢ 83 are unpredictable means that enough of their λ bits remain unknown so that the probability of the event Eᵢ=a is negligible. In the preferred embodiment of this invention, each unpredictable element Eᵢ 83 is obtained by multiplication modulo 2^{λ} of the element index i and the secret random number r₀ 71; i.e., Eₗ=r₀×i. In an alternate embodiment, when encryption is performed sequentially, each element of the sequence Eₗ₊₁ (where i≧1) is generated from the previous element Eᵢ by modular 2^{λ} addition of the secret random number r₀, the first element of the sequence being the secret random number r₀ itself, namely E₁=r₀. It should be appreciated by those skilled in the art, and is a further aspect of this invention, that the unpredictable elements 83 and the combination operation 84 can be obtained in other ways that do not depart from the spirit and scope of the present invention as set forth in the claims. In an alternate embodiment of this invention, the unpredictable elements Eᵢ are the elements of the linear congruence sequence defined by Eᵢ=a^{l}×r₀, where a is called the multiplier and is chosen to pass all the necessary spectral tests, i is the element index, i=1, . . . , n+1, and r₀ is the secret random number 71, as described by D. E. Knuth in “The Art of Computer Programming—Volume 2: Seminumerical Algorithms,” Addison-Wesley, 1981 (second edition), Chapter 3, incorporated herein by reference.

The combination operation for the hidden ciphertext 84 is an operation that has an inverse. In the preferred embodiment of this invention, the combination operation 84 is the modular 2^{λ} addition, whereby each ciphertext block is obtained as yᵢ=zₗ+Eᵢ modulo 2^{λ}. In an alternate embodiment of this invention, the combination operation 84 is the bit-wise exclusive-or operation, whereby each ciphertext block yᵢ=zᵢ\mathring{+}Eᵢ. In yet another alternate embodiment of this invention, the combination operation 84 is modular 2^{λ} subtraction operation, whereby each ciphertext block yᵢ=zₗ−Eₗ modulo 2^{λ}. The invention, however, is not so limited, as other combination operations that have an inverse may also be used for combination operation for the hidden ciphertext 84.

In the preferred embodiment of this invention, the distinct unpredictable elements Eᵢ 83 (where i≧1) and the combination operation for the hidden ciphertext 84 are chosen such that for any two distinct unpredictable elements Eₗ, Eⱼ, both used for the same message or each used for different messages encrypted with the same key K 31, the combination Eᵢ op⁻¹ Eⱼ results in an λ-bit block that is unpredictable, where op⁻¹ denotes the inverse of the combination operation 84. That is, for any given λ-bit constant a, the probability of the event Eₗ op⁻¹ Eⱼ=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). The fact that block Eᵢ op⁻¹ Eⱼ is unpredictable means that enough of its λ bits remain unknown so that the probability of the event Eᵢ op⁻¹ Ej=a is negligible.

The application of the combination operation 84 to the plurality of hidden ciphertext blocks 87 and the unpredictable elements 83 of the sequence results in a plurality of ciphertext blocks yᵢ 24. Ciphertext block y₀ 25 and the plurality of ciphertext blocks yⱼ 24 form the ciphertext string y 26 that has n+2 blocks and is the output data of the encryption mode 51. For the example presented in FIG. 1, the ciphertext string 26 is y=y₀ y₁ y₂ y₃ y₄ y₅; i.e., has n+2=6 blocks.

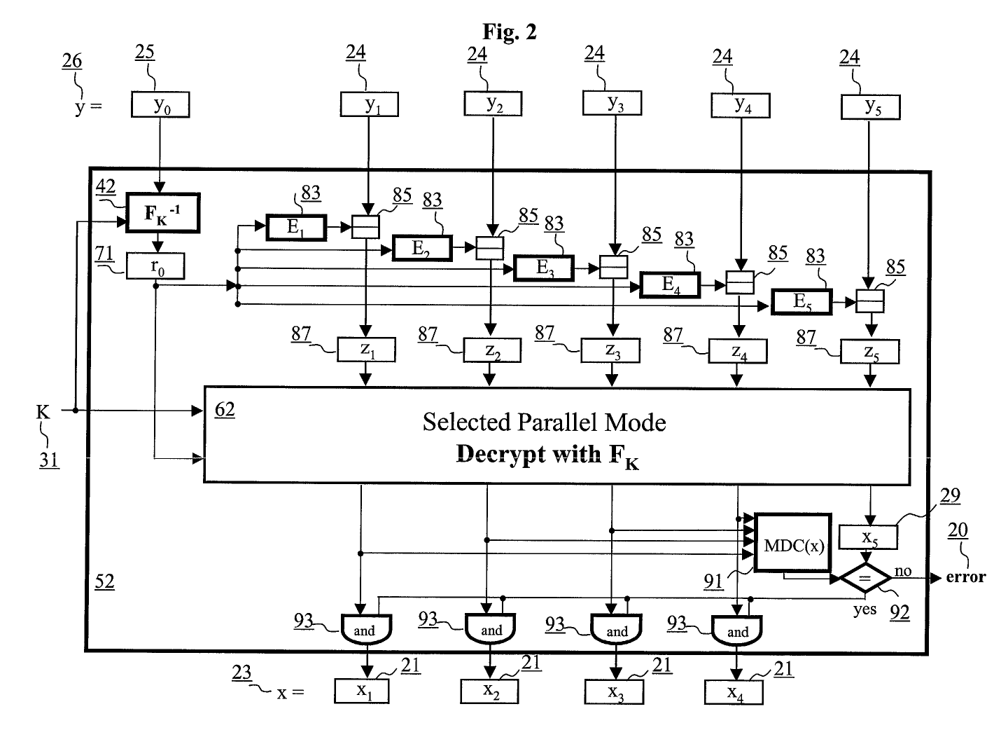

FIG. 2 represents the decryption of a ciphertext string y 26 composed of block y₀ 25 and n+1 ciphertext blocks 24 to either a plaintext string x 23 composed of n plaintext blocks 21 or an error indicator 20 by the parallel decryption mode providing data confidentiality and integrity 52. FIG. 2 shows an example wherein the ciphertext string y 26 is composed of block y₀ 25 and n+1=5 ciphertext blocks 24; i.e., y=y₀ y₁ y₂ y₃ y₄ y₅, and the plaintext string x 23 has n=4 blocks; i.e., x=x₁ x₂ x₃ x₄. It is assumed that the sender shares the secret key K (31) with the receiver of the data string y 26.

F⁻¹_{K} 42 is the inverse of the λ-bit block cipher F using secret key K 31. F⁻¹_{K} (d) is an λ-bit block representing the deciphering of the λ-bit block d by F⁻¹_{K}.

Block y₀ 25 is deciphered using F⁻¹_{K} 42, the inverse of the block cipher F using secret key K 31, resulting in the secret random number r₀ 71.

The n+1 ciphertext blocks yᵢ 24, where i≧1, are submitted to the inverse combination operation for the hidden ciphertext 85 together with the unpredictable elements Eᵢ 83, computed at decryption, resulting in n+1 hidden ciphertext blocks zᵢ 87. The unpredictable elements Eₗ 83 are computed exactly in the same way as at parallel encryption (viz., FIG. 1). The inverse combination operation for the hidden ciphertext 85 is the inverse of the combination operation for the hidden ciphertext 84 used at encryption. In the preferred embodiment of this invention, if the combination operation 84 is a modular 2^{λ} addition operation, then the inverse combination operation 85 is the modular 2^{λ} subtraction; i.e., each block zₗ=yᵢ−Eᵢ modulo 2^{λ}. In an alternate embodiment of this invention, if the combination operation 84 is the bit-wise exclusive-or operation, then the inverse combination operation 85 is the bit-wise exclusive-or operation; i.e., each block zₗ=yᵢ\mathring{+}Eₗ. In yet another alternate embodiment of this invention, if the combination operation 84 is modular 2^{λ} subtraction operation, then the inverse combination operation 85 is the modular 2^{λ} addition; i.e., each block zᵢ=yᵢ+Eᵢ modulo 2^{λ}.

The n+1 hidden ciphertext blocks zₗ 87 are sent to the parallel decryption function of the selected mode 62 that uses F⁻¹_{K}, the inverse of the block cipher F using key K 31. The decryption of the selected mode 61 outputs n plaintext blocks and one decrypted MDC block 29. For the example presented in FIG. 2, the n=4 plaintext blocks are x₁, x₂, x₃, x₄ and the decrypted MDC block 29 is x₅. Further, the non-cryptographic MDC function is applied to the n plaintext blocks and the result is MDC(x). In the preferred embodiment of this invention, MDC(x) is the computed MDC block 91. In an alternate embodiment, the result MDC(x) is further combined with the secret vector z₀ to yield the computed λ-bit MDC block, MDC(x)\mathring{+}z₀ 91, wherein the secret random vector z₀ is obtained from the secret number r₀ by enciphering the variant r₀+c using F_{K}, where c is a non-zero constant. Then the computed MDC block 91 and the decrypted MDC block 29 are compared for equality using the comparator 92. If the computed MDC block 91 and the decrypted MDC block 29 are not equal, then the result of the decryption of the data string y 26 is the error indicator 20. If the computed MDC block 91 and the decrypted MDC block 29 are equal, then the output from the logical “and” operators 93 is the result of the decryption of the ciphertext string y 26 using the parallel decryption mode 52; i.e., the result is the plaintext string x 23 comprising n plaintext blocks xᵢ 21. In the example presented in FIG. 2, if computed MDC block 91 and the decrypted MDC block 29 are equal, then the output of the parallel decryption mode 52 is the plaintext string 23 x=x₁ x₂ x₃ x₄.

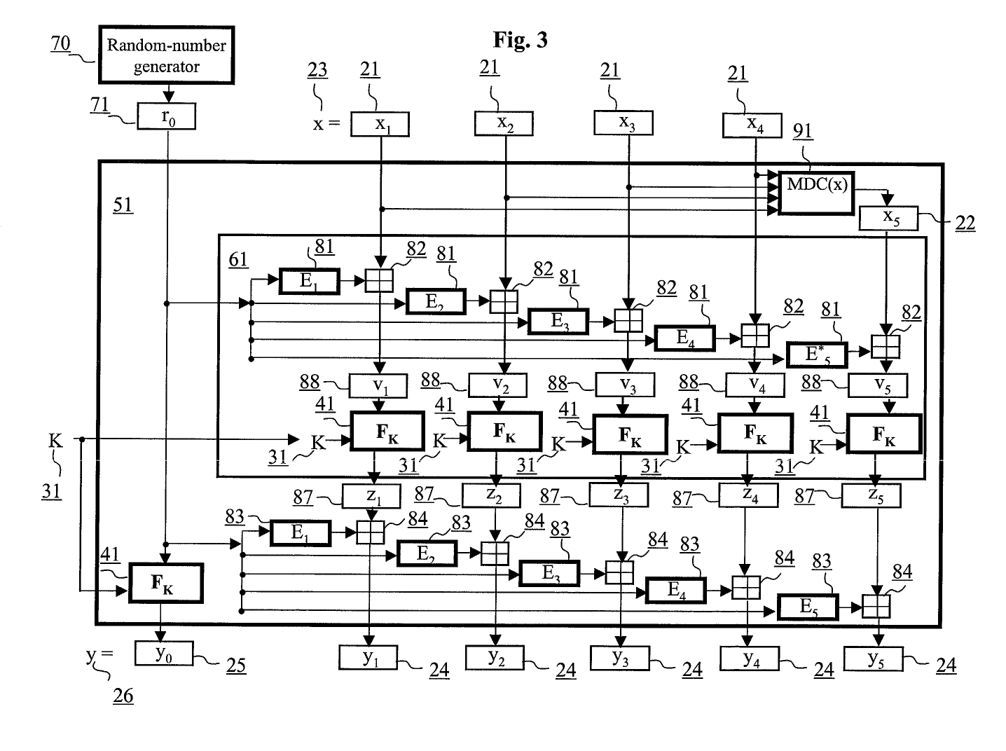

FIG. 3 illustrates a schematic diagram for the preferred embodiment of this invention of the stateless parallel encryption mode. The input plaintext string x 23 (which is padded in a standard way as necessary) containing n plaintext blocks xᵢ 21 is encrypted using the encryption mode 51 and the result of this encryption is the ciphertext string y 26 containing n+2 ciphertext blocks, namely ciphertext block y₀ 25 and n+1 ciphertext blocks yₗ 24 where i=1, 2, . . . , n+1. The encryption uses a secret key K (31). The random-number generator 70 outputs the secret random number r₀ 71 that is further enciphered with F_{K} 41, the block cipher F using the first key K 31, and the result is ciphertext block y₀ 25.

In this embodiment, the plaintext blocks xᵢ 21 are bit-wise exclusive-or-ed into MDC(x) 22; i.e., MDC(x)=x₁\mathring{+} . . . \mathring{+}xₙ, and this value is appended to the plaintext string x and submitted to selected parallel encryption mode 61 that uses F_{K}, the block cipher F using the key K 31. The parallel encryption mode 61 comprises a plaintext randomization step applied to the n plaintext blocks xᵢ 21 and the MDC block 22 to generate the hidden plaintext blocks vₗ 88 that are further enciphered with F_{K}, the block cipher F using the first key K 31, resulting in n+1 hidden ciphertext blocks zᵢ 87. FIG. 3 shows an example where n=4; i.e. the hidden plaintext blocks vᵢ 88 are v₁, v₂, v₃, v₄, v₅ and the hidden ciphertext blocks 87 are z₁, z₂, z₃, z₄, z₅.

In the preferred embodiment of this invention of the stateless encryption, the plaintext randomization step comprises combining each of the plaintext blocks xᵢ 21 and the MDC block 22, and each λ-bit element E₁, E₂, . . . , Eₙ and E*ₙ₊₁ 81 of a sequence of n+1 elements for the hidden plaintext using a combination operation for the hidden plaintext 82. Each of these elements E₁, E₂, . . . , Eₙ and E*ₙ₊₁ 81 for the hidden plaintext is unpredictable because it is obtained by combining the secret random number r₀ 71 and the element identifier i such that for any given λ-bit constant a, the probability of the event equating the i-th element and constant a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). In the preferred embodiment of this invention, each unpredictable element 81 is obtained by multiplication modulo 2^{λ} of the element index i with the secret random number r₀ 71 for each plaintext block and by multiplication modulo 2^{λ} of the constant n+2 with the secret random number r₀ 71 for the MDC block, i.e., Eᵢ=r₀×i for plaintext blocks with i=1, 2, . . . , n, and E*ₙ₊₁=r₀×(n+2) for the MDC block. It should be appreciated by those skilled in the art, and is a further aspect of this invention, that the unpredictable elements 81 for the hidden plaintext and the combination operation 82 can be obtained in other ways that do not depart from the spirit and scope of the present invention as set forth in the claims. In an alternate embodiment of this invention, the unpredictable elements 81 for the hidden ciphertext are the elements of the linear congruence sequence defined by Eₗ=a^{l}×r₀, for the n plaintext blocks and E*ₙ₊₁=aⁿ⁺²×r₀, where a is called the multiplier and is chosen to pass all the necessary spectral tests, i is the element index, i=1, . . . , n, and r₀ is the secret random number 71, as described by D. E. Knuth in “The Art of Computer Programming—Volume 2: Seminumerical Algorithms,” Addison-Wesley, 1981 (second edition), Chapter 3, incorporated herein by reference.

The combination operation for the hidden plaintext 82 is an operation that has an inverse. In the preferred embodiment of this invention, the combination operation 82 is the modular 2^{λ} addition, whereby each hidden plaintext block is obtained as vᵢ=xₗ+Eₗ modulo 2^{λ for i=}1, 2, . . . , n, and vₙ₊₁=xₙ₊₁+E*ₙ₊₁ modulo 2^{λ} for the MDC block. In an alternate embodiment of this invention, the combination operation 82 is the bit-wise exclusive-or operation. In yet another alternate embodiment of this invention, the combination operation 82 is the modular 2^{λ} subtraction operation. The invention, however, is not so limited, as other combination operations that have an inverse may also be used for operation for the hidden plaintext 82.

In the preferred embodiment of this invention, the distinct unpredictable elements E₁, E₂, . . . , Eₙ and E*ₙ₊₁ 81 (where i≧1) and the combination operation for the hidden ciphertext 82 are chosen such that for any two distinct unpredictable elements 81, both used for the same message or each used for different messages encrypted with the same key K 31, the combinations Eᵢ op⁻¹ Eⱼ and Eᵢ op⁻¹ E*ₙ₊₁ result in λ-bit blocks that are unpredictable, where op⁻¹ denotes the inverse of the combination operation. That is, for any given λ-bit constant a, the probability of event Eᵢ op⁻¹ Eⱼ=a and event Eᵢ op⁻¹ E*ₙ₊₁=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). The fact that blocks Eᵢ op⁻¹ Eⱼ and Eᵢ op⁻¹ E*ₙ₊₁ are unpredictable means that enough of their λ bits remain unknown so that the probability of the event Eₗ op⁻¹ Ej=a and event Eₗ op⁻¹ E*ₙ₊₁=a is negligible.

In the preferred embodiment of this invention of the stateless parallel encryption, the hidden ciphertext blocks zₗ 87 are submitted to a randomization step for the hidden ciphertext comprising applying a combination operation 84 for the hidden ciphertex to each hidden ciphertext block zₗ 87 and each λ-bit element Eᵢ 83 of a sequence of n+1 elements. Each of these elements Eₗ 83 is unpredictable because it is obtained by combining the secret random number r₀ 71 and the element identifier i such that for any given λ-bit constant a, the probability of the event Eᵢ=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). In the preferred embodiment of this invention, each unpredictable element for the hidden ciphertext 83 is obtained by multiplication modulo 2^{λ} of the element index i with the secret random number r₀ 71; i.e., Eᵢ=r₀×i for i=1, 2, . . . , n+1. It should be appreciated by those skilled in the art, and is a further aspect of this invention, that the unpredictable elements for the hidden ciphertext 83 and the combination operation for the hidden ciphertext 84 can be obtained in other ways that do not depart from the spirit and scope of the present invention as set forth in the claims. In an alternate embodiment of this invention, the unpredictable elements 83 are the elements of the linear congruence sequence defined by a^{l}×r₀, where a is called the multiplier and is chosen to pass all the necessary spectral tests, i is the element index, i=1, . . . , n+1, and r₀ is the secret random number 71, as described by D. E. Knuth in “The Art of Computer Programming—Volume 2: Seminumerical Algorithms,” Addison-Wesley, 1981 (second edition), Chapter 3, incorporated herein by reference.

The combination operation for the hidden ciphertext 84 is an operation that has an inverse. In the preferred embodiment of this invention, the combination operation 84 is the modular 2^{λ} addition, whereby each ciphertext block is obtained as yᵢ=zₗ+Eₗ modulo 2^{λ}. In an alternate embodiment of this invention, the combination operation 84 is the bit-wise exclusive-or operation. In yet another alternate embodiment of this invention, the combination operation 84 is the modular 2^{λ} subtraction operation. The invention, however is not so limited, as other combination operations that have an inverse may also be used for operation for the hidden ciphertext 84.

In the preferred embodiment of this invention, the distinct unpredictable elements Eᵢ 83 (where i≧1) and the combination operation for the hidden ciphertext 84 are chosen such that for any two distinct unpredictable elements Eₗ, Eⱼ, both used for the same message or each used for different messages encrypted with the same key K 31, the combination Eᵢ op⁻¹ Eⱼ results in an λ-bit block that is unpredictable, where op⁻¹ denotes the inverse of the combination operation. That is, for any given λ-bit constant a, the probability of the event Eₗ op⁻¹ Eⱼ=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). The fact that block Eₗ op⁻¹ Eⱼ is unpredictable means that enough of its λ bits remain unknown so that the probability of the event Eₗ op⁻¹ Ej=a is negligible.

The application of the combination operation for the hidden ciphertext 84 to the plurality of hidden ciphertext blocks 87 and the unpredictable elements for the hidden ciphertext, Eᵢ 83, of the sequence results in a plurality of ciphertext blocks yₗ 24. Ciphertext block y₀ 25 and the plurality of ciphertext blocks yₗ 24 form the ciphertext string y 26 that has n+2 blocks and is the output data of the encryption mode 51. For the example presented in FIG. 3, the ciphertext string 26 is y=y₀ y₁ y₂ y₃ y₄ y₅; i.e., has n+2=6 blocks.

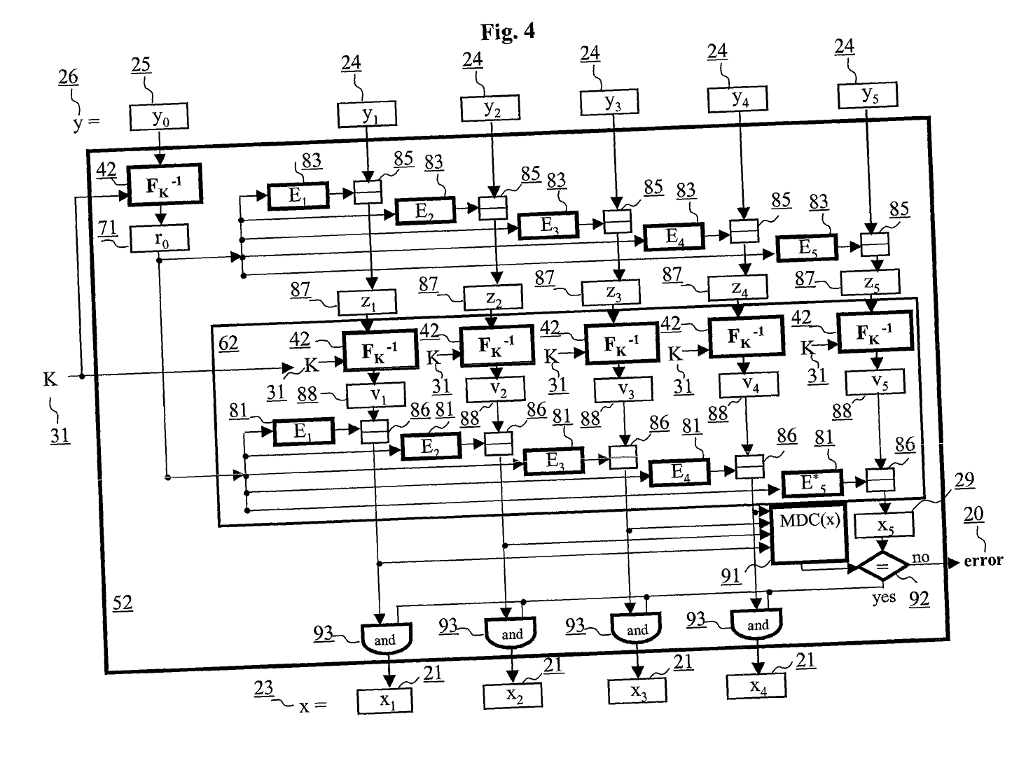

FIG. 4 illustrates a schematic diagram for the preferred embodiment of this invention of the stateless parallel decryption. From the ciphertext string y 26, ciphertext block y₀ 25 is deciphered using the inverse of the block cipher with key K 31, namely F⁻¹_{K} 42 to obtain the secret random vector r₀ 71.

The secret random number r₀ 71 is used to obtain the unpredictable elements for the hidden ciphertext Eᵢ=r₀×i (modulo 2^{λ}) 83 in the same way as at encryption (viz., FIG. 3). These unpredictable elements Eᵢ 83 and the ciphertext blocks yᵢ 24 are combined using the inverse combination operation for the ciphertext 85 to generate the hidden ciphertext blocks zₗ 87. The inverse combination operation for the hidden ciphertext 85 is the inverse of the combination operation for the hidden ciphertext 84 used at encryption. In the preferred embodiment of this invention of the stateless parallel decryption, the inverse combination operation for the ciphertext 85 is subtraction modulo 2^{λ}; i.e., zᵢ=yᵢ−Eᵢ. In an alternate embodiment of this invention, when the combination operation 84 is the bit-wise exclusive-or operation, the inverse combination operation for the hidden ciphertext 85 is the bit-wise exclusive-or operation; i.e., zᵢ=yₗ\mathring{+}Eₗ. In another alternate embodiment of this invention, when the combination operation 84 is the modular 2^{λ} subtraction operation, the inverse combination operation for the ciphertext 85 is addition modulo 2^{λ}; i.e., zᵢ=yᵢ+Eₗ. The invention, however, is not so limited, as other inverse combination operations may also be used for operation 85, the only restriction being that operation 85 is the inverse of the combination operation for the hidden ciphertext 84.

The n+1 hidden ciphertext blocks zₗ 87 are presented to the select parallel decryption mode 62 that uses F⁻¹_{K}, the inverse of the block cipher F using key K 31. The parallel decryption mode 62 consists of deciphering the n+1 hidden ciphertext blocks zₗ 87 using F⁻¹_{K}, the inverse of the block cipher F using key K 31 to obtain n+1 hidden plaintext blocks vₗ 88 that are further submitted to a reverse plaintext randomization step that generates n+1 blocks xᵢ. The last block xₙ₊₁ 29 represents the decrypted MDC block.

The reverse plaintext randomization step consists of applying the inverse operation for the hidden plaintext 86 to the n+1 hidden plaintext blocks vᵢ 88 and the n+1 unpredictable elements for the hidden plaintext E₁, E₂, . . . , Eₙ and E*ₙ₊₁ 81 obtained in the same way as at encryption (viz., FIG. 3). The inverse combination operation for the hidden plaintext 86 is the inverse of the combination operation for the hidden plaintext 82 used at encryption. In the preferred embodiment of this invention of the stateless parallel decryption, the inverse combination operation for the plaintext 86 is subtraction modulo 2^{λ}; i.e., xᵢ=vᵢ−Eₗ, for 1≦i≦n, and xₙ₊₁=vₙ₊₁−E*ₙ₊₁ for i=n+1. In an alternate embodiment of this invention, when the combination operation 82 is the bit-wise exclusive-or operation, the inverse combination operation for the hidden plaintext 85 is the bit-wise exclusive-or operation; i.e., xᵢ=vᵢ\mathring{+}Eᵢ, for 1≦i≦n, and xₙ₊₁=vₙ₊₁\mathring{+}E*ₙ₊₁ for i=n+1. In another alternate embodiment of this invention, when the combination operation 82 is the modular 2^{λ} subtraction operation, the inverse combination operation for the hidden plaintext 86 is addition modulo 2^{λ}; i.e., xₗ=vᵢ+Eₗ, for 1≦i≦n, and xₙ₊₁=vₙ₊₁+E*ₙ₊₁ for i=n+1. The invention, however, is not so limited, as other inverse combination operations may also be used for operation 86, the only restriction being that operation 86 is the inverse of the combination operation for the hidden plaintext 82.

The n blocks xᵢ, namely x₁, x₂, . . . , xₙ, in accordance with one embodiment of the MDC function, are bit-wise exclusive-or-ed to obtain computed MDC(x) block 91; i.e. MDC(x)=x₁\mathring{+} . . . \mathring{+}xₙ. Then the computed MDC(x) an the decrypted MDC block xₙ₊₁ 29 are compared for equality at 92. If the computed MDC block MDC(x) 91 and the decrypted MDC block 29 are not equal then the result of the decryption of the data string y 26 is the error indicator 20. If the computed MDC block MDC(x) 91 and the decrypted MDC block 29 are equal then the output from the logical “and” operators 93 is the result of the decryption of the ciphertext string y 26 using the decryption mode 52; i.e., the result is the plaintext string x 23 composed of n plaintext blocks xᵢ 21. For the example illustrated in FIG. 4, the output of the parallel decryption mode 52 is the plaintext string 23 x=x₁ x₂ x₃ x₄.

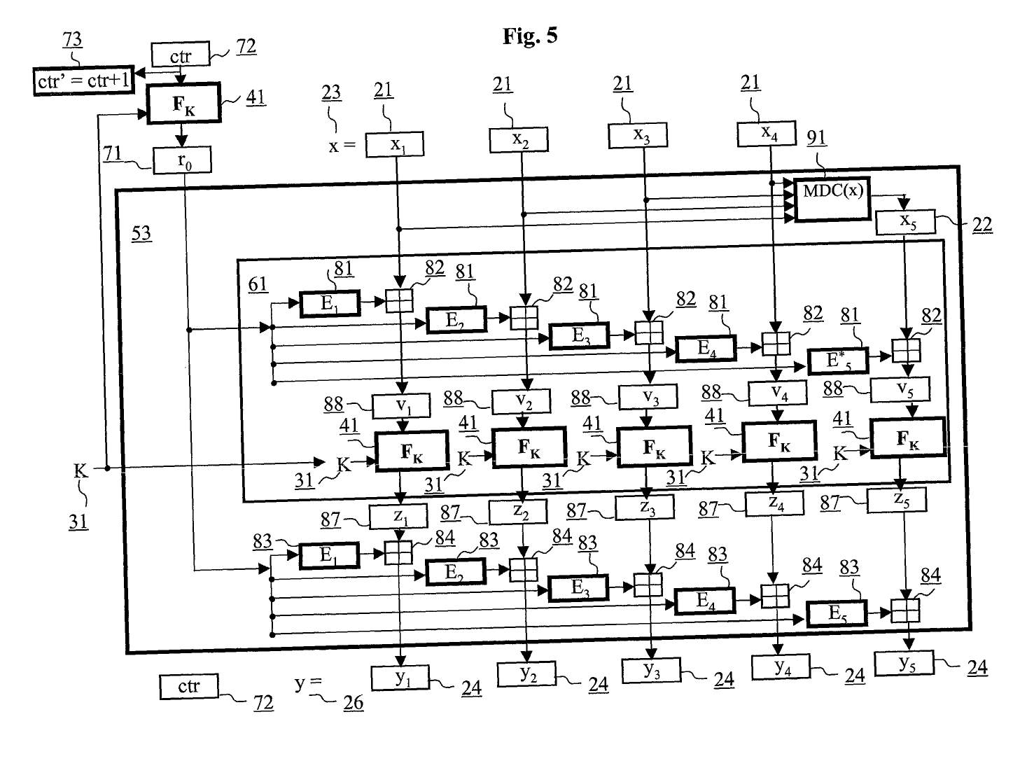

FIG. 5 illustrates a schematic diagram for the preferred embodiment of this invention of the stateful-sender parallel encryption mode. The encryption mode 53 uses a secret key K (31). In this embodiment of the method of the invention a counter initialized to a constant, ctr 72, is enciphered using F_{K} 41, the block cipher F using the first key K 31, to yield the secret random number r₀ 71.

In this embodiment, the plaintext blocks xᵢ 21 are bit-wise exclusive-or-ed into MDC(x) 22; i.e., MDC(x)=x₁\mathring{+} . . . \mathring{+}xₙ, and this value is appended to the plaintext string x and submitted to selected parallel encryption mode 61 that uses F_{K}, the block cipher F using the key K 31. The selected parallel encryption mode 61 has been described in FIG. 3.

The parallel encryption mode 61 yields n+1 hidden ciphertext blocks zₗ 87. FIG. 5 shows an example where n=4; i.e., the hidden ciphertext blocks 87 are z₁, z₂, z₃, z₄, z₅.

In the preferred embodiment of this invention of the stateful-sender parallel encryption, the hidden ciphertext blocks zₗ 87 are submitted to a randomization step for the hidden ciphertext comprising applying a combination operation for the hidden ciphertext 84 to each hidden ciphertext block zᵢ 87 and each λ-bit element 83 of a sequence of n+1 elements, resulting in n+1 ciphertext blocks yₗ 24. The randomization step for the hidden ciphertext has been described in FIG. 3. The plurality of ciphertext blocks yₗ 24 forms the ciphertext string y 26 that has n+1 blocks. For the example presented in FIG. 5, the ciphertext string 26 is y=y₁ y₂ y₃ y₄ y₅; i.e., has n+1=5 blocks. The counter ctr 72 and the ciphertext string y 26 representing the output of the encryption mode 53 form the output message data.

With the encryption of each plaintext string, the current value of the counter ctr 72 is incremented, or otherwise changed to a new value, ctr′, at 73. This new value is used to encrypt the next plaintext string.

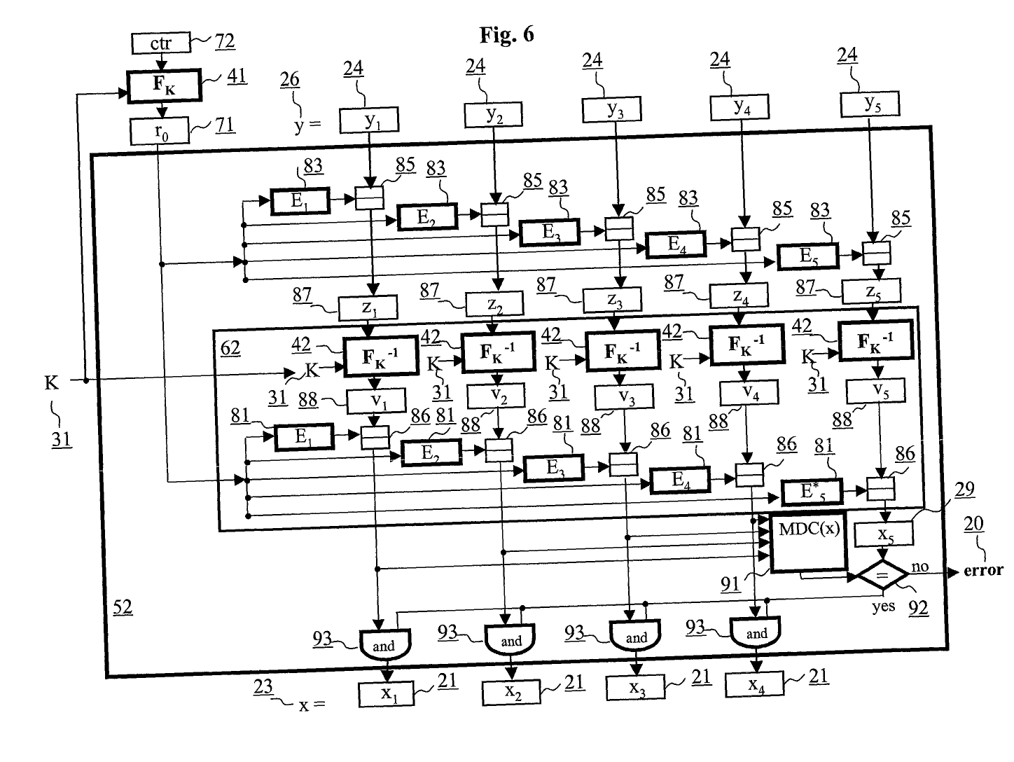

FIG. 6 illustrates a schematic diagram for the preferred embodiment of this invention of the stateful-sender parallel decryption mode. From the string presented for decryption comprising the counter ctr 72 and ciphertext string y 26, the counter ctr 72 is enciphered using F_{K} 41, the block cipher F using key K 31, and the secret random number r₀ 71 is obtained. After obtaining the secret random number r₀ 71, the ciphertext string y 26, composed of n+1 ciphertext blocks yᵢ 24, is decrypted in the same manner as that used in the stateless parallel decryption mode 52 after it obtains the secret random number r₀ 71 (viz., FIG. 4) to obtain either the plaintext string x 23 composed of n plaintext blocks xᵢ 21 or the error indicator 20.

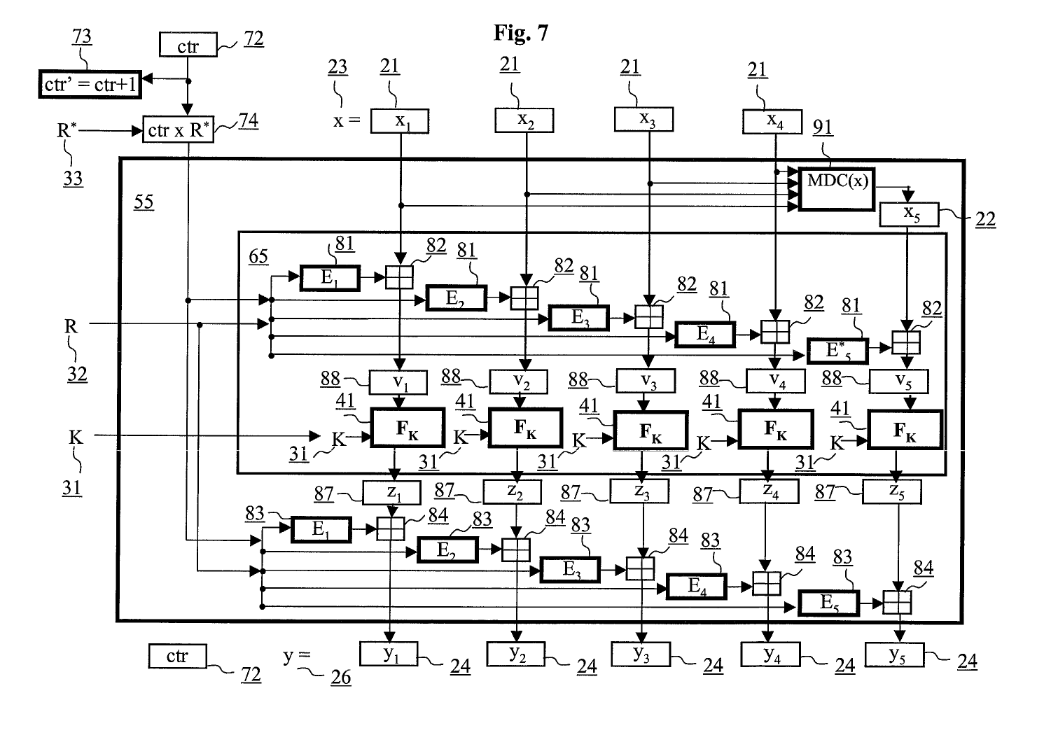

FIG. 7 illustrates a schematic diagram for the preferred embodiment of this invention of the stateful parallel encryption mode. The encryption mode 55 uses a secret key K (31) and two independent secret random numbers, R 32 and R* 33, of λ bits in size shared between a sender and a receiver. In the preferred embodiment of this invention, the sender and the receiver generate the same shared independent secret random numbers R 32 and R* 33 from an already shared secret key K 31 using key separation techniques well-known in the art. In an alternate embodiment of this invention, the two independent secret random numbers, R 32 and R* 33, are generated by a random number generator and distributed to the sender and receiver in the same way as that used for secret key K 31 using distribution techniques well-known in the art.

In this embodiment of the method of the invention a counter ctr 72 is used to obtain the block-index-independent unpredictable element R*×ctr (modulo 2^{λ}) 74. Each block-index-independent unpredictable element 74, which is generated at the encryption of a plaintext string x 23, is unpredictable because it is obtained by combining the secret random number R* 33 and a non-zero counter ctr 72 such that for any given λ-bit constant a, the probability of the event equating this element 74 and constant a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). In this embodiment, each block-index-independent unpredictable element 74 is generated from the block-index-independent unpredictable element used for the encryption of the previous plaintext by modular 2^{λ} addition of the secret random number R*, the unpredictable element used for the first encrypted plaintext being the secret random number R* itself. In an alternate embodiment, the block-index-independent unpredictable element R*×ctr (modulo 2^{λ}) 74 is generated by modular 2^{λ} multiplication. It should be appreciated by those skilled in the art, and is a further aspect of this invention, that the unpredictable element 74 can be generated for each plaintext to be encrypted in other ways that do not depart from the spirit and scope of the present invention as set forth in the claims.

In the preferred embodiment of this invention, the plaintext blocks xᵢ 21 are bit-wise exclusive-or-ed into MDC(x) 22; i.e., MDC(x)=x₁\mathring{+} . . . \mathring{+}xₙ, and this value is appended to the plaintext string x and submitted to selected parallel encryption mode 65 that uses F_{K}, the block cipher F using the key K 31. The parallel encryption mode 65 comprises a plaintext randomization step applied to the n plaintext blocks xᵢ 21 and the MDC block 22 to generate the hidden plaintext blocks vₗ 88 that are further enciphered with F_{K}, the block cipher F using the first key K 31, resulting in n+1 hidden ciphertext blocks zᵢ 87. FIG. 7 shows an example where n=4; i.e. the hidden plaintext blocks vᵢ 88 are v₁, v₂, v₃, v₄, v₅ and the hidden ciphertext blocks 87 are z₁, z₂, z₃, z₄, z₅.

In the preferred embodiment of this invention of the stateful encryption, the plaintext randomization step comprises a combining each of the plaintext blocks xᵢ 21 and the MDC block 22, and each λ-bit element E₁, E₂, . . . , Eₙ and E*ₙ₊₁ 81 of a sequence of n+1 unpredictable elements for the hidden plaintext using a combination operation for the hidden plaintext 82. In the preferred embodiment of this invention, the unpredictable elements 81 are obtained as Eᵢ=R×i+R*×ctr (modulo 2^{λ}) from the element index i for each plaintext block i, with i=1, 2, . . . , n, and as E*ₙ₊₁=R*×ctr (modulo 2^{λ}) for the MDC block 91. Each of these elements E₁, E₂, . . . , Eₙ and E*ₙ₊₁ 81 for the hidden plaintext is unpredictable because, for any given λ-bit constant a, the probability of the event R×i+R*×ctr=a is negligible, for j=1, 2, . . . , n, and the probability of the event R*×ctr=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). It should be appreciated by those skilled in the art, and is a further aspect of this invention, that the unpredictable elements 81 for the hidden plaintext and the combination operation 82 can be obtained in other ways that do not depart from the spirit and scope of the present invention as set forth in the claims. In an alternate embodiment of this invention, the unpredictable elements E₁, E₂, . . . , Eₙ and E*ₙ₊₁ 81 for the hidden plaintext are obtained using the elements of the linear congruence sequence a^{l}×R such that Eᵢ=R*×ctr+a^{l}×R, for the n plaintext blocks and E*ₙ₊₁=R*×ctr, where a is called the multiplier and is chosen to pass all the necessary spectral tests, i is the element index, i=1, . . . , n, and R 32 is a secret random number independent of the secret random number R* 33, as described by D. E. Knuth in “The Art of Computer Programming—Volume 2: Seminumerical Algorithms,” Addison-Wesley, 1981 (second edition), Chapter 3, incorporated herein by reference.

The combination operation for the hidden plaintext 82 is an operation that has an inverse. In the preferred embodiment of this invention, the combination operation 82 is the modular 2λ addition, whereby each hidden plaintext block is obtained as vₗ=xₗ+Eᵢ modulo 2^{λ} for i=1, 2, . . . , n, and vₙ₊₁=xₙ₊₁+E*ₙ₊₁ for the MDC block 91. In an alternate embodiment of this invention, the combination operation 82 is the bit-wise exclusive-or operation. In yet another alternate embodiment of this invention, the combination operation 82 is the modular 2^{λ} subtraction operation. The invention, however, is not so limited, as other combination operations that have an inverse may also be used for operation for the hidden plaintext 82.

In the preferred embodiment of this invention, the distinct unpredictable elements Eᵢ 81 (where i≧1) and the combination operation for the hidden ciphertext 82 are chosen such that for any two distinct unpredictable elements Eᵢ, Eⱼ, both used for the same message or each used for different messages encrypted with the same key K 31, the combination Eᵢ op⁻¹ Eⱼ results in an λ-bit block that is unpredictable, where op⁻¹ denotes the inverse of the combination operation. That is, for any given λ-bit constant a, the probability of events Eᵢ op⁻¹ Eⱼ=a and event Eₗ op⁻¹ E*ₙ₊₁=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). The fact that blocks Eₗ op⁻¹ Eⱼ and Eᵢ op⁻¹ E*ₙ₊₁ are unpredictable means that enough of their λ bits remain unknown so that the probability of the event Eₗ op⁻¹ Ej=a and event Eⱼ op⁻¹ E*ₙ₊₁=a is negligible.

In the preferred embodiment of this invention of the stateful parallel encryption, the hidden ciphertext blocks zₗ 87 are submitted to a randomization step for the hidden ciphertext comprising applying a combination operation for the hidden ciphertext 84 to each hidden ciphertext block zᵢ 87 and each λ-bit element 83 of a sequence of n+1 unpredictable elements. In the preferred embodiment of this invention, the unpredictable elements Eᵢ 83 are obtained as Eₗ=R×i+R*×ctr (modulo 2^{λ}) from the element index i for each plaintext block i, with i=1, 2, . . . , n+1. Each of these elements Eᵢ 83 is unpredictable because, for any given λ-bit constant a, the probability of the event R×i+R*×ctr=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). It should be appreciated by those skilled in the art, and is a further aspect of this invention, that the unpredictable elements for the hidden ciphertext Eᵢ 83 and the combination operation for the hidden ciphertext 84 can be obtained in other ways that do not depart from the spirit and scope of the present invention as set forth in the claims. In an alternate embodiment of this invention, the unpredictable elements Eₗ 83 for the hidden ciphertext are obtained using the elements of the linear congruence sequence a^{l}×R such that Eₗ=R*×ctr+a^{l}×R, where a is called the multiplier and is chosen to pass all the necessary spectral tests, i is the element index, i=1, . . . , n+1, and R 32 is a secret random number independent of the secret random number R* 33, as described by D. E. Knuth in “The Art of Computer Programming—Volume 2: Seminumerical Algorithms,” Addison-Wesley, 1981 (second edition), Chapter 3, incorporated herein by reference.

The combination operation for the hidden ciphertext 84 is an operation that has an inverse. In the preferred embodiment of this invention, the combination operation 84 is the modular 2^{λ} addition, whereby each ciphertext block is obtained as yᵢ=zᵢ+Eₗ modulo 2^{λ}. In an alternate embodiment of this invention, the combination operation 84 is the bit-wise exclusive-or operation. In yet another alternate embodiment of this invention, the combination operation 84 is the modular 2^{λ} subtraction operation. The invention, however, is not so limited, as other combination operations that have an inverse may also be used for operation for the hidden ciphertext 84.

In the preferred embodiment of this invention, the distinct unpredictable elements Eᵢ 83 (where i≧1) and the combination operation for the hidden ciphertext 84 are chosen such that for any two distinct unpredictable elements Eᵢ, Eⱼ, both used for the same message or each used for different messages encrypted with the same key K 31, the combination Eᵢ op⁻¹ Eⱼ results in an λ-bit block that is unpredictable, where op⁻¹ denotes the inverse of the combination operation. That is, for any given λ-bit constant a, the probability of the event Eₗ op⁻¹ Eⱼ=a is negligible, wherein the notion of negligible probability is well-known to those skilled in the art (viz., M. Naor and O. Reingold: “From Unpredictability to Indistinguishability: A Simple Construction of Pseudo-Random Functions from MACs,” Advances in Cryptology—CRYPTO '98 (LNCS 1462), pp. 267-282, 1998; M. Bellare, A. Desai, E. Jokipii, and P. Rogaway: “A Concrete Security Treatment of Symmetric Encryption,” Proceedings of the 38th Symposium on Foundations of Computer Science, IEEE, 1997, pp. 394-403). The fact that block Eᵢ op⁻¹ Eⱼ is unpredictable means that enough of its λ bits remain unknown so that the probability of the event Eᵢ op⁻¹ Ej=a is negligible.

The application of the combination operation for the hidden ciphertext 84 to the plurality of hidden ciphertext blocks 87 and the unpredictable elements for the hidden ciphertext 83 of the sequence results in a plurality of ciphertext blocks yᵢ 24. The plurality of ciphertext blocks yᵢ 24 forms the ciphertext string y 26 that has n+1 blocks. For the example presented in FIG. 7, the ciphertext string 26 is y=y₁ y₂ y₃ y₄ y₅; i.e., has n+1=5 blocks. The counter ctr 72 and the ciphertext string y 26 representing the output of the encryption mode 55 form the output message data.

With the encryption of each plaintext string, the current value of the counter ctr 72 is incremented, or otherwise changed, to a new non-zero value, ctr′, at 73. This new value is used to encrypt the next plaintext string.

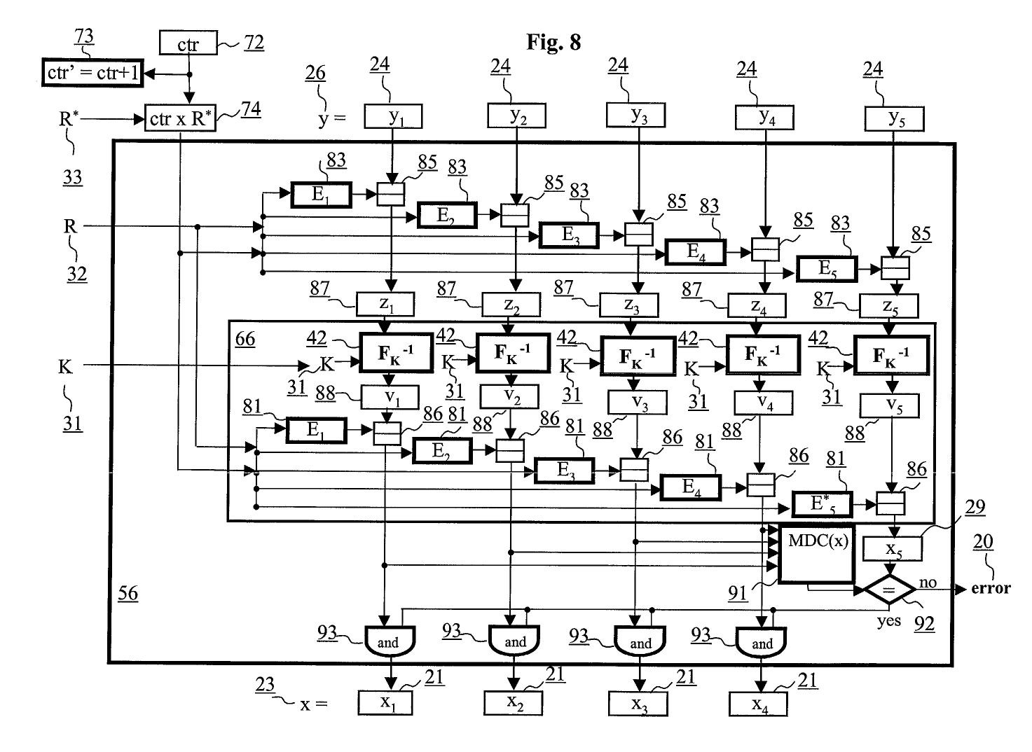

FIG. 8 illustrates a schematic diagram for the preferred embodiment of this invention of the stateful parallel decryption mode. The decryption mode 56 uses a secret key K (31) and two independent random numbers, R 32 and R* 33, shared between a sender and a receiver. The string presented for decryption comprises the non-zero counter ctr 72 and ciphertext string y 26. In this embodiment of the method of the invention, a non-zero counter ctr 72 is used to obtain the unpredictable element R*×ctr (modulo 2^{λ}) 74 in the same way as at encryption (viz., FIG. 7). The secret shared random numbers R 32 and R* 33 are used to obtain the unpredictable elements for the hidden ciphertext Eᵢ=R×i+R*×ctr (modulo 2^{λ}) 83 in the same way as at encryption (viz., FIG. 7). These unpredictable elements Eₗ 83 and the ciphertext blocks yₗ 24 are combined using the inverse combination operation for the ciphertext 85 to generate the hidden ciphertext blocks zₗ 87. The inverse combination operation for the hidden ciphertext 85 is the inverse of the combination operation for the hidden ciphertext 84 used at encryption. In the preferred embodiment of this invention of the stateful parallel decryption, the inverse combination operation for the ciphertext 85 is subtraction modulo 2^{λ}; i.e., zᵢ=yᵢ−(R×i+R*×ctr). In an alternate embodiment of this invention, when the combination operation 84 is the bit-wise exclusive-or operation, the inverse combination operation for the ciphertext 85 is the bit-wise exclusive-or operation; i.e., zᵢ=yᵢ\mathring{+}(R×i+R*×ctr). In another alternate embodiment of this invention, when the combination operation 84 is the modular 2^{λ} subtraction operation, the inverse combination operation for the ciphertext 85 is addition modulo 2^{λ}; i.e., zₗ=yᵢ+(R×i+R*×ctr). The invention, however, is not so limited, as other inverse combination operations may also be used for operation 85, the only restriction being that operation 85 is the inverse of the combination operation for the hidden ciphertext 84.

The n+1 hidden ciphertext blocks zₗ 87 are presented to the select parallel decryption mode 66 that uses F⁻¹_{K}, the inverse of the block cipher F using key K 31. The parallel decryption mode 66 comprises deciphering the n+1 hidden ciphertext blocks zᵢ 87 using F⁻¹_{K}, the inverse of the block cipher F using key K 31 to obtain n+1 hidden plaintext blocks vₗ 88 that are further submitted to a reverse plaintext randomization step that generates n+1 blocks xₗ. The last block xₙ₊₁ 29 represents the decrypted MDC block.

The reverse plaintext randomization step comprises applying the inverse operation for the hidden plaintext 86 to the n+1 hidden plaintext blocks vₗ 88 and the n+1 unpredictable elements for the hidden plaintext E₁, E₂, . . . , Eₙ and E*ₙ₊₁ 81 obtained in the same way as at encryption (viz., FIG. 7). The inverse combination operation for the hidden plaintext 86 is the inverse of the combination operation for the hidden plaintext 82 used at encryption. In the preferred embodiment of this invention of the stateless parallel decryption, the inverse combination operation for the plaintext 86 is subtraction modulo 2^{λ}; i.e., xᵢ=vᵢ−(R×i+R*×ctr), for 1≦i≦n, and xₙ₊₁=vₙ₊₁−(R*×ctr) for i=n+1. In an alternate embodiment of this invention, when the combination operation 82 is the bit-wise exclusive-or operation, the inverse combination operation for the hidden plaintext 85 is the bit-wise exclusive-or operation; i.e., xᵢ=vᵢ\mathring{+}(R×i+R*×ctr), for 1≦i≦n, and xₙ₊₁=vₙ₊₁\mathring{+}(R*×ctr) for i=n+1. In another alternate embodiment of this invention, when the combination operation 82 is the modular 2^{λ} subtraction operation, the inverse combination operation for the hidden plaintext 86 is addition modulo 2^{λ}; i.e., xᵢ=vᵢ+(R×i+R*×ctr), for 1≦i≦n, and xₙ₊₁=vₙ₊₁+(R*×ctr) for i=n+1. The invention, however, is not so limited, as other inverse combination operations may also be used for operation 86, the only restriction being that operation 86 is the inverse of the combination operation for the hidden plaintext 82.

The n blocks xₗ, namely x₁, x₂, . . . , xₙ, in accordance with one embodiment of the MDC function, are bit-wise exclusive-or-ed to obtain computed MDC(x) block 91; i.e. MDC(x)=x₁\mathring{+} . . . \mathring{+}xₙ. Then the computed MDC(x) and the decrypted MDC block xₙ₊₁ 29 are compared for equality at 92. If the computed MDC block MDC(x) 91 and the decrypted MDC block 29 are not equal then the result of the decryption of the data string y 26 is the error indicator 20. If the computed MDC block MDC(x) 91 and the decrypted MDC block 29 are equal then the output from the logical “and” operators 93 is the result of the decryption of the ciphertext string y 26 using the decryption mode 56; i.e., the result is the plaintext string x 23 composed of n plaintext blocks xᵢ 21. For the example illustrated in FIG. 8, the output of the decryption mode 56 is the plaintext string 23 x=x₁ x₂ x₃ x₄.

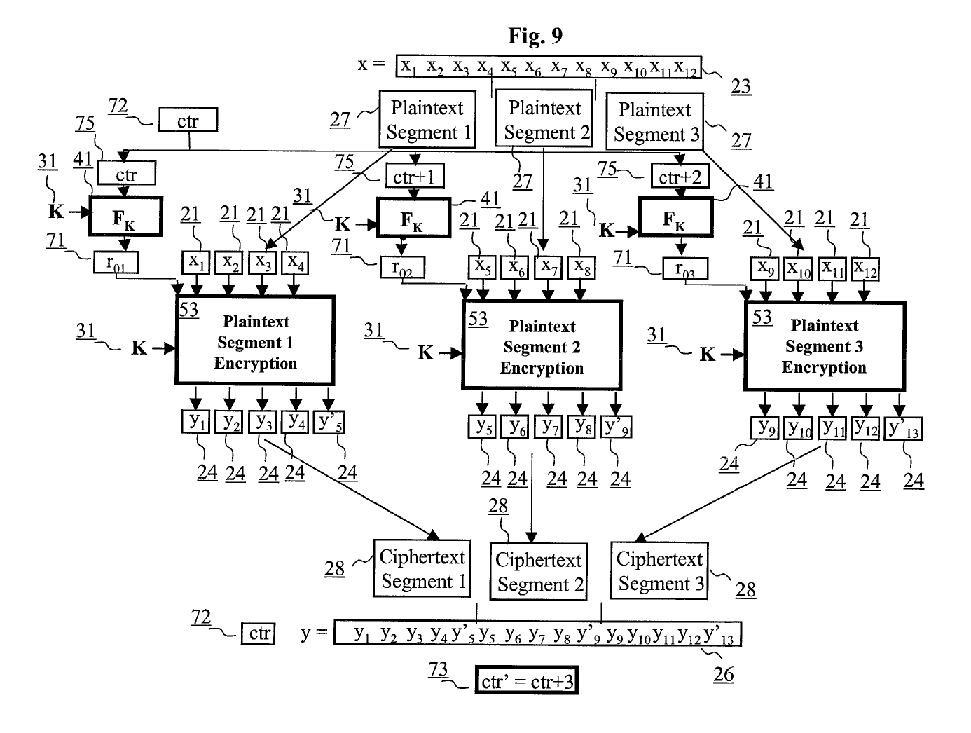

FIG. 9 illustrates a schematic diagram for the preferred embodiment of the L-segment stateful-sender parallel encryption mode. Input plaintext string x 23 composed of n plaintext blocks xᵢ 21 is encrypted using a secret key K 31 to obtain output ciphertext string y 26 composed of ciphertext blocks yᵢ 24. The plaintext string x 23 (which is padded in a standard way as necessary) is partitioned into a plurality of plaintext segments 27. Each plaintext segment contains a plurality of plaintext blocks xᵢ 21. FIG. 9 shows an example in which the number of segments is L=3, and the plaintext string x 23 has 12 plaintext blocks x₁ x₂ x₃ x₄ x₅ x₆ x₇ x₈ x₉ x₁₀ x₁₁ x₁₂; furthermore, plaintext segment 1 is composed of plaintext blocks x₁ x₂ x₃ x₄, plaintext segment 2 is composed of plaintext blocks x₅ x₆ x₇ x₈, and plaintext segment 3 is composed of plaintext blocks x₉ x₁₀ x₁₁ x₁₂. Note that although in the example presented in FIG. 9, the plaintext segments 27 have the same number of plaintext blocks 21, this is not required.

For each plaintext segment 27, a variant 75 of the counter ctr 72 is enciphered using F_{K} 41, the block cipher F using the secret key K 31, to yield the per-segment secret random numbers r₀ₗ71. FIG. 9 shows an example in which the per-segment variant 75 of the counter is computed from the counter by adding modulo 2^{λ}, a segment index, i.e., for plaintext segment 1 use ctr as the variant of the counter 75 and compute the first segment random number r₀₁ 71 as r₀₁=F_{K}(ctr), for plaintext segment 2 use ctr+1 modulo 2^{λ} as the variant of the counter 75 and compute the second segment random number r₀₂ 71 as r₀₂=F_{K}(ctr+1), and for plaintext segment 3 use ctr+2 modulo 2^{λ} as the variant of the counter 75 and compute the third segment random number r₀₃ 71 as r₀₃=F_{K}(ctr+2). Each per-segment random number 71 and the plaintext segment 27 are submitted to a stateful-sender parallel encryption mode 53 (e.g., FIG. 5) using the secret key K 31 that generates the ciphertext blocks 24 of output ciphertext segment 28. The ciphertext segments 28 are further assembled together with the number of ciphertext segments L, the length of each ciphertext segment and the ciphertext segment sequence into the ciphertext string y 26 (e.g., by standard ASN.1 encoding). The ciphertext string y 26 contains n+L ciphertext blocks. FIG. 9 shows an example in which plaintext segment 1 is encrypted using the parallel encryption mode 53, the secret random number r₀₁ generated at 71, the secret key K 31 to obtain the ciphertext blocks y₁ y₂ y₃ y₄ y′₅; plaintext segment 2 is encrypted using the parallel encryption mode 53, the secret random number r₀₂ generated at 71, the secret key K 31 to obtain the ciphertext blocks y₅ y₆ y₇ y₈ y′₉; and plaintext segment 3 is encrypted using the parallel encryption mode 53, the secret random number r₀₃ generated at 71, the secret key K 31 to obtain the ciphertext blocks y₉ y₁₀ y₁₁ y₁₂ y′₁₃. In the example presented in FIG. 9, the ciphertext string 26 is y=y₁ y₂ y₃ y₄ y′₅ y₅ y₆ y₇ y₈ y′₉ y₉ y₁₀ y₁₁ y₁₂ y′₁₃ and contains n+L=12+3=15 ciphertext blocks.

With the encryption of each plaintext string, the current value of the counter ctr is incremented with the number of plaintext segments L, or otherwise changed to a new value, at 73. This new value is used to encrypt the next plaintext string.

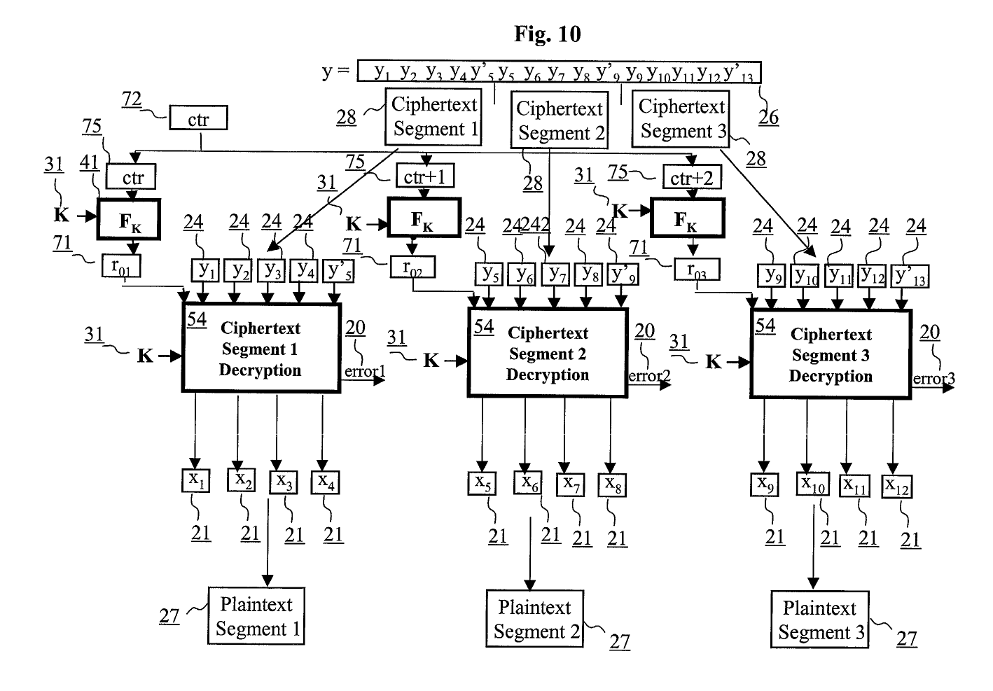

FIG. 10 illustrates a schematic diagram for the preferred embodiment of the L-segment stateful-sender parallel decryption mode. Input ciphertext string y 26 is decrypted at 54 to obtain a plurality of output plaintext segments x 27 or failure indicators 20. The parsing of the string encoding of y 26 yields the ctr 72, the number of ciphertext segments L, the length of each ciphertext segment and the ciphertext segment sequence. The parsing of the ciphertext string y yields the number of ciphertext segments L, the length of each ciphertext segment and the ciphertext segment sequence; furthermore, the ciphertext string y 26 is partitioned into a plurality of ciphertext segments 28. Each segment contains a plurality of ciphertext blocks yᵢ 24. FIG. 10 shows an example in which the number of segments is L=3, the ciphertext string y 26 has 15 ciphertext blocks y₁ y₂ y₃ y₄ y′₅ y₅ y₆ y₇ y₈ y′₉ y₉ y₁₀ y₁₁ y₁₂ y′₁₃; furthermore, ciphertext segment 1 is composed of ciphertext blocks y₁ y₂ y₃ y₄ y′₅, ciphertext segment 2 is composed of ciphertext blocks y₅ y₆ y₇ y₈ y′₉, and ciphertext segment 3 is composed of ciphertext blocks y₉ y₁₀ y₁₁ y₁₂ y′₁₃. Note that although in the example presented in FIG. 10, the ciphertext segments 28 have the same number of ciphertext blocks 24, this is not required.

From the counter ctr 72, the per-segment secret random number r₀ₗ 71 are obtained in the same manner as at a segmented encryption mode. For each ciphertext segment 28, a variant 75 of the counter ctr 72 is enciphered using F_{K} 41, the block cipher F using a secret key K 31, to yield the per-segment secret random numbers r₀ₗ 71. FIG. 10 shows an example in which the per-segment variant 75 of the counter is computed from the counter by adding modulo 2^{λ}, a segment index, i.e., for ciphertext segment 1 use ctr as the variant of the counter 75 and compute the first segment random number r₀₁ 71 as r₀₁=F_{K}(ctr), for ciphertext segment 2 use ctr+1 modulo 2^{λ} as the variant of the counter 75 and compute the second segment random number r₀₂ 71 as r₀₂=F_{K}(ctr+1), and for ciphertext segment 3 use ctr+2 modulo 2^{λ} as the variant of the counter 75 and compute the third segment random number r₀₃ 71 as r₀₃=F_{K}(ctr+2). Each per-segment random number 71 and the ciphertext segment 28 are submitted to a stateful-sender parallel decryption mode 54 (viz., FIG. 6) using the secret key K 31 that generates the plaintext blocks 21 of output plaintext segment 27 or the failure indicator 20.

Each plaintext segment 27 is either accepted, or it is rejected if the output of the stateful-sender parallel decryption mode 54 is the failure indicator 20.

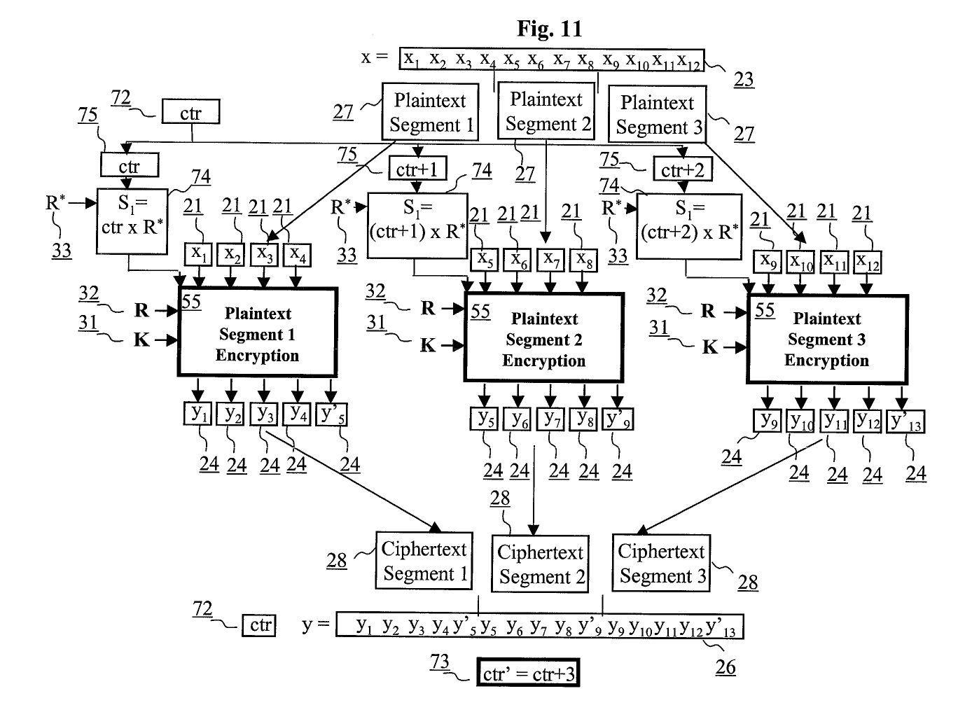

FIG. 11 illustrates a schematic diagram for the preferred embodiment of the L-segment stateful parallel encryption mode. Input plaintext string x 23 composed of n plaintext blocks xᵢ 21 is encrypted using a secret key K 31 to obtain output ciphertext string y 26 composed of ciphertext blocks yᵢ 24. The plaintext string x 23 (which is padded in a standard way as necessary) is partitioned into a plurality of plaintext segments 27. Each plaintext segment contains a plurality of plaintext blocks xᵢ 21. FIG. 11 shows an example in which the number of segments is L=3, and the plaintext string x 23 has 12 plaintext blocks x₁ x₂ x₃ x₄ x₅ x₆ x₇ x₈ x₉ x₁₀ x₁₁ x₁₂; furthermore, plaintext segment 1 is composed of plaintext blocks x₁ x₂ x₃ x₄, plaintext segment 2 is composed of plaintext blocks x₅ x₆ x₇ x₈, and plaintext segment 3 is composed of plaintext blocks x₉ x₁₀ x₁₁ x₁₂. Note that although in the example presented in FIG. 11, the plaintext segments 27 have the same number of plaintext blocks 21, this is not required.

For each plaintext segment 27, a per-segment unpredictable element is created at 74 from a first secret random number R* 33 and the non-zero counter 72; i.e., for plaintext segment 1, the per-segment unpredictable element 74 is R*×ctr (modulo 2^{λ}), for plaintext segment 2, the per-segment unpredictable element 74 is R*×(ctr+1) (modulo 2^{λ}), for plaintext segment 3, the per-segment unpredictable element 74 is R*×(ctr+2) (modulo 2^{λ}).

Each per-segment unpredictable element 74 and the plaintext segment 27 are submitted to a stateful parallel encryption mode 55 (viz., FIG. 7) using the secret key K 31 that generates the ciphertext blocks 24 of output ciphertext segment 28. The ciphertext segments 28 are further assembled together with the number of ciphertext segments L, the length of each ciphertext segment and the ciphertext segment sequence into the ciphertext string y 26 (e.g., by standard ASN.1 encoding). The ciphertext string y 26 contains n+L ciphertext blocks. FIG. 11 shows an example in which plaintext segment 1 is encrypted using the parallel encryption mode 55, the per-segment unpredicatable element R*×ctr (modulo 2^{λ}) generated at 74, the secret key K 31 to obtain the ciphertext blocks y₁ y₂ y₃ y₄ y′₅; plaintext segment 2 is encrypted using the parallel encryption mode 55, the per-segment unpredictable element R*×(ctr+1) (modulo 2^{λ}) generated at 74, the secret key K 31 to obtain the ciphertext blocks y₅ y₆ y₇ y₈ y′₉; and plaintext segment 3 is encrypted using the parallel encryption mode 55, the per-segment unpredictable element R*×(ctr+2) (modulo 2^{λ}) generated at 74, the secret key K 31 to obtain the ciphertext blocks y₉ y₁₀ y₁₁ y₁₂ y′₁₃. In the example presented in FIG. 11, the ciphertext string 26 is y=y₁ y₂ y₃ y₄ y′₅ y₅ y₆ y₇ y₈ y′₉ y₉ y₁₀ y₁₁ y₁₂ y′₁₃ and contains n+L=12+3=15 ciphertext blocks.

With the encryption of each plaintext string, the current value of the non-zero counter ctr is incremented with the number of plaintext segments L, or otherwise changed to a new non-zero value, at 73. This new value is used to encrypt the next plaintext string.

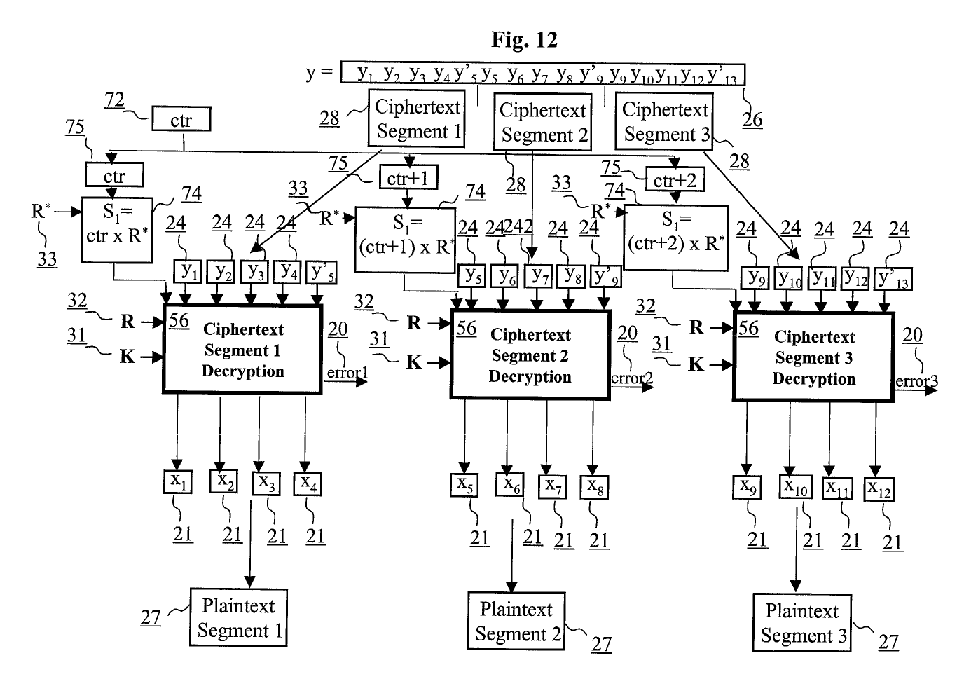

FIG. 12 illustrates a schematic diagram for the preferred embodiment of the L-segment stateful parallel decryption mode. Input ciphertext string y 26 is decrypted at 56 to obtain a plurality of output plaintext segments x 27 or failure indicators 20. The parsing of the string encoding of y 26 yields the ctr 72, the number of ciphertext segments L, the length of each ciphertext segment and the ciphertext segment sequence. The parsing of the ciphertext string y yields the number of ciphertext segments L, the length of each ciphertext segment and the ciphertext segment sequence; furthermore, the ciphertext string y 26 is partitioned into a plurality of ciphertext segments 28. Each segment contains a plurality of ciphertext blocks yᵢ 24. FIG. 12 shows an example in which the number of segments is L=3, the ciphertext string y 26 has 15 ciphertext blocks y₁ y₂ y₃ y₄ y′₅ y₅ y₆ y₇ y₈ y′₉ y₉ y₁₀ y₁₁ y₁₂ y′₁₃; furthermore, ciphertext segment 1 is composed of ciphertext blocks y₁ y₂ y₃ y₄ y′₅, ciphertext segment 2 is composed of ciphertext blocks y₅ y₆ y₇ y₈ y′₉, and ciphertext segment 3 is composed of ciphertext blocks y₉ y₁₀ y₁₁ y₁₂ y′₁₃. Note that although in the example presented in FIG. 12, the ciphertext segments 28 have the same number of ciphertext blocks 24, this is not required.

From the non-zero counter ctr 72, the per-segment secret unpredictable elements 74 are obtained in the same manner as at a segmented encryption mode; i.e., for ciphertext segment 1, the per-segment unpredictable element 74 is R*×ctr (modulo 2^{λ}), for ciphertext segment 2, the per-segment unpredictable element 74 is R*×(ctr+1) (modulo 2^{λ}), for ciphertext segment 3, the per-segment unpredictable element 74 is R*×(ctr+2) (modulo 2^{λ}).

Each per-segment unpredictable element 74 and the ciphertext segment 28 are submitted to a stateful parallel decryption mode 56 (e.g., FIG. 8) using the secret key K 31 that generates the plaintext blocks 21 of output plaintext segment 27 or the failure indicator 20.

Each plaintext block 27 is either accepted, or it is rejected if the output of the stateful parallel decryption mode 56 is the failure indicator 20.

It is readily understood by those skilled in the art that similar modes can be derived for stateless segmented encryption method and stateless decryption method, wherein, in the preferred embodiment, the per-segment random numbers r₀ᵢ 71 are generated by a random number generator. In an alternate embodiment, the per-segment random numbers r₀ᵢ 71 are generated from the shared secret key K 31 by key-separation techniques well-known in the art.

Additional properties of the method of this invention are now presented. In a further aspect, the method of this invention allows the incremental replacement of ciphertext blocks without requiring the complete re-execution of the decryption and encryption procedure. That is, if a plaintext block xᵢ of an n-block encrypted string x needs to be updated to obtain new plaintext block x′ᵢ of new string x′, then the ciphertext block yᵢ of the i-th block ciphertext string y is replaced with a new block y′ᵢ. A new MDC(x′) block and ciphertext blocks y′ₗ and y′ₙ₊₁ are computed using only a small number of invocations of the block cipher that does not depend on the number of blocks of the input plaintext string x and of the ciphertext string y of the original. For instance, for the preferred embodiment of the stateless parallel encryption mode using secret key K, if R* and R (viz., FIG. 7), are the random independent secret λ-bit numbers used in the encryption of the original input plaintext string x, then the ciphertext string y′ in which block yₗ is replaced with a new block y′ᵢ, representing the enciphering of updated plaintext block x′ₗ, then the ciphertext y′ of plaintext string x′ is thus computed as follows.

The new block x′ᵢ is used to update original plaintext block xₙ₊₁=MDC(x)=x₁\mathring{+} . . . \mathring{+}xₙ and obtain plaintext block x′ₙ₊₁=MDC(x′)=MDC(x)\mathring{+}x′ᵢ\mathring{+}xᵢ. The new blocks x′ᵢ and x′ₙ₊₁ are used to generate two new ciphertext blocks y′ᵢ and y′ₙ₊₁. Both ciphertext blocks y′ₗ and y′ₙ₊₁ are generated using the steps defined in FIG. 7. To obtain new ciphertext y′ᵢ block x′ᵢ is subjected to a randomization step comprising, in one embodiment, applying a combination operation 82 (viz., FIG. 7) with the i-th element Eᵢ of a sequence of n+1 unpredictable λ-bit elements 81. The resulting λ-bit hidden plaintext block v′ᵢ 88 is enciphered with block cipher F_{K} 41 using secret key K 31 to obtain the hidden ciphertext block z′ᵢ 87. This hidden ciphertext block is further randomized by applying a combination operation 84 (viz., FIG. 7) with the i-th element Eᵢ (viz., FIG. 7) to obtain the desired ciphertext y′ᵢ. To obtain new ciphertext y′ᵢ₊₁, block x′ᵢ₊₁ is subjected to a randomization step comprising, in one embodiment, applying a combination operation 82 (viz., FIG. 7) with the n+1-st element E*ₙ₊₁ of a sequence of n+1 unpredictable λ-bit elements 81. The resulting λ-bit hidden plaintext block Vₙ₊₁ 88 is enciphered with block cipher F_{K} 41 using secret key K 31 to obtain the hidden ciphertext block zₙ₊₁ 87. This hidden ciphertext block is further randomized by applying a combination operation 84 (viz., FIG. 7) with the n+1-st element Eₙ₊₁ (viz., FIG. 7) to obtain the desired ciphertext y′ₙ₊₁.

It is readily understood by those skilled in the art that deletion or insertion of a ciphertext block y′ᵢ, 2≦i≦n, can also be performed without requiring the complete execution of the message decryption and encryption procedures. Furthermore, it is also readily understood by those skilled in the art that the incremental replacement, deletion, or insertion of a plurality of ciphertext blocks without requiring the complete execution of the message decryption and encryption procedures applies to all other embodiments of this invention, not just to the parallel stateful encryption mode described at FIGS. 7 and 8.

In a yet further aspect of this invention, the method of this invention allows out-of-order processing of both plaintext and ciphertext blocks of a message. Referring to the preferred embodiment of the stateful parallel decryption mode using secret key K 31 (viz., FIG. 8), if any ciphertext block yₗ is received before the other ciphertext blocks, then the corresponding unpredictable element for the hidden ciphertext Eₗ 83 and the corresponding unpredictable element for the hidden plaintext Eᵢ for 1≦i≦n and E*ₙ₊₁ for i=n+1 81 can be computed immediately, and the inverse combination operation for the hidden ciphertext 85 and the inverse combination operation for the hidden plaintext 86 can be performed immediately; i.e., there is no delay for any additional deciphering or enciphering operation. Also, for the preferred embodiment of the parallel stateful encryption mode using secret key K 31 (viz., FIG. 7), if any plaintext block xᵢ is received before the other plaintext blocks, then the corresponding unpredictable element for the hidden plaintext Eᵢ for 1≦i≦n and E*ₙ₊₁ for i=n+1 81 and the corresponding unpredictable element for the hidden ciphertext Eᵢ 83 can be computed immediately, and the combination operation for the hidden plaintext 82 and the combination operation for the hidden ciphertext 84 can be performed immediately; i.e., there is no delay for any additional deciphering or enciphering operation.

It is readily understood by those skilled in the art that the out-of-order processing of applies to all other embodiments of this invention, not just to the parallel stateful encryption mode using secret key K 31 (described in FIGS. 7 and 8).

Additional details of the embodiment of the method of the present invention are now presented. The encryption modes presented in this method processes plaintext strings whether or not they are multiple of a desired block length λ. The method begins by selecting F, an λ-bit block cipher using keys of length k. For example, λ is 64 and k=56 when F is the DES algorithm. Of course, other block ciphers are known to those skilled in the art, and some of these block ciphers have been surveyed by Menezes, Van Oorschot and Vanstone in their book entitled “Handbook of Applied Cryptography,” CRC Press, 1997 hereby included by reference.

In the preferred embodiments of the stateless mode and of the stateful-sender mode, padding the plaintext string 23 comprises the following steps: if the last block xₙ of the plaintext has λ bits in length derive a last element E*ₙ₊₁ of the sequence of unpredictable elements for the hidden plaintext 81 to be combined with the MDC block 22 (i.e., block xₙ₊₁) from the bit-wise complement sₒ of a random number r₀ 71, namely E*ₙ₊₁=s₀×(n+2) modulo 2^{λ}; else, append to the last block of the plaintext xₙ the bit 1 and the necessary bits of 0 to generate a last equal block 21, and derive a last element E*ₙ₊₁ of the sequence of unpredictable elements for the hidden plaintext 81 to be combined with the MDC block 22 (i.e., block xₙ₊₁) from the random number r₀ 71, namely E*ₙ₊₁=r₀×(n+2) modulo 2^{λ}. In these preferred embodiments of the stateless mode and of the stateful-sender mode, each but the last of the plurality of the unpredictable elements (81) of the sequence of unpredictable elements for the hidden plaintext is generated by combining a different element identifier i for each of the unpredictable elements and the secret random number r₀ 71; i.e., Eₗ=r₀×i modulo 2^{λ} for plaintext blocks with i=1, 2, . . . , n. In the preferred embodiment of the stateful mode, padding the plaintext string 23 consists of the following steps: if the last block xₙ of the plaintext has λ bits in length derive a last element E*ₙ₊₁ of the sequence of unpredictable elements for the hidden plaintext 81 to be combined with the MDC block 22 (i.e., block xₙ₊₁) from the bit-wise complement S* of random number R* 33 , namely E*ₙ₊₁=S*×ctr modulo 2^{λ}; else, append to the last block of the plaintext xₙ the bit 1 and the necessary bits of 0 to generate a last equal block 21, and derive a last element E*ₙ₊₁ of the sequence of unpredictable elements for the hidden plaintext 81 to be combined with the MDC block 22 (i.e., block xₙ₊₁) from the random number R* 33, namely E*ₙ₊₁=R*×ctr modulo 2^{λ}. In this preferred embodiment of the stateful mode, each but the last of the plurality of the unpredictable elements (81) of the sequence of unpredictable elements for the hidden plaintext is generated as: Eₗ=R×i+R*×ctr modulo 2^{λ} for plaintext blocks with i=1, 2, . . . , n. In an alternate embodiment, the input plaintext string x 23 is padded in some standard fashion as necessary so that it is a multiple of λ bits. In this alternate embodiment, the padding is commonly known in the data processing art.

It should be appreciated by those skilled in the art that the specific embodiments disclosed above may be readily utilized as a basis for modifying or designing other techniques and routines for carrying out the same purposes and spirit of the present invention as set forth in the claims.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

What is claimed is:

1. A parallel encryption method for providing both data confidentiality and integrity for a message, comprising the steps of:
receiving an input plaintext string comprising a message;
generating a plurality of equal-sized blocks of λ bits in length from the input plaintext string;
creating an MDC block of λ bits in length that includes the result of applying a non-cryptographic Manipulation Detection Code (MDC) function to the plurality of said equal-size blocks;
presenting the equal-size blocks and the MDC block to a selected parallel encryption mode that makes one and only one processing pass with a single cryptographic primitive over each of the said equal-size blocks and said MDC block to create a plurality of hidden ciphertext blocks each of λ bits in length; and
performing a hidden ciphertext randomization function over said plurality of hidden ciphertext blocks to create a plurality of output ciphertext blocks each of λ bits in length.

2. The method as defined in claim 1, comprising the steps of:
wherein said selected parallel encryption mode is confidentiality-secure against chosen-plaintext attacks, wherein each of said equal-size blocks and the MDC block is processed by a block cipher using a secret key (K) to obtain said plurality of hidden ciphertext blocks; and
wherein said performing a hidden ciphertext randomization function step comprises combining each of said hidden ciphertext blocks with a corresponding element of a sequence of unpredictable elements for the hidden ciphertext to create a set of output blocks of the ciphertext, wherein a hidden ciphertext block identified by an index i is combined with the element of the sequence identified by index i by an operation for the hidden ciphertext that has an inverse.

3. The method as defined in claim 2, wherein said selected parallel encryption mode that is confidentiality-secure against chosen-plaintext attacks comprises the steps of:
performing a plaintext randomization function over said plurality of equal-sized blocks of the plaintext and the MDC block to create a plurality of hidden plaintext blocks each of λ bits in length; and
processing each of said hidden plaintext blocks by a block cipher using said secret key (K) to obtain said plurality of hidden ciphertext blocks.

4. The method as defined in claim 3, wherein said performing a plaintext randomization function step comprises combining each of said equal-size blocks and the MDC block with a corresponding element of a sequence of unpredictable elements for the hidden plaintext to create a set of hidden plaintext blocks, wherein an equal-size block or the MDC block identified by an index i is combined with the element of the sequence identified by index i by an operation for the hidden plaintext that has an inverse.

5. The method as defined in claim 2,
wherein the result of the combination of any two different unpredictable elements of the sequence of unpredictable elements for the hidden ciphertext by the inverse operation of the operation for the hidden ciphertext is unpredictable; and
wherein said unpredictable elements selected as said two unpredictable elements for the hidden ciphertext are any two different elements of the same sequence of unpredictable elements for the hidden ciphertext used for the encryption of said plaintext string; and
wherein said unpredictable elements selected as said two unpredictable elements for the hidden ciphertext are any two different elements of a plurality of sequences of unpredictable elements for the hidden ciphertext used for encryption of a plurality of plaintext strings with the same secret key K.

6. The method as defined in claim 4,
wherein the result of the combination of any two different unpredictable elements of the sequence of unpredictable elements for the hidden plaintext by the inverse operation of the operation for the hidden plaintext is unpredictable; and
wherein said unpredictable elements selected as said two unpredictable elements for the hidden plaintext are any two different elements of the same sequence of unpredictable elements for the hidden plaintext used for the encryption of said plaintext string; and
wherein said unpredictable elements selected as said two unpredictable elements for the hidden plaintext are any two different elements of a plurality of sequences of unpredictable elements for the hidden plaintext used for encryption of a plurality of plaintext strings with the same secret key K.

7. The method as defined in claim 4,
wherein any two different unpredictable elements of the sequence of unpredictable elements for the hidden ciphertext are not pair-wise independent;
wherein said unpredictable elements selected as said two unpredictable elements for the hidden ciphertext are any two different elements of the same sequence of unpredictable elements for the hidden ciphertext used for the encryption of said plaintext string; and
wherein said unpredictable elements selected as said two unpredictable elements for the hidden ciphertext are any two different elements of a plurality of sequences of unpredictable elements for the hidden ciphertext used for encryption of a plurality of plaintext strings with the same secret key K; and
wherein any two different unpredictable elements of the sequence of unpredictable elements for the hidden plaintext are not pair-wise independent;
wherein said unpredictable elements selected as said two unpredictable elements for the hidden plaintext are any two different elements of the same sequence of unpredictable elements for the hidden plaintext used for the encryption of said plaintext string; and
wherein said unpredictable elements selected as said two unpredictable elements for the hidden plaintext are any two different elements of a plurality of sequences of unpredictable elements for the hidden plaintext used for encryption of a plurality of plaintext strings with the same secret key K.

8. The method as defined in claim 1, wherein said creating an MDC block step comprises applying the non-cryptographic MDC function to the equal-sized blocks of the plaintext.

9. The method of claim 8, wherein said non-cryptographic MDC function is the bit-wise exclusive-or function.

10. The method of claim 8, wherein said non-cryptographic MDC function is the addition modulo 2^{λ}-1function.

11. The method of claim 8, wherein said non-cryptographic MDC function is the subtraction modulo 2^{λ}-1function.

12. The method of claim 8 further comprising combining the result from applying the non-cryptographic Manipulation Detection Code function to the plurality of equal-sized blocks of the plaintext with a secret, λ-bit random vector generated on a per-message basis to obtain said MDC block.

13. The method as defined in claim 12, wherein said combining step comprises performing the combination using a bit-wise exclusive-or function.

14. The method as defined in claim 12, wherein said combining step comprises performing the combination using addition modulo 2^{λ}-1.

15. The method as defined in claim 12, wherein said combining step comprises performing the combination using subtraction modulo 2^{λ}-1.

16. The method as defined in claim 12, comprising the step of generating said secret random vector from a secret random number generated on a per-message basis.

17. The method as defined in claim 2, further comprising the step of appending the created MDC block after a last block of the set of equal-sized blocks of the plaintext.

18. The method as defined in claim 2, wherein the hidden ciphertext blocks from the processing step comprise n+1 hidden ciphertext blocks each of λ-bit length, where n is the total number of blocks in said set of equal-sized blocks of the plaintext.

19. The method as defined in claim 2, further comprising the step of generating each of a plurality of the unpredictable elements of said sequence of unpredictable elements for the hidden ciphertext by combining a different element identifier for each of the unpredictable elements and a secret random number.

20. The method as defined in claim 4, further comprising the step of generating each of a plurality of the unpredictable elements of said sequence of unpredictable elements for the hidden plaintext by combining a different element identifier for each of the unpredictable elements and a secret random number.

21. The method as defined in claim 4, further comprising the steps of:
generating each of a plurality of the unpredictable elements of said sequence of unpredictable elements for the hidden ciphertext by combining a different element identifier for each of the unpredictable elements and a secret random number; and
generating each of a plurality of the unpredictable elements of said sequence of unpredictable elements for the hidden plaintext by combining a different element identifier for each of the unpredictable elements and said secret random number.

22. The method as defined in claim 21, further comprising the steps of:
wherein generating each element in said sequence of unpredictable elements for the hidden ciphertext comprises a modular 2^{λ} multiplication of a different unique element identifier (i) for each element in the sequence of unpredictable elements and said secret random number; and
wherein generating each element in said sequence of unpredictable elements for the hidden plaintext comprises a modular 2^{λ} multiplication of a different unique element identifier (i) for each element in the sequence of unpredictable elements and said secret random number for all the equal-size blocks of the plaintext and by modular 2^{λ} multiplication of n+2 and said secret random number for the MDC block.

23. The method as defined in claim 21, further comprising the steps of:
enciphering the secret random number using the block cipher using the secret key (K); and
including this enciphered secret random number (y₀) as one of said output ciphertext blocks.

24. The method of claim 21, wherein the secret random number is provided by a random number generator.

25. The method as defined in claim 21, further comprising:
generating said secret random number by enciphering a count of a counter initialized to a constant, said enciphering being performed with the block cipher using the secret key (K); and
incrementing said counter by one on every message encryption.

26. The method as defined in claim 25, wherein said counter is initialized to a constant whose value is the λ-bit representation of negative one.

27. The method as defined in claim 25, comprising:
initializing said counter to a secret value of λ bits in length.

28. The method as defined in claim 25, further comprising:
outputting said counter value as an output block of the encryption mode.

29. The method as defined in claim 4, further comprising the steps of:
deriving a block-index-independent unpredictable element;
generating each of a plurality of the unpredictable elements of said sequence of unpredictable elements for the hidden ciphertext by combining said block-index-independent unpredictable element with each of a plurality of block-index-dependent unpredictable elements for the hidden ciphertext; and
generating each of a plurality of the unpredictable elements of said sequence of unpredictable elements for the hidden plaintext by combining said block-index-independent unpredictable element with each of a plurality of block-index-dependent unpredictable elements for the hidden ciphertext.

30. The method of claim 29, further comprising the steps of:
wherein said block-index-independent unpredictable element is obtained from a count of an λ-bit counter initialized to a non-zero constant, and a per-key secret, first random initial number shared between sender and receiver; and
wherein each of said plurality of block-index-dependent unpredictable elements for the hidden ciphertext is obtained from an λ-bit element index and a secret, second random initial number shared between sender and receiver;
wherein each of said plurality of block-index-dependent unpredictable elements for the hidden plaintext is obtained from an λ-bit element index and a per-key secret, second random initial number shared between sender and receiver;
wherein said secret, first and second random initial numbers are independent; and
wherein said λ-bit counter is incremented by one on every message encryption.

31. The method of claim 29, wherein said combining to obtain the unpredictable elements for the hidden ciphertext comprises an addition modulo 2^{λ}.

32. The method of claim 29, wherein said combining to obtain the unpredictable elements for the hidden plaintext comprises an addition modulo 2^{λ}.

33. The method of claim 29, wherein said combining to obtain the unpredictable elements for the hidden ciphertext comprises a subtraction modulo 2^{λ}.

34. The method of claim 29, wherein said combining to obtain the unpredictable elements for the hidden plaintext comprises a subtraction modulo 2^{λ}.

35. The method of claim 29, wherein said combining to obtain the unpredictable elements for the hidden ciphertext comprises a bit-wise exclusive-or operation.

36. The method of claim 29, wherein said combining to obtain the unpredictable elements for the hidden plaintext comprises a bit-wise exclusive-or operation.

37. The method of claim 30, further comprising the steps of:
wherein said block-index-independent unpredictable element is obtained by multiplication modulo 2^{λ} of said secret, first random initial number with a different value of the counter; and
wherein each of said plurality of block-index-dependent unpredictable elements for the hidden ciphertext is obtained by multiplication modulo 2^{λ} of said secret, second random initial number with the index i of the hidden ciphertext block; and
wherein each of said plurality of block-index-dependent unpredictable elements for the hidden plaintext is obtained by multiplication modulo 2^{λ} of said secret, second random initial number with the index i of the plaintext block; and
wherein the unpredictable element for the hidden plaintext corresponding to the MDC block is the block-index-independent unpredictable element itself.

38. The method as defined in claim 2, wherein said operation for the hidden ciphertext that has an inverse is the addition modulo 2^{λ}.

39. The method as defined in claim 2, wherein said operation for the hidden ciphertext that has an inverse is a bit-wise exclusive-or operation.

40. The method as defined in claim 2, wherein said operation for the hidden ciphertext that has an inverse is the subtraction modulo 2^{λ} operation.

41. The method as defined in claim 4, wherein said operation for the hidden plaintext that has an inverse is the addition modulo 2^{λ}.

42. The method as defined in claim 4, wherein said operation for the hidden plaintext that has an inverse is a bit-wise exclusive-or operation.

43. The method as defined in claim 4, wherein said operation for the hidden plaintext that has an inverse is the subtraction modulo 2^{λ} operation.

44. The method as defined in claim 1, wherein said generating a plurality of equal-sized blocks of λ bits in length from the input plaintext string further comprises the steps of:
padding the input plaintext string as necessary such that its length is a multiple of λ bits; and
partitioning the padded input plaintext string into a plurality of equal-size blocks of λ bits in length.

45. The method as defined in claim 44, wherein said padding of the input plaintext string is a standard padding method.

46. The method as defined in claim 44, wherein said padding of the input plaintext string comprises the steps of:
if the last block of the plaintext has λ bits in length derive a last element of said sequence of unpredictable elements for the hidden plaintext to be combined with the MDC block to form a hidden plaintext block from the bit-wise complement of a random number;
else, append to the last block of the plaintext the bit 1 and the necessary bits of 0 to generate a last equal-size block, and derive a last element of said sequence of unpredictable elements for the hidden plaintext to be combined with the MDC block to form a hidden plaintext block from said random number; and
generating each but the last of a plurality of the unpredictable elements of said sequence of unpredictable elements for the hidden plaintext by combining a different element identifier for each of the unpredictable elements and said secret random number.

47. The method as defined in claim 44, wherein said padding of the input plaintext string comprises the steps of:
if the last block of the plaintext has λ bits in length derive a last element of said sequence of unpredictable elements for the hidden plaintext to be combined with the MDC block to form a hidden plaintext block from a different block-index-independent unpredictable element obtained from the bit-wise complement of a first random number shared between a sender and a receiver;
else, append to the last block of the plaintext the bit 1 and the necessary bits of 0 to generate a last equal-size block, and derive the last element of said sequence of unpredictable elements for the hidden plaintext to be combined with the MDC block to form a hidden plaintext block from a different block-index-independent unpredictable element obtained from the said first random number shared between a sender and a receiver; and
generating each but the last of a plurality of the unpredictable elements of said sequence of unpredictable elements for the hidden plaintext by combining a different block-index-independent unpredictable element obtained from said first random number shared between a sender and a receiver and each of a plurality of block-index-dependent unpredictable elements for the hidden plaintext.

48. A parallel decryption method that is the inverse of the parallel encryption method which provides both data confidentiality and integrity, comprising the steps of:
presenting a string including ciphertext string for decryption;
partitioning said ciphertext string into a plurality of ciphertext blocks comprising λ bits each;
selecting n+1 ciphertext blocks from said plurality of ciphertext blocks representing n data blocks and one MDC block and performing a reverse hidden ciphertext randomization function on each of the selected n+1 ciphertext blocks to obtain a plurality of hidden ciphertext blocks each of λ bits in length;
presenting the hidden ciphertext blocks to a selected parallel decryption mode that makes one and only one processing pass with a single cryptographic primitive that is the inverse of an encryption single cryptographic primitive over the plurality of hidden ciphertext blocks to obtain a plurality of plaintext blocks and one decrypted MDC block each of λ bits in length;
verifying integrity of the plaintext blocks using a non-cryptographic Manipulation Detection Function (MDC) function;
outputting the plurality of plaintext blocks as an accurate plaintext string if the integrity verification passes; and
outputting a failure indicator if the integrity verification fails.

49. The method as defined in claim 48, wherein performing said reverse hidden-ciphertext randomization function comprises: generating a sequence of unpredictable elements for the hidden ciphertext each of λ-bit length in the same manner as used at an encryption method;
selecting n+1 ciphertext blocks from said plurality of ciphertext blocks representing n data blocks and one MDC block in the same order as that used at an encryption method, and combining said selected ciphertext blocks with said sequence of unpredictable elements for the hidden ciphertext to obtain a plurality of hidden ciphertext blocks (zₗ), such that each of the n+1 ciphertext blocks identified by index i is combined with the element of the sequence of unpredictable elements for the hidden ciphertext identified by index i, by the inverse of said operation for the hidden ciphertext used at the encryption method; and
wherein the verifying integrity step comprises creating an MDC decryption block by applying the non-cryptographic Manipulation Detection Code function to the n decrypted plaintext data blocks; and
comparing said created MDC decryption block with the decrypted MDC block.

50. The method as defined in claim 49, wherein said creating an MDC decryption block further comprises combining the result with a secret, λ-bit random vector, said combining operation being the same as the combining operation at the encryption method, and said secret random vector being derived from said secret random number in the same manner as at the encryption method.

51. The method as defined in claim 48, wherein said selected parallel decryption mode comprises the steps of:
processing each of said hidden ciphertext blocks with the inverse of the block cipher used at an encryption method using a secret key (K) to obtain a plurality of hidden plaintext blocks; and
performing a reverse plaintext randomization function over said plurality of hidden plaintext blocks to create a plurality of n decrypted plaintext data blocks and one decrypted MDC block each of λ bits in length.

52. The method as defined in claim 51, wherein performing said reverse plaintext randomization function comprises:
generating a sequence of unpredictable elements for the hidden plaintext each of λ-bit length in the same manner as used at an encryption method; and
combining said selected hidden plaintext blocks with said sequence of unpredictable elements for the hidden plaintext to obtain a plurality of n plaintext blocks and one decrypted MDC block, such that each of the n+1 hidden plaintext blocks identified by index i is combined with the element of the sequence of unpredictable elements for the hidden plaintext identified by index i, by the inverse of said operation for the hidden plaintext used at the encryption method.

53. The method of claim 49, further comprising the steps of:
deriving a secret random number from said ciphertext string presented for decryption; and
generating each of a plurality of the unpredictable elements of said sequence of unpredictable elements for the hidden ciphertext in the same manner as at the encryption method.

54. The method of claim 52, further comprising the steps of:
deriving a secret random number from said ciphertext string presented for decryption; and
generating each of a plurality of the unpredictable elements of said sequence of unpredictable elements for the hidden plaintext in the same manner as at the encryption method.

55. The method of claim 52, further comprising the steps of:
deriving a secret random number from said ciphertext string presented for decryption;
generating each of a plurality of the unpredictable elements of said sequence of unpredictable elements for the hidden ciphertext in the same manner as at the encryption method; and
generating each of a plurality of the unpredictable elements of said sequence of unpredictable elements for the hidden plaintext in the same manner as at the encryption method.

56. The method of claim 48, further comprising:
selecting the ciphertext block of a secret random number (y₀) from said string presented for decryption; and
deciphering the selected ciphertext block to obtain the secret random number.

57. The method as defined in claim 56, wherein said deciphering step comprises performing the deciphering with the inverse of the said block cipher using the secret key (K).

58. The method of claim 48, further comprising:
for the encryption method generating a secret random number by enciphering a count of a counter initialized to a constant, said enciphering being performed with the block cipher using the secret key; and
incrementing said counter by one on every message encryption; and
further comprising for decrypting the ciphertext blocks of the partitioned ciphertext string the steps of:
selecting a counter block representing the count of the counter from said string presented at decryption; and
enciphering said selected counter block to obtain the secret random number.

59. The method as defined in claim 58, wherein the enciphering step comprises performing said enciphering with the block cipher using the secret key.

60. The method of claim 48, further comprising:
generating each of a plurality of the unpredictable elements of said sequence of unpredictable elements for the hidden ciphertext by combining a different block-index-independent unpredictable element with each of a plurality of block-index-dependent unpredictable elements for the hidden ciphertext in the same manner as at the encryption method; and
generating each of a plurality of the unpredictable elements of said sequence of unpredictable elements for the hidden plaintext by combining a different block-index-independent unpredictable element with each of a plurality of block-index-dependent unpredictable elements for the hidden plaintext in the same manner as at the encryption method.

61. The method as defined in claim 48, wherein the string presented for decryption is obtained by applying the encryption method that provides both data confidentiality and integrity to an input plaintext string, further comprising:
outputting said input plaintext string.

62. A method for segmented encryption processing of a message comprising the steps of:
partitioning said input plaintext string into a plurality of input plaintext segments;
concurrently presenting each different one of said plurality of input plaintext segments to a different one of a plurality of parallel encryption methods, each of said different methods using a different λ-bit secret random number per segment to obtain a ciphertext segment, wherein each encryption method provides both data confidentiality and integrity with a single processing pass over the input plaintext segment and a single cryptographic primitive, and uses a non-cryptographic Manipulation Detection Code function, wherein said single cryptographic primitive is an λ-bit block cipher using a secret key;
assembling the plurality of ciphertext segments into a ciphertext string; and
outputting the ciphertext string.

63. The method as defined in claim 62, wherein said assembling step comprises including in the ciphertext string the number of ciphertext segments, a ciphertext segment index, a length of each ciphertext segment and a sequence of ciphertext segments.

64. The method of claim 62, further comprising:
generating said different λ-bit secret random number per segment from a secret random number of λ bits in length.

65. The method of claim 64, further comprising:
generating said different secret random number per segment from the secret random number of λ bits by adding modulo 2^{λ} a plaintext segment sequence index for that segment to the secret random number.

66. The method of claim 64, further comprising:
generating said secret random number of λ bits in length by a random number generator;
enciphering said secret random number with said block cipher using a first key (K); and
including the enciphered secret random number as an output block of said output ciphertext string.

67. The method of claim 62, further comprising:
generating each of the said secret random number per segment by enciphering the result of adding the segment number to a counter initialized to a constant, said enciphering being done with said block cipher using said first key (K); and
outputting said counter value as an output block of said output ciphertext string; and
incrementing after every different message encryption said counter by a number equal to a number of plaintext segments in the message.

68. The method of claim 62, further comprising:
generating each of the said secret random number per segment from a per-key secret, first random initial number shared between sender and receiver and the result of adding modulo 2^{λ} the segment number to a counter initialized to a constant; and
outputting said counter value as an output block of said output ciphertext string; and
incrementing after every different message encryption said counter by a number equal to a number of plaintext segments in the message.

69. The method of claim 68, wherein said generating each of the said secret random number per segment comprises multiplying modulo 2^{λ} said per-key secret, first random initial number shared between sender and receiver with the result of adding the segment number to said counter.

70. A method for segmented decryption processing of a message comprising the steps of:
presenting a string including the ciphertext string of a message for decryption;
partitioning said ciphertext string into a plurality of ciphertext segments;
concurrently presenting said plurality of ciphertext segments to a plurality of decryption modes;
obtaining a different secret random number per ciphertext segment in the same manner as at the segmented encryption method;
decrypting each ciphertext segment using said different secret random number per ciphertext segment to obtain a plaintext segment, using a parallel decryption method that is the inverse of the parallel encryption method that provides both data confidentiality and integrity with a single processing pass over the input plaintext segment and a single cryptographic primitive, wherein said single cryptographic primitive is an λ-bit block cipher using a secret key, and using a non-cryptographic Manipulation Detection Code function for verifying integrity of the plaintext blocks of each plaintext segment; and
verifying the integrity of each plaintext segment and for each plaintext segment, outputting either the plaintext segment if the integrity verification passes, or an error indicator.

71. The method of claim 70, wherein each of the said different secret random numbers per ciphertext segment are obtained from a secret random number in the same manner at as used at a segmented encryption method.

72. The method of claim 71, further comprising:
selecting a ciphertext block of the secret random number from said string presented for decryption;
deciphering the selected ciphertext block to obtain the secret random number.

73. The method as defined in claim 72, performing said deciphering step with the inverse of a block cipher using said secret key, said block cipher and said secret key being the same as to those used at a segmented encryption method.

74. The method of claim 70, further comprising:
for the segmented encryption method generating said secret random number per ciphertext segment by enciphering the result of adding modulo 2^{λ} the segment number with a counter initialized to a constant, said enciphering being done with said block cipher using said first key (K); and
incrementing after every different message encryption said counter by a number equal to a number of plaintext segments in the message; and
further comprising for segmented decryption of the ciphertext segments of the partitioned ciphertext string the steps of:
selecting a counter block holding the count of the counter from said string presented for decryption;
enciphering the result of adding modulo 2^{λ} the segment number with said selected counter block to obtain said secret random number per ciphertext segment.

75. The method as defined in claim 74, wherein said enciphering of the result of adding modulo 2^{λ} the segment number with a counter initialized to a constant step comprises enciphering with the block cipher using the same key as that used for segmented encryption.

76. The method of claim 70, further comprising:
for the segmented encryption method generating each of the said secret random number per segment from a per-key secret, first random initial number shared between sender and receiver and the result of adding modulo 2^{λ} the segment number to a counter initialized to a constant; and
outputting said counter value as an output block of said output ciphertext string; and
incrementing after every different message encryption said counter by a number equal to a number of plaintext segments in the message; and
further comprising for segmented decryption of the ciphertext segments of the partitioned ciphertext string the steps of:
selecting a counter block holding the count of the counter from said string presented for decryption; and
generating each of the said secret random number per ciphertext segment from said per-key secret, first random initial number shared between sender and receiver and the result of adding modulo 2^{λ} the segment number to said counter.

77. A parallel encryption method for providing both data confidentiality and integrity for a message, that updates a ciphertext string incrementally, comprising the steps of:
receiving an input plaintext string comprising a message;
generating a plurality of equal-sized blocks of λ bits in length from the input plaintext string;
creating an MDC block of λ bits in length that includes the result of applying a non-cryptographic Manipulation Detection Code (MDC) function to the plurality of said equal-size blocks;
performing a plaintext randomization function over said plurality of equal-sized blocks of the plaintext and the MDC block to create a plurality of hidden plaintext blocks each of λ bits in length;
processing each of said hidden plaintext blocks by a block cipher using a secret key (K) to obtain a plurality of hidden ciphertext blocks;
performing a hidden ciphertext randomization function over said plurality of hidden ciphertext blocks to create a plurality of output ciphertext blocks each of λ bits in length; and
further comprising the steps of:
receiving an input plaintext string;
generating a plurality of equal-sized blocks of λ bits in length from the input plaintext string;
receiving an input ciphertext string including a plurality of n+1 equal-size blocks of the ciphertext of λ bits in length, wherein the n+1 block of the ciphertext corresponds to an MDC block for said plaintext string;
receiving a new λ-bit plaintext block to replace an λ-bit plaintext block at index i;
creating a new MDC block of λ bits in length that includes the result of applying a non-cryptographic Manipulation Detection Code (MDC) function to the plurality of said equal-size blocks and the new λ-bit plaintext block;
performing the same plaintext randomization function as that used at a parallel encryption method over said new λ-bit plaintext block and the new MDC block to create two new hidden plaintext blocks each of λ bits in length using index i for the new λ-bit plaintext block and index n+1 for the new MDC block;
processing each of said two new hidden plaintext blocks by a block cipher using said secret key (K) to obtain two new hidden ciphertext blocks;
performing the same hidden ciphertext randomization function as that used at a parallel encryption method over said two new hidden ciphertext blocks to create two new output ciphertext blocks each of λ bits in length using index i for the new λ-bit plaintext block and index n+1 for the new MDC block;
replacing in the input ciphertext string, the input ciphertext block at index i with the output ciphertext block for the new λ-bit plaintext block and replace the input ciphertext block at index n+1 with the output ciphertext block for the new MDC block, to create a new ciphertext string; and
outputting the new ciphertext string.

78. The method as defined in claim 77, wherein said generating a plurality of equal-sized blocks of λ bits in length from the input plaintext string further comprises the steps of:
padding the input plaintext string as necessary such that its length is a multiple of λ bits; and partitioning the padded input plaintext string into a plurality of equal-size blocks of λ bits in length.

79. The method of claim 77 comprising the steps of:
receiving a plurality of new λ-bit plaintext blocks to replace a plurality of λ-bit plaintext blocks at said plaintext string at index i; and
providing a parallel encryption method that outputs a ciphertext string incrementally for each of the said plurality of new λ-bit plaintext blocks.

80. A parallel encryption method for providing both data confidentiality and integrity for a message, comprising the steps of:
receiving an input plaintext string comprising a message;
generating a plurality of equal-sized blocks of λ bits in length from the input plaintext string;
partitioning the padded input plaintext string into a plurality of equal-size blocks of λ bits in length;
creating an MDC block of λ bits in length that includes the result of applying a non-cryptographic Manipulation Detection Code (MDC) function to the plurality of said equal-size blocks;
performing a plaintext randomization function over said plurality of equal-sized blocks of the plaintext and the MDC block using a different plaintext index for each equal-sized block and the MDC block to create a plurality of hidden plaintext blocks each of λ bits in length;
processing each of said hidden plaintext blocks by a block cipher using a secret key (K) to obtain a plurality of hidden ciphertext blocks;
performing a hidden ciphertext randomization function over said plurality of hidden ciphertext blocks using a different ciphertext index for each hidden ciphertext block to create a plurality of output ciphertext blocks each of λ bits in length; and
further providing an out-of-order decryption method for the parallel encryption method, which provides both data confidentiality and integrity, comprising the steps of:
receiving a string including a plurality of n+1 λ-bit ciphertext blocks for decryption;
selecting n+1 ciphertext blocks from said plurality of ciphertext blocks representing n data blocks and one MDC block and performing a reverse hidden ciphertext randomization function on each of the selected n+1 ciphertext blocks using said ciphertext index to obtain a plurality of hidden ciphertext blocks each of λ bits in length;
processing each of said hidden ciphertext blocks with the inverse of the block cipher used at an encryption method using said secret key (K) to obtain a plurality of hidden plaintext blocks; and
performing an inverse plaintext randomization function over said plurality of hidden plaintext blocks using said plaintext index to create a plurality of n decrypted plaintext data blocks and one decrypted MDC block each of λ-bit length;
creating an MDC decryption block by applying the non-cryptographic Manipulation Detection Code function to the n decrypted plaintext data blocks in the same manner as at a parallel encryption method;
verifying integrity of the plaintext blocks by comparing said created MDC decryption block with the decrypted MDC block;
outputting the plurality of plaintext blocks as an accurate plaintext string if the integrity verification passes; and
outputting a failure indicator if the integrity verification fails.

81. The method as defined in claim 80, wherein said generating a plurality of equal-sized blocks of λ bits in length from the input plaintext string further comprises the steps of:
padding the input plaintext string as necessary such that its length is a multiple of λ bits; and
partitioning the padded input plaintext string into a plurality of equal-size blocks of λ bits in length.

82. A program product for parallel encryption for providing both data confidentiality and integrity for a message, including machine-readable program code for causing a machine to perform the following method steps:
receiving an input plaintext string comprising a message;
generating a plurality of equal-sized blocks of λ bits in length from the input plaintext string;
creating an MDC block of λ bits in length that includes the result of applying a non-cryptographic Manipulation Detection Code (MDC) function to the plurality of said equal-size blocks;
presenting the equal-size blocks and the MDC block to a selected parallel encryption mode that makes one and only one processing pass with a single cryptographic primitive over each of the said equal-size blocks and said MDC block to create a plurality of hidden ciphertext blocks each of λ bits in length; and
performing a hidden ciphertext randomization function over said plurality of hidden ciphertext blocks to create a plurality of output ciphertext blocks each of λ bits in length.

83. The program product as defined in claim 82, wherein the program code includes code
to cause the step of presenting the equal-size blocks and the MDC block to a selected parallel encryption mode processing each of said equal-size blocks and the MDC block by a parallel encryption mode to be confidentiality-secure against chosen-plaintext attacks, wherein each of said equal-size blocks and the MDC block is processed by a block cipher using a secret key (K) to obtain said plurality of hidden ciphertext blocks; and
to cause the step of performing a hidden ciphertext randomization function step comprises code for combining each of said hidden ciphertext blocks with a corresponding element of a sequence of unpredictable elements for the hidden ciphertext to create a set of output blocks of the ciphertext, wherein a hidden ciphertext block identified by an index i is combined with the element of the sequence identified by index i by an operation for the hidden ciphertext that has an inverse.

84. The program product as defined in claim 83, wherein the program code for causing the performance of the step of processing each of said the equal-size blocks and the MDC block by a parallel encryption mode that is confidentiality-secure against chosen-plaintext attacks comprises code for:
performing a plaintext randomization function over said plurality of equal-sized blocks of the plaintext and the MDC block to create a plurality of hidden plaintext blocks each of λ bits in length; and
processing each of said hidden plaintext blocks by a block cipher using said secret key (K) to obtain said plurality of hidden ciphertext blocks.

85. The program product as defined in claim 84, wherein the program code for performing a plaintext randomization function step comprises code for combining each of said equal-size blocks and the MDC block with a corresponding element of a sequence of unpredictable elements for the hidden plaintext to create a set of hidden plaintext blocks, wherein an equal-size block or the MDC block identified by an index i is combined with the element of the sequence identified by index i by an operation for the hidden plaintext that has an inverse.

86. The program product as defined in claim 83,
wherein the result of the combination of any two different unpredictable elements of the sequence of unpredictable elements for the hidden ciphertext by the inverse operation of the operation for the hidden ciphertext is unpredictable; and
wherein said unpredictable elements selected as said two unpredictable elements for the hidden ciphertext are any two different elements of the same sequence of unpredictable elements for the hidden ciphertext used for the encryption of said plaintext string; and
wherein said unpredictable elements selected as said two unpredictable elements for the hidden ciphertext are any two different elements of a plurality of sequences of unpredictable elements for the hidden ciphertext used for encryption of a plurality of plaintext strings with the same secret key K.

87. The program product as defined in claim 85,
wherein the result of the combination of any two different unpredictable elements of the sequence of unpredictable elements for the hidden plaintext by the inverse operation of the operation for the hidden plaintext is unpredictable; and
wherein said unpredictable elements selected as said two unpredictable elements for the hidden plaintext are any two different elements of the same sequence of unpredictable elements for the hidden plaintext used for the encryption of said plaintext string; and
wherein said unpredictable elements selected as said two unpredictable elements for the hidden plaintext are any two different elements of a plurality of sequences of unpredictable elements for the hidden plaintext used for encryption of a plurality of plaintext strings with the same secret key K.

88. A program product for parallel decryption that is the inverse of a program product for parallel encryption which provides both data confidentiality and integrity, comprising machine-readable program code for causing a machine to perform the following method steps:
presenting a string including ciphertext string for decryption;
partitioning said ciphertext string into a plurality of ciphertext blocks comprising λ bits each;
selecting n+1 ciphertext blocks from said plurality of ciphertext blocks representing n data blocks and one MDC block and performing a reverse hidden ciphertext randomization function on each of the selected n+1 ciphertext blocks to obtain a plurality of hidden ciphertext blocks each of λ bits in length;
presenting the hidden ciphertext blocks to a selected parallel decryption mode that makes one and only one processing pass with a single cryptographic primitive that is the inverse of an encryption single cryptographic primitive over the plurality of hidden ciphertext blocks to obtain a plurality of plaintext blocks and one decrypted MDC block each of λ bits in length;
verifying integrity of the plaintext blocks using a non-cryptographic Manipulation Detection Function (MDC) function;
outputting the plurality of plaintext blocks as an accurate plaintext string if the integrity verification passes; and
outputting a failure indicator if the integrity verification fails.

89. The program product as defined in claim 88, wherein said program code for causing the performance of the step of selecting n+1 ciphertext blocks from said plurality of ciphertext blocks representing n data blocks and one MDC block and performing said reverse hidden-ciphertext randomization function comprises code for:
generating a sequence of unpredictable elements for the hidden ciphertext each of λ-bit length in the same manner as used at an encryption program product;
selecting n+1 ciphertext blocks from said plurality of ciphertext blocks representing n data blocks and one MDC block in the same order as that used at an encryption program product, and combining said selected ciphertext blocks with said sequence of unpredictable elements for the hidden ciphertext to obtain a plurality of hidden ciphertext blocks (zₗ), such that each of the n+1 ciphertext blocks identified by index i is combined with the element of the sequence of unpredictable elements for the hidden ciphertext identified by index i, by the inverse of said operation for the hidden ciphertext used at the encryption program product; and
wherein the program code for causing the performance of the step of verifying integrity comprises code for creating an MDC decryption block by applying the non-cryptographic Manipulation Detection Code function to the n decrypted plaintext data blocks; and
code for comparing said created MDC decryption block with the decrypted MDC block.

90. The program product as defined in claim 88, wherein said program code for causing the performance of the step of presenting the hidden ciphertext blocks to a selected parallel decryption mode comprises code for:
processing each of said hidden ciphertext blocks with the inverse of the block cipher used at an encryption program product using a secret key (K) to obtain a plurality of hidden plaintext blocks; and
performing a reverse plaintext randomization function over said plurality of hidden plaintext blocks to create a plurality of n decrypted plaintext data blocks and one decrypted MDC block each of λ bits in length.

91. The program product as defined in claim 90, wherein said program code for causing the performance of said reverse plaintext randomization function comprises code for:
generating a sequence of unpredictable elements for the hidden plaintext each of λ-bit length in the same manner as used at an encryption program product; and
combining said selected hidden plaintext blocks with said sequence of unpredictable elements for the hidden plaintext to obtain a plurality of n plaintext blocks and one decrypted MDC block, such that each of the n+1 hidden plaintext blocks identified by index i is combined with the element of the sequence of unpredictable elements for the hidden plaintext identified by index i, by the inverse of said operation for the hidden plaintext used at the encryption program product.

92. A program product for segmented encryption processing of a message comprising machine-readable program code for causing the performance of the following method steps:
partitioning said input plaintext string into a plurality of input plaintext segments;
concurrently presenting each different one of said plurality of input plaintext segments to a different one of a plurality of program products for parallel encryption, each of said different program products using a different λ-bit secret random number per segment to obtain a ciphertext segment, wherein each encryption program product provides both data confidentiality and integrity with a single processing pass over the input plaintext segment and a single cryptographic primitive, and uses a non-cryptographic Manipulation Detection Code function, wherein said single cryptographic primitive is an λ-bit block cipher using a secret key;
assembling the plurality of ciphertext segments into a ciphertext string; and
outputting the ciphertext string.

93. The program product as defined in claim 92, wherein said program code for causing the performance of the step of assembling comprises code for including in the ciphertext string the number of ciphertext segments, a ciphertext segment index, a length of each ciphertext segment and a sequence of ciphertext segments.

94. A program product for segmented decryption processing of a message comprising machine-readable program code for causing a machine to perform the following method steps:
presenting a string including the ciphertext string of a message for decryption;
partitioning said ciphertext string into a plurality of ciphertext segments;
concurrently presenting said plurality of ciphertext segments to a plurality of decryption modes;
obtaining a different secret random number per ciphertext segment in the same manner as at the program product for segmented encryption;
for decrypting each ciphertext segment using said different secret random number per ciphertext segment to obtain a plaintext segment, using a program product for parallel decryption that is the inverse of a program product for parallel encryption that provides both data confidentiality and integrity with a single processing pass over the input plaintext segment and a single cryptographic primitive, wherein said single cryptographic primitive is an λ-bit block cipher using a secret key, and using a non-cryptographic Manipulation Detection Code function for verifying integrity of the plaintext blocks of each plaintext segment; and
verifying the integrity of each plaintext segment and for each plaintext segment, outputting either the plaintext segment if the integrity verification passes, or an error indicator.

95. A system for parallel encryption for providing both data confidentiality and integrity for a message, comprising:
a first component for receiving an input plaintext string comprising a message;
a second component for generating a plurality of equal-sized blocks of λ bits in length from the input plaintext string;
a third component for creating an MDC block of λ bits in length that includes the result of applying a non-cryptographic Manipulation Detection Code (MDC) function to the plurality of said equal-size blocks;
a fourth component for presenting the equal-size blocks and the MDC block to a selected parallel encryption mode that makes one and only one processing pass with a single cryptographic primitive over each of the said equal-size blocks and said MDC block to create a plurality of hidden ciphertext blocks each of λ bits in length; and
a fifth component for performing a hidden ciphertext randomization function over said plurality of hidden ciphertext blocks to create a plurality of output ciphertext blocks each of λ bits in length.

96. The system as defined in claim 95, comprising:
wherein said fourth component for presenting the equal-size blocks and the MDC block to a selected parallel encryption mode comprises a component for processing each of said the equal-size blocks and the MDC block by a parallel encryption mode is confidentiality-secure against chosen-plaintext attacks, wherein each of said equal-size blocks and the MDC block is processed by a block cipher using a secret key (K) to obtain said plurality of hidden ciphertext blocks; and
wherein said fifth component for performing a hidden ciphertext randomization function step comprises a component for combining each of said hidden ciphertext blocks with a corresponding element of a sequence of unpredictable elements for the hidden ciphertext to create a set of output blocks of the cipherte)ct, wherein a hidden ciphertext block identified by an index i is combined with the element of the sequence identified by index i by an operation for the hidden ciphertext that has an inverse.

97. The system as defined in claim 96, wherein said component for processing each of said the equal-size blocks and the MDC block by a parallel encryption mode that is confidentiality-secure against chosen-plaintext attacks comprises:
a component for performing a plaintext randomization function over said plurality of equal-sized blocks of the plaintext and the MDC block to create a plurality of hidden plaintext blocks each of λ bits in length; and
a component for processing each of said hidden plaintext blocks by a block cipher using said secret key (K) to obtain said plurality of hidden ciphertext blocks.

98. The system as defined in claim 97, wherein said component for performing a plaintext randomization function step comprises a component for combining each of said equal-size blocks and the MDC block with a corresponding element of a sequence of unpredictable elements for the hidden plaintext to create a set of hidden plaintext blocks, wherein an equal-size block or the MDC block identified by an index i is combined with the element of the sequence identified by index i by an operation for the hidden plaintext that has an inverse.

99. The system as defined in claim 96,
wherein the result of the combination of any two different unpredictable elements of the sequence of unpredictable elements for the hidden ciphertext by the inverse operation of the operation for the hidden ciphertext is unpredictable; and
wherein said unpredictable elements selected as said two unpredictable elements for the hidden ciphertext are any two different elements of the same sequence of unpredictable elements for the hidden ciphertext used for the encryption of said plaintext string; and
wherein said unpredictable elements selected as said two unpredictable elements for the hidden ciphertext are any two different elements of a plurality of sequences of unpredictable elements for the hidden ciphertext used for encryption of a plurality of plaintext strings with the same secret key K.

100. The system as defined in claim 98,
wherein the result of the combination of any two different unpredictable elements of the sequence of unpredictable elements for the hidden plaintext by the inverse operation of the operation for the hidden plaintext is unpredictable; and
wherein said unpredictable elements selected as said two unpredictable elements for the hidden plaintext are any two different elements of the same sequence of unpredictable elements for the hidden plaintext used for the encryption of said plaintext string; and
wherein said unpredictable elements selected as said two unpredictable elements for the hidden plaintext are any two different elements of a plurality of sequences of unpredictable elements for the hidden plaintext used for encryption of a plurality of plaintext strings with the same secret key K.

101. A system for parallel decryption that is the inverse of a system for parallel encryption which provides both data confidentiality and integrity, comprising:
a first component for presenting a string including ciphertext string for decryption;
a second component for partitioning said ciphertext string into a plurality of ciphertext blocks comprising λ bits each;
a third component for selecting n+1 ciphertext blocks from said plurality of ciphertext blocks representing n data blocks and one MDC block and performing a reverse hidden ciphertext randomization function on each of the selected n+1 ciphertext blocks to obtain a plurality of hidden ciphertext blocks each of λ bits in length;
a fourth component for presenting the hidden ciphertext blocks to a selected parallel decryption mode that makes one and only one processing pass with a single cryptographic primitive that is the inverse of an encryption single cryptographic primitive over the plurality of hidden ciphertext blocks to obtain a plurality of plaintext blocks and one decrypted MDC block each of λ bits in length;
a fifth component for verifying integrity of the plaintext blocks using a non-cryptographic Manipulation Detection Function (MDC) function;
a sixth component for outputting the plurality of plaintext blocks as an accurate plaintext string if the integrity verification passes; and
a seventh component for outputting a failure indicator if the integrity verification fails.

102. The system as defined in claim 101, wherein said third component for selecting n+1 ciphertext blocks from said plurality of ciphertext blocks representing n data blocks and one MDC block and performing said reverse hidden-ciphertext randomization function comprises:
a component for generating a sequence of unpredictable elements for the hidden ciphertext each of λ-bit length in the same manner as used at an encryption system;
a component for selecting n+1 ciphertext blocks from said plurality of ciphertext blocks representing n data blocks and one MDC block in the same order as that used at an encryption system, and combining said selected ciphertext blocks with said sequence of unpredictable elements for the hidden ciphertext to obtain a plurality of hidden ciphertext blocks (zₗ), such that each of the n+1 ciphertext blocks identified by index i is combined with the element of the sequence of unpredictable elements for the hidden ciphertext identified by index i, by the inverse of said operation for the hidden ciphertext used at the encryption system; and
wherein the fifth code for verifying integrity step comprises a component for creating an MDC decryption block by applying the non-cryptographic Manipulation Detection Code function to the n decrypted plaintext data blocks; and a component for comparing said created MDC decryption block with the decrypted MDC block.

103. The system as defined in claim 101, wherein said fourth component for presenting the hidden ciphertext blocks to a selected parallel decryption mode comprises:
a component for processing each of said hidden ciphertext blocks with the inverse of the block cipher used at an encryption system using a secret key (K) to obtain a plurality of hidden plaintext blocks; and
a component for performing a reverse plaintext randomization function over said plurality of hidden plaintext blocks to create a plurality of n decrypted plaintext data blocks and one decrypted MDC block of λ bits in length.

104. The system as defined in claim 103, wherein said component for performing said reverse plaintext randomization function comprises:
a component for generating a sequence of unpredictable elements for the hidden plaintext each of λ-bit length in the same manner as used at an encryption system; and
a component for combining said selected hidden plaintext blocks with said sequence of unpredictable elements for the hidden plaintext to obtain a plurality of n plaintext blocks and one decrypted MDC block, such that each of the n+1 hidden plaintext blocks identified by index i is combined with the element of the sequence of unpredictable elements for the hidden plaintext identified by index i, by the inverse of said operation for the hidden plaintext used at the encryption system.

105. A system for segmented encryption processing of a message comprising:
a first component for partitioning said input plaintext string into a plurality of input plaintext segments;
a second component for concurrently presenting each different one of said plurality of input plaintext segments to a different one of a plurality of systems for parallel encryption, each of said different systems using a different λ-bit secret random number per segment to obtain a ciphertext segment, wherein each encryption system provides both data confidentiality and integrity with a single processing pass over the input plaintext segment and a single cryptographic primitive, and uses a non-cryptographic Manipulation Detection Code function, wherein said single cryptographic primitive is an λ-bit block cipher using a secret key;
a third component for assembling the plurality of ciphertext segments into a ciphertext string; and
a fourth component outputting the ciphertext string.

106. The system as defined in claim 105, wherein said third component for assembling step comprises a component for including in the ciphertext string the number of ciphertext segments, a ciphertext segment index, a length of each ciphertext segment and a sequence of ciphertext segments.

107. A system for segmented decryption processing of a message comprising:
a first component for presenting a string including the ciphertext string of a message for decryption;
a second component for partitioning said ciphertext string into a plurality of ciphertext segments;
a third component for concurrently presenting said plurality of ciphertext segments to a plurality of decryption modes;
a fourth component for obtaining a different secret random number per ciphertext segment in the same mariner as at the system for segmented encryption;
a fifth component for decrypting each ciphertext segment using said different secret random number per ciphertext segment to obtain a plaintext segment, using a system for parallel decryption that is the inverse of a system for parallel encryption that provides both data confidentiality and integrity with a single processing pass over the input plaintext segment and a single cryptographic primitive, wherein said single cryptographic primitive is an λ-bit block cipher using a secret key, and using a non-cryptographic Manipulation Detection Code function for verifying integrity of the plaintext blocks of each plaintext segment; and
a sixth component for verifying the integrity of each plaintext segment and for each plaintext segment, outputting either the plaintext segment if the integrity verification passes, or an error indicator.

108. A program product for a parallel encryption for providing both data confidentiality and integrity for a message, that updates a ciphertext string incrementally, including machine-readable code for performing the following method steps:
receiving an input plaintext string comprising a message;
generating a plurality of equal-sized blocks of λ bits in length from the input plaintext string;
creating an MDC block of λ bits in length that includes the result of applying a non-cryptographic Manipulation Detection Code (MDC) function to the plurality of said equal-size blocks;
performing a plaintext randomization function over said plurality of equal-sized blocks of the plaintext and the MDC block to create a plurality of hidden plaintext blocks each of λ bits in length;
processing each of said hidden plaintext blocks by a block cipher using a secret key (K) to obtain a plurality of hidden ciphertext blocks; performing a hidden ciphertext randomization function over said plurality of hidden ciphertext blocks to create a plurality of output ciphertext blocks each of λ bits in length; and
further including machine-readable code for performing the following method steps:
receiving an input plaintext string;
generating a plurality of equal-sized blocks of λ bits in length from the input plaintext string;
receiving an input ciphertext string including a plurality of n+1 equal-size blocks of the ciphertext of λ bits in length, wherein the n+1 block of the ciphertext corresponds to an MDC block for said plaintext string;
receiving a new λ-bit plaintext block to replace an λ-bit plaintext block at index i;
creating a new MDC block of λ bits in length that includes the result of applying a non-cryptographic Manipulation Detection Code (MDC) function to the plurality of said equal-size blocks and the new λ-bit plaintext block;
performing the same plaintext randomization function as that used at a parallel encryption method over said new λ-bit plaintext block and the new MDC block to create two new hidden plaintext blocks each of λ bits in length using index i for the new λ-bit plaintext block and index n+1 for the new MDC block;
processing each of said two new hidden plaintext blocks by a block cipher using said secret key (K) to obtain two new hidden ciphertext blocks;
performing the same hidden ciphertext randomization function as that used at a parallel encryption method over said two new hidden ciphertext blocks to create two new output ciphertext blocks each of λ bits in length using index i for the new λ-bit plaintext block and index n+1 for the new MDC block;
replacing in the input ciphertext string, the input ciphertext block at index i with the output ciphertext block for the new λ-bit plaintext block and replace the input ciphertext block at index n+1 with the output ciphertext block for the new MDC block, to create a new ciphertext string; and
outputting the new ciphertext string.

109. The program product as defined in claim 108, wherein the program code for causing the performance of the step of generating a plurality of equal-sized blocks of λ bits in length from the input plaintext string further comprises code for:
padding the input plaintext string as necessary such that its length is a multiple of λ bits; and
partitioning the padded input plaintext string into a plurality of equal-size blocks of λ bits in length.

110. The program product of claim 108 including machine-readable code for performing the method steps:
receiving a plurality of new λ-bit plaintext blocks to replace a plurality of λ-bit plaintext blocks at said plaintext string at index i; and
providing a parallel encryption method that outputs a ciphertext string incrementally for each of the said plurality of new λ-bit plaintext blocks.

111. A program product for parallel encryption method for providing both data confidentiality and integrity for a message, including machine-readable program code for causing a machine to perform the method steps:
receiving an input plaintext string comprising a message;
generating a plurality of equal-sized blocks of λ bits in length from the input plaintext string;
partitioning the padded input plaintext string into a plurality of equal-size blocks of λ bits in length;
creating an MDC block of λ bits in length that includes the result of applying a non-cryptographic Manipulation Detection Code (MDC) function to the plurality of said equal-size blocks;
performing a plaintext randomization function over said plurality of equal-sized blocks of the plaintext and the MDC block using a different plaintext index for each equal-sized block and the MDC block to create a plurality of hidden plaintext blocks each of λ bits in length;
processing each of said hidden plaintext blocks by a block cipher using a secret key (K) to obtain a plurality of hidden ciphertext blocks;
performing a hidden ciphertext randomization function over said plurality of hidden ciphertext blocks using a different ciphertext index for each hidden ciphertext block to create a plurality of output ciphertext blocks each of λ bits in length; and
further including machine-readable program code for performing an out-of-order decryption method for the parallel encryption method, which provides both data confidentiality and integrity, including code for:
receiving a string including a plurality of n+1 λ-bit ciphertext blocks for decryption;
selecting n+1 ciphertext blocks from said plurality of ciphertext blocks representing n data blocks and one MDC block and performing a reverse hidden ciphertext randomization function on each of the selected n+1 ciphertext blocks using said ciphertext index to obtain a plurality of hidden ciphertext blocks each of λ bits in length;
processing each of said hidden ciphertext blocks with the inverse of the block cipher used at an encryption method using said secret key (K) to obtain a plurality of hidden plaintext blocks; and
performing an inverse plaintext randomization function over said plurality of hidden plaintext blocks using said plaintext index to create a plurality of n decrypted plaintext data blocks and one decrypted MDC block each of λ-bit length;
creating an MDC decryption block by applying the non-cryptographic Manipulation Detection Code function to the n decrypted plaintext data blocks in the same manner as at a parallel encryption method;
verifying integrity of the plaintext blocks by comparing said created MDC decryption block with the decrypted MDC block;
outputting the plurality of plaintext blocks as an accurate plaintext string if the integrity verification passes; and
outputting a failure indicator if the integrity verification fails.

112. The program product as defined in claim 111, wherein the program code for generating a plurality of equal-sized blocks of λ bits in length from the input plaintext string comprises code for:
padding the input plaintext string as necessary such that its length is a multiple of λ bits; and
partitioning the padded input plaintext string into a plurality of equal-size blocks of λ bits in length.

113. A system for a parallel encryption for providing both data confidentiality and integrity for a message, that updates a ciphertext string incrementally, comprising:
a first component for receiving an input plaintext string comprising a message;
a second component for generating a plurality of equal-sized blocks of λ bits in length from the input plaintext string;
a third component for creating an MDC block of λ bits in length that includes the result of applying a non-cryptographic Manipulation Detection Code (MDC) function to the plurality of said equal-size blocks;
a fourth component for performing a plaintext randomization function over said plurality of equal-sized blocks of the plaintext and the MDC block to create a plurality of hidden plaintext blocks each of λ bits in length;
a fifth component for processing each of said hidden plaintext blocks by a block cipher using a secret key (K) to obtain a plurality of hidden ciphertext blocks;
a sixth component for performing a hidden ciphertext randomization function over said plurality of hidden ciphertext blocks to create a plurality of output ciphertext blocks each of λ bits in length; and
further comprising:
a seventh component for receiving an input plaintext string;
an eight component for generating a plurality of equal-sized blocks of λ bits in length from the input plaintext string;
a ninth component for receiving an input ciphertext string including a plurality of n+1 equal-size blocks of the ciphertext of λ bits in length, wherein the n+1 block of the ciphertext corresponds to an MDC block for said plaintext string;
a tenth component for receiving a new λ-bit plaintext block to replace an λ-bit plaintext block at index i;
an eleventh component for creating a new MDC block of λ bits in length that includes the result of applying a non-cryptographic Manipulation Detection Code (MDC) function to the plurality of said equal-size blocks and the new λ-bit plaintext block;
a twelfth component for performing the same plaintext randomization function as that used at a parallel encryption method over said new λ-bit plaintext block and the new MDC block to create two new hidden plaintext blocks each of λ bits in length using index i for the new λ-bit plaintext block and index n+1 for the new MDC block;
a thirteenth component for processing each of said two new hidden plaintext blocks by a block cipher using said secret key (K) to obtain two new hidden ciphertext blocks;
a fourteenth component for performing the same hidden ciphertext randomization function as that used at a parallel encryption method over said two new hidden ciphertext blocks to create two new output ciphertext blocks each of λ bits in length using index i for the new λ-bit plaintext block and index n+1 for the new MDC block;
a fifteenth component for replacing in the input ciphertext string, the input ciphertext block at index i with the output ciphertext block for the new λ-bit plaintext block and replace the input ciphertext block at index n+1 with the output ciphertext block for the new MDC block, to create a new ciphertext string; and
a sixteenth component for outputting the new ciphertext string.

114. The system as defined in claim 113, wherein said second component for generating a plurality of equal-sized blocks of λ bits in length from the input plaintext string further comprises:
a component for padding the input plaintext string as necessary such that its length is a multiple of λ bits; and
a component for partitioning the padded input plaintext string into a plurality of equal-size blocks of λ bits in length.

115. The system of claim 113, further comprising:
a component for receiving a plurality of new λ-bit plaintext blocks to replace a plurality of λ-bit plaintext blocks at said plaintext string at index i; and
a component for providing a parallel encryption method that outputs a ciphertext string incrementally for each of the said plurality of new λ-bit plaintext blocks.

116. A system for parallel encryption method for providing both data confidentiality and integrity for a message, comprising:
a first component for receiving an input plaintext string comprising a message;
a second component for generating a plurality of equal-sized blocks of λ bits in length from the input plaintext string;
a third component for partitioning the padded input plaintext string into a plurality of equal-size blocks of λ bits in length;
a fourth component for creating an MDC block of λ bits in length that includes the result of applying a non-cryptographic Manipulation Detection Code (MDC) function to the plurality of said equal-size blocks;
a fifth component for performing a plaintext randomization function over said plurality of equal-sized blocks of the plaintext and the MDC block using a different plaintext index for each equal-sized block and the MDC block to create a plurality of hidden plaintext blocks each of λ bits in length;
a sixth component for processing each of said hidden plaintext blocks by a block cipher using a secret key (K) to obtain a plurality of hidden ciphertext blocks;
a seventh component for performing a hidden ciphertext randomization function over said plurality of hidden ciphertext blocks using a different ciphertext index for each hidden ciphertext block to create a plurality of output ciphertext blocks each of λ bits in length; and
further comprising for performing an out-of-order decryption method for the parallel encryption method, which provides both data confidentiality and integrity:
an eighth component for receiving a string including a plurality of n+1 λ-bit ciphertext blocks for decryption;
a ninth component for selecting n+1 ciphertext blocks from said plurality of ciphertext blocks representing n data blocks and one MDC block and performing a reverse hidden ciphertext randomization function on each of the selected n+1 ciphertext blocks using said ciphertext index to obtain a plurality of hidden ciphertext blocks each of λ bits in length;
a tenth component for processing each of said hidden ciphertext blocks with the inverse of the block cipher used at an encryption method using said secret key (K) to obtain a plurality of hidden plaintext blocks; and
an eleventh component for performing an inverse plaintext randomization function over said plurality of hidden plaintext blocks using said plaintext index to create a plurality of n decrypted plaintext data blocks and one decrypted MDC block each of λ-bit length;
a twelfth component for creating an MDC decryption block by applying the non-cryptographic Manipulation Detection Code function to the n decrypted plaintext data blocks in the same manner as at a parallel encryption method;
a thirteenth component for verifying integrity of the plaintext blocks by comparing said created MDC decryption block with the decrypted MDC block;
a fourteenth component for outputting the plurality of plaintext blocks as an accurate plaintext string if the integrity verification passes; and
a fifteenth component for outputting a failure indicator if the integrity verification fails.

117. The system as defined in claim 116, wherein said second component for generating a plurality of equal-sized blocks of λ bits in length from the input plaintext string comprises:
a component for padding the input plaintext string as necessary such that its length is a multiple of λ bits; and
a component for partitioning the padded input plaintext string into a plurality of equal-size blocks of λ bits in length.
